(19) United States
(12) Patent Application Publication
(10) Pub. No.: US 2018/0257075 A1
(43) Pub. Date: Sep. 13, 2018

(54) MAGNETIC SINGLE CELL ARRAYS FOR PROBING CELL-DRUG AND CELL-CELL COMMUNICATION

(71) Applicant: Duke University, Durham, NC (US)

(72) Inventors: Benjamin B. Yellen, Durham, NC (US); David M. Murdoch, Chapel Hill, NC (US); Roozbeh Abedini-Nassab, Durham, NC (US); Kris C. Wood, Durham, NC (US)

(21) Appl. No.: 15/750,418

(22) PCT Filed: Aug. 10, 2016
(86) PCT No.: PCT/US2016/046269

§ 371 Date: Feb. 5, 2018

Related U.S. Application Data
(60) Provisional application No. 62/278,589, filed on Jan. 14, 2016.
(60) Provisional application No. 62/278,148, filed on Jan. 13, 2016.
(60) Provisional application No. 62/202,970, filed on Aug. 10, 2015.

(51) Int. Cl. B01L 3/00; B03C 1/28

(52) U.S. Cl. CPC B01L 3/502761; B03C 2201/26; B01L 2200/025; B01L 2200/0668; B01L 2200/147; B01L 2300/0816; B01L 2300/0851; B01L 2300/0864; B01L 2300/0883; B01L 2300/0893; B01L 2400/043; B01L 2400/0605; B01L 2400/0638; B01L 2400/0655; B01L 2400/0666; B01L 2400/0677; B03C 2201/18; B03C 1/288

(57) ABSTRACT

The current invention relates to systems for transporting, trapping, and releasing magnetically-labeled bioparticles within microfluidic environments.

### CROSS-REFERENCE

This application claims the benefit of U.S. Provisional Application No. 62/202,970, filed Aug. 10, 2015, U.S. Provisional Application No. 62/278,589, filed Jan. 14, 2016, and of U.S. Provisional Application No. 62/278,148, filed Jan. 13, 2016, which applications are incorporated herein in their entireties by reference.

### STATEMENT AS TO FEDERALLY SPONSORED RESEARCH

This invention was made with the support of the United States government under Federal Grant No. P30 A1027767 awarded by the Creative and Novel Ideas in Research (CNIHR) Program of the National Institute of Allergy and Infectious Diseases (NIAID), and Federal Grant No. R56-AI112360 awarded by the National Institute of Allergy and Infectious Diseases (NIAID), and the Duke University CFAR (5P30 AI064518). The government has certain rights in the invention.

### TECHNICAL FIELD

The current disclosure relates to systems for transporting, trapping, and releasing bioparticles within microfluidic environments. More particularly, the disclosure relates to the use of magnetic patterns and electrical wires near a fluid contacting surface, which operate jointly in a dynamic external field to transport magnetized bioparticles along programmable paths in microfluidic environments.

### BACKGROUND

Single cell arrays represent an emerging tool for analysis of cellular heterogeneity in response to myriad environmental stimuli, such as the presence of drug compounds, or interactions with other cells. Several single cell arrays are currently under development, which are based on passive sedimentation of cells into morphological templates [e.g., Love, et al. (2006), “A microengraving method for rapid selection of single cells producing antigen-specific antibodies”, Nat. Biotech 24:703-707], or microfluidic based trapping of cells in micro-chambers [e.g., Frimat, et al. (2011), “A microfluidic array with cellular valving for single cell co-culture.” Lab on a Chip 11:231-237].

The most notable commercial example of single cell array technology is the FLUIDIGM® system, which can capture and perform transcriptional analyses on up to 96 cells in hydrodynamic traps [Citri A, et al. (2012), “Comprehensive qPCR Profiling of Gene Expression in Single Neuronal Cells. Nature Protoc 7: 118-127; McDavid A, et a. (2013), “Data Exploration, Quality Control and Testing in Single-Cell qPCR-based Gene Expression Experiments”, Bioinformatics 29: 461-467]; however, the FLUIDIGM platform cannot be used for studies such as sensing cytokines secreted by large numbers of single cells, nor does this platform have the capability of recovering live cells for use in potential therapies. A second example of a commercial platform is the SILICON BIOSYSTEMS® DEParray platform, which uses negative dielectrophoresis to capture cells in electric field traps [Fabbri F, et al. (2013), “Detection and Recovery of Circulating Colon Cancer Cells Using a Dielectrophoresis-based Device: KRAS Mutation Status in Pure CTCs”, Cancer Lett 335: 225-231; Peeters D J E, et al. (2013), “Semiautomated Isolation and Molecular Characterisation of Single or Highly Purified Tumour Cells from CellSearch Enriched Blood Samples Using Dielectrophoretic Cell Sorting”, Brit J Cancer 108: 1358-1367]. This platform is most commonly used for separating, phenotyping, and recovering circulating tumor cells in core blood samples. This platform is not currently being used to organize, incubate, and monitor single cell arrays or to detect their secretion patterns, proliferation rates, or other long-term phenotypic behavior.

None of the currently existing tools are capable of organizing single cells into large arrays with the flexibility and scalability of computer circuits. Thus, there remains an unmet need to develop equivalent circuits to automate the placement of cells in well-defined storage sites, enable their long-term microscopic evaluation in response to different environmental stimuli, and retrieve selected cells at specified times for follow-on transcriptomic analysis or clonal expansion.

### SUMMARY

Disclosed herein are microfluidic chips comprising: a) a microfluidic structure disposed above a solid surface; and b) a first magnetizable track, comprising a continuous series of sections having either positive or negative curvature, wherein the first magnetizable track is deposited on or embedded within the solid surface, and is in close proximity to, or in direct contact with, at least a portion of the microfluidic structure. In some embodiments, the continuous series of sections alternate between having positive and negative curvature. In some embodiments, the first magnetizable track is made of iron, a nickel-iron alloy, a nickel-molybdenum-iron alloy, a cobalt-iron alloy, an iron-silicon alloy, a material having low coercivity and high magnetizability, or any combination thereof. In some embodiments, the first magnetizable track has a multi-layered stack structure. In some embodiments, the multi-layered stack structure comprises two magnetic layers with a non-magnetic layer disposed between the two magnetic layers. In some embodiments, the microfluidic chip further comprises at least a second magnetizable track. In some embodiments, the microfluidic chip further comprises an electrically conducting structure, wherein at least a portion of the electrically conducting structure is spatially registered between the first magnetizable track and the at least second magnetizable track. In some embodiments, the electrically conducting structure is less than about 10 μm wide in at least one dimension. In some embodiments, the electrically conducting structure is less than about 1 μm wide in at least one dimension. In some embodiments, the electrically conducting structure is larger than about 100 nm in the at least one dimension. In some embodiments, the electrically conducting structure is made of Au, Pt, Ag, Al, Cu, Zn, graphene, carbon nanotubes, organic conductors, a metal or composite with conductivity larger than 100,000 S/m, or any combination thereof. In some embodiments, the electrically conducting structure comprises a p-n junction patterned in silicon or another semiconducting material. In some embodiments, the microfluidic structure comprises a fluid channel, a fluid chamber, a fluid compartment, a microwell, or any combination thereof. In some embodiments, the microfluidic chip further comprises a non-fouling layer disposed between the first magnetizable track and the microfluidic structure. In some embodiments, the non-fouling layer is made of polyethylene glycol, poly[oligo(ethylene glycol) methyl ether methacrylate], zwitterionic polymers containing carboxybetaine or sulfobetaine, polytetrafluoroethylene or other fluoropolymer, or any combination thereof.

Disclosed herein are microfluidic chips comprising: a) a microfluidic structure disposed above a solid surface; and b) a pattern of magnetizable material comprising a continuous series of sections having either positive or negative curvature, wherein the pattern of magnetizable material is deposited on or embedded within the solid surface, and is in close proximity to, or in direct contact with, at least a portion of the microfluidic structure. In some embodiments, the continuous series of sections alternate between having positive and negative curvature. In some embodiments, the microfluidic structure comprises one or more of a fluid channel, a fluid chamber, a fluid compartment, a microwell, or any combination thereof. In some embodiments, the microfluidic structure comprises a first fluid channel and a plurality of fluid compartments in fluid contact with the channel. In some embodiments, the plurality of fluid compartments comprises at least 100 fluid compartments. In some embodiments, the plurality of fluid compartments comprises at least 1,000 fluid compartments. In some embodiments, the pattern of magnetizable material forms one or more structures selected from the group consisting of (i) structures that transport magnetically-susceptible objects along a path defined by the geometry of the magnetic pattern, and (ii) structures that trap magnetically-susceptible objects at specific locations defined by the geometry of the magnetic pattern, or any combination thereof. In some embodiments, the microfluidic chip further comprises a pattern of electrically conducting material deposited on or embedded in the solid surface, and configured to form one or more junctions used to sort magnetically-susceptible objects between two pre-defined magnetic paths according to a relationship between the geometry of the magnetic pattern and the pattern of electrically conducting material. In some embodiments, the microfluidic chip further comprises a non-fouling layer disposed between the microfluidic domain and the pattern of magnetizable material.

Disclosed herein are microfluidic chips comprising: a) a microfluidic structure disposed above a solid surface and comprising: i) one or more fluid channels, and ii) one or more fluid chambers, each of which is in fluid contact with at least one fluid channel; and b) a pattern of magnetizable material comprising a continuous series of sections having either positive or negative curvature, which is deposited on or embedded within the solid surface, the pattern comprising: i) one or more structures that transport magnetically-susceptible objects along a path defined by the geometry of the magnetic pattern that are in close proximity to, or in direct contact with, at least one fluid channel, and ii) one or more structures that trap magnetically-susceptible objects at specific locations defined by the geometry of the magnetic pattern, each of which is in close proximity to, or in direct contact with, one of the one or more fluid chambers. In some embodiments, the microfluidic chip further comprises a pattern of electrically conducting structures deposited on or embedded within the solid surface and forming junctions used to sort magnetically-susceptible objects between (i) the one or more structures that transport magnetically-susceptible objects along a path defined by the geometry of the magnetic pattern, and (ii) the one or more structures that trap magnetically-susceptible objects at specific locations defined by the geometry of the magnetic pattern, or any combination thereof. In some embodiments, the microfluidic chip further comprises a non-fouling layer disposed between the microfluidic structure and the pattern of magnetizable material. In some embodiments, the microfluidic chip further comprises one or more valves associated with each of the one or more fluid chambers, wherein the one or more valves are configured to reversibly seal the one or more fluid chambers. In some embodiments, the one or more valves associated with each of the one or more fluid chambers are configured to reversibly seal the one or more fluid chambers in a fluid chamber-specific addressable manner.

Disclosed herein are microfluidic chips comprising: a) a microfluidic channel disposed above a solid surface; b) a first magnetizable track deposited on or embedded within the solid surface which is in close proximity to, or in direct contact with, at least a portion of the microfluidic channel; c) a microfluidic chamber disposed above the solid surface and in fluid contact with the microfluidic channel; d) a second magnetizable track embedded within the solid surface in close proximity or direct contact with at least a portion of the microfluidic chamber; e) a microfluidic valve located between the first microfluidic chamber and the microfluidic channel, wherein fluid contact between the microfluidic chamber and the microfluidic channel is broken when the microfluidic valve is closed; and f) an electrically conducting material deposited on or embedded within the solid surface, at least a portion of which is spatially registered between the first magnetizable track and the second magnetizable track.

Disclosed herein are systems for controlling the position of magnetically-susceptible objects within a microfluidic chip comprising: a) a controller adapted to dynamically adjust a time-varying magnetic field that has field components oriented in directions both parallel and perpendicular to a solid surface; b) a microfluidic chip comprising: i) a microfluidic structure disposed above the solid surface; and ii) a pattern of magnetizable material deposited on or embedded within the solid surface and adapted to provide for directional movement of a magnetically-susceptible objects within the microfluidic structure when the microfluidic chip is exposed to the time-varying magnetic field; and c) a single-phase aqueous liquid comprising one or more magnetically-susceptible objects and located within the microfluidic structure of the microfluidic chip.

Disclosed herein are systems for controlling the position of magnetically-susceptible objects within a microfluidic chip comprising: a) a controller adapted to dynamically adjust a time-varying magnetic field that has field components oriented in directions both parallel and perpendicular to a solid surface; and b) a microfluidic chip comprising: i) a microfluidic structure disposed above the solid surface; ii) a pattern of magnetizable material, comprising a continuous series of sections having either positive or negative curvature, which is deposited on or embedded within the solid surface, and which is in close proximity to, or in direct contact with, at least a portion of the microfluidic structure. In some embodiments, the microfluidic chip further comprises a pattern of electrically conducting structures deposited on or embedded within the solid surface and forming junctions used to sort magnetically-susceptible objects between (i) the one or more structures that transport magnetically-susceptible objects along a path defined by the geometry of the magnetic pattern, and (ii) the one or more structures that trap magnetically-susceptible objects at specific locations defined by the geometry of the magnetic pattern, or any combination thereof. In some embodiments, the system further comprises one or more magnets operatively connected to the controller and adapted to produce the time-varying magnetic field. In some embodiments, the one or more magnets are electromagnets. In some embodiments, the one or more magnets are movable permanent magnets.

Disclosed herein are methods comprising: a) introducing a plurality of magnetically-susceptible objects into a microfluidic chip, wherein the microfluidic chip comprises: i) a pattern of magnetizable material deposited on or embedded within a solid surface and in close proximity to or direct contact with a microfluidic channel, and ii) a plurality of microfluidic chambers in fluid contact with the microfluidic channel; and b) magnetically sorting the plurality of magnetically-susceptible objects into the plurality of microfluidic chambers using a time-varying magnetic field that has field components oriented in directions both parallel to and perpendicular to the solid surface. In some embodiments, the method further comprises correcting for multiple occupancy by identifying microfluidic chambers that contain more than one magnetically-susceptible object, and selectively removing a desired number of magnetically-susceptible objects from the identified microfluidic chambers using a time-varying magnetic field that has field components oriented in directions both parallel to and perpendicular to the solid surface. In some embodiments, the plurality of magnetically-susceptible objects comprises a plurality of bioparticles. In some embodiments, the plurality of bioparticles comprises magnetically-labeled cells selected from the group consisting of adherent and non-adherent eukaryotic cells, mammalian cells, primary and immortalized human cells or cell lines, primary and immortalized rodent cells or cell lines, cancer cells, epithelial cells, red blood cells, white blood cells, cultured mammalian cells, T cells, B cells, NK cells, macrophages, neuronal cells, glial cells, astrocytes, fibroblasts, endothelial cells, circulating tumor cells (CTCs) distinct cell subsets such as CD8+ T cells, CD4+ T cells, CD44high/CD24low cancer stem cells, Lgr5/6+ stem cells or any combination thereof. In some embodiments, the plurality of bioparticles comprises magnetically-labeled cells selected from the group consisting of adherent and non-adherent prokaryotic cells, yeast cells, bacterial cells, algae cells, and fungal cells or any combination thereof. In some embodiments, the plurality of bioparticles comprises magnetically-labeled organisms selected from the group consisting of nematodes, embryos, and any other living organism, or any combination thereof. In some embodiments, the plurality of bioparticles comprises magnetically-labeled non-cellular structures selected from the group consisting of viral particles, cellular organelles, viruses, exosomes, liposomes, blebs, microparticles, micelles, and nanoparticles. In some embodiments, the plurality of bioparticles comprises magnetic beads that are attached to DNA, RNA, proteins, antibodies, enzymes, ribosomes, polysaccharides, lipids, or any combination thereof. In some embodiments, the method further comprises introducing a chemical stimulus into the plurality of microfluidic chambers. In some embodiments, the chemical stimulus is selected from the group consisting of a cytokine, a chemokine, a growth factor, a pH change, a change in the ionic strength of the buffer, a change in Ca2+ concentration, a change in Mg2+ concentration, a change in oxygen concentration, a change in the concentration of nutrients like glucose or amino acids, a lysis buffer, a drug, a protein, a ligand, a hormone, a carbohydrate, a lipid, a nucleic acid, a cDNA, an siRNA, an shRNA, a microRNA, an sgRNA, an mRNA, a virus, a retrovirus, a lentivirus, a kinase, an enzyme, an antibody, an aptamer, an antigen, a micelle, a nanoparticle, a liposome, a microparticle, a lysis buffer, or any combination thereof. In some embodiments, the method further comprises applying a physical stimulus to the plurality of cells in the plurality of microfluidic chambers. In some embodiments, the physical stimulus is selected from the group consisting of a light stimulus, a temperature change, a gas concentration change, a pressure change, an electric field, a magnetic field, an acoustic field, an optical field, radiation, or any combination thereof. In some embodiments, the method further comprises introducing at least a second plurality of magnetically-susceptible objects into the microfluidic chip and magnetically sorting the at least second plurality of magnetically-susceptible objects into the plurality of microfluidic chambers. In some embodiments, the at least second plurality of magnetically-susceptible objects comprises at least a second plurality of magnetically-labeled cells of the same cell type or a different cell type so as to sort homogeneous or heterogeneous sets of two or more cells into each microfluidic chamber. In some embodiments, the heterogeneous set of two or more cells comprises immune cells which are used to analyze immunological interactions. In some embodiments, the heterogeneous set of two or more cells comprises immune cells and cancer cells which are used to study immune surveillance or immunotherapies. In some embodiments, the heterogeneous set of two or more cells comprises neuron cells and muscle cells which are used to study the formation of neuromuscular junctions. In some embodiments, the heterogeneous set of two or more cells comprises neuron cells, glial cells, and astrocytes, which are used to study neuronal signaling and the drug-dependence thereof. In some embodiments, the heterogeneous set of two or more cells comprises tumor cells, endothelial cells, epithelial cells, macrophages, neutrophils, NK cells, fibroblasts, stromal cells, smooth muscle cells, and adipocytes, or any combination thereof, which are used to study properties of a tumor microenvironment. In some embodiments, the homogeneous or heterogeneous set of two or more cells comprises a pair of adherent cells, and adhesion between the pair of cells is studied. In some embodiments, the heterogeneous set of two or more cells comprises an immune cell and a pathogen, and an interaction between the immune cell and the pathogen is analyzed. In some embodiments, the heterogeneous set of two or more cells comprises a leukocyte and an endothelial cell, and an interaction between the leukocyte and the endothelial cell is analyzed. In some embodiments, the heterogeneous set of two or more cells comprises a pair of cells, and is used to analyze a tight junction, a gap junction, or a junction involving direct contact between the membranes of two different cells. In some embodiments, the at least second plurality of magnetically-susceptible objects comprises magnetic particles conjugated to cytokine-specific antibodies, chemokine-specific antibodies, protein-specific antibodies, phosphoprotein-specific antibodies, protein post-translational modification-specific antibodies, growth factor-specific antibodies, another antibody, an aptamer, a glycoprotein, a protein, a drug, a cell signaling agent, a polysaccharide, or any combination thereof. In some embodiments, the method further comprises measuring a level of at least one cytokine, chemokine, or growth factor. In some embodiments, the at least one cytokine, chemokine, or growth factor is selected from the group consisting of interleukin 2 (IL-2), interleukin 4 (IL-4), interleukin 5 (IL-5), interleukin 10 (IL-10), interleukin 13 (IL-13), interferon-γ (IFN-γ), tumor necrosis factor-alpha (TNF-α), tumor necrosis factor-beta (TNF-β), a member of the transforming growth factor beta superfamily including TGF-β1, TGF-β2, and TGF-β3, epithelial growth factor (EGF), hepatocyte growth factor (HGF), vascular endothelial growth factors (VEGF family), a member of the platelet derived growth factor (PDGF) family, and fibroblast growth factor (FGF), or any combination thereof. In some embodiments, the at least second plurality of magnetically-susceptible objects comprises a molecule that adheres to the outer membrane of a virus particle selected from the group consisting of influenza virus, rhinovirus, cytomegalovirus, Epstein-barr virus, ebola virus, Marburg virus, zika virus, dengue virus, measles virus, mumps virus, polio virus, rubella virus, varicella-zoster virus, a member of the hepatitis family of viruses, a member of the HIV family of viruses, a member of the herpes family of viruses, an adenovirus, and a retrovirus. In some embodiments, the at least second plurality of magnetically-susceptible objects comprises magnetic beads conjugated to a molecule that adheres to the outer membrane of a virus particle and is used to capture virus particles secreted by cells in each fluid chamber, and wherein the method further comprises determining a level of the virus particles in each fluid chamber. In some embodiments, the level of the virus particles in each fluid chamber is determined by monitoring a fluorescent signal, an optical signal, a color change, an electrical signal, a pH change, an enzymatic reaction, or any combination thereof. In some embodiments, the individual magnetically-susceptible objects of a first or at least second plurality of magnetically-susceptible objects each comprise attached oligonucleotide barcodes that code for the identity of cells or antigen-specific antibodies conjugated to the magnetically-susceptible objects. In some embodiments, the individual magnetically-susceptible objects of a first or at least second plurality of magnetically-susceptible objects each comprise a plurality of attached oligonucleotides, and wherein the oligonucleotides attached to a given magnetically-susceptible object each comprise (i) a unique magnetically-susceptible object-specific barcode sequence that is the same for all oligonucleotides attached to the given magnetically-susceptible object, and different from that for all other magnetically-susceptible objects of the plurality, (ii) a molecular index barcode sequence that is different for each oligonucleotide attached to the given particle, (iii) a capture sequence designed to capture a complementary oligonucleotide sequence that is present in the microfluidic chamber, and (iv) at least one polymerase primer sequence. In some embodiments, individual magnetically-susceptible objects of the first or at least second plurality of magnetically-susceptible objects are sorted into individual microfluidic chambers containing a single cell, and wherein the attached oligonucleotide sequences are used to capture target RNA molecules released by lysing the single cell. In some embodiments, the method further comprises retrieving and pooling the magnetically-susceptible objects from the plurality of microfluidic chambers, and subsequently performing a reverse transcription reaction to produce a complementary DNA strand that comprises the molecular index barcode sequence and all or a portion of the target RNA molecule sequence, followed by DNA sequencing of complementary DNA strands produced for at least one of the retrieved magnetically-susceptible objects. In some embodiments, the method further comprises performing a reverse transcription reaction to produce a complementary DNA strand that comprises the molecular index barcode sequence and all or a portion of the target RNA molecule sequence, and subsequently retrieving and pooling the magnetically-susceptible objects from the plurality of microfluidic chambers, followed by DNA sequencing of complementary DNA strands produced for at least one of the retrieved magnetically-susceptible objects. In some embodiments, the magnetically-susceptible objects are exposed to a set of sequencing reagents in a cyclic series of synthesis reactions that allows the identity of the attached oligonucleotide barcode sequences to be determined while the magnetically-susceptible objects are compartmentalized within the microfluidic chambers. In some embodiments, the cyclic series of synthesis reactions utilize a change in light intensity, fluorescence, pH, or electrical current to determine the identity of a nucleotide incorporated in each cycle of the cyclic series of synthesis reactions. In some embodiments, the method further comprises the step of subsequently using the time-varying magnetic field to remove all or a portion of the plurality of magnetically-susceptible objects from the plurality of microfluidic chambers. In some embodiments, the first plurality of magnetically-susceptible objects comprises magnetically-labeled cells of a first cell type, the at least second plurality of magnetically-susceptible objects comprises magnetic beads of at least a first bead type or magnetically-labeled cells of at least a second cell type, and wherein use of the time-varying magnetic field enables magnetic sorting of magnetically-labeled cells or magnetic beads into the plurality of microfluidic chambers in any combination of cell types and bead types. In some embodiments, the magnetically-susceptible objects comprise magnetically-labeled cells of a first cell type, and wherein subsequently to the sorting step, the individual magnetically-labeled cells in individual microfluidic chambers are exposed to none or at least one type of drug or test compound while the number of cell divisions, cell size, cell shape, organelle number, organelle shape, organelle size, or reporter gene expression, or any combination thereof, are monitored within each individual microfluidic chamber as a function of time. In some embodiments, following the exposure of the magnetically-labeled cells in individual microfluidic chambers to none or at least one type of drug, a level of a cellular protein, a level of a phosphoprotein, a degree of protein localization, a level of an organelle function, or any combination thereof, is measured using a fluorescence-based assay. In some embodiments, the at least second plurality of magnetically-susceptible objects comprises magnetic beads conjugated to antibodies, cytokine-specific antibodies, chemokine-specific antibodies, growth factor-specific antibodies enzymes, enzyme substrates, proteins, small molecules, glycoproteins, drug molecules, polysaccharides, fluorophores, oligonucleotides, oligonucleotide barcodes, or any combination thereof. In some embodiments, the plurality of magnetically-susceptible objects comprises bacterial cells attached to magnetic particles, and an antibiotic is applied as the chemical stimulus and the method is used to determine the ability of the antibiotic to impede proliferation of the bacteria. In some embodiments, the first and at least second plurality of magnetically-susceptible objects comprise at least two different types of magnetically-labeled bacteria that are sorted into each microfluidic chambers, and the method is used to monitor an interaction between, or signaling between, the at least two different types of bacteria. In some embodiments, the plurality of magnetically-susceptible objects comprises yeast cells attached to magnetic particles, and the method is used to monitor the proliferation of, and molecules produced by, the yeast cells.

### INCORPORATION BY REFERENCE

All publications, patents, and patent applications mentioned in this specification are herein incorporated by reference in their entirety to the same extent as if each individual publication, patent, or patent application was specifically and individually indicated to be incorporated by reference in its entirety. In the event of a conflict between a term herein and a term in an incorporated reference, the term herein controls.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1A-F illustrate non-limiting examples of magnetic patterns which are used to guide the motion of magnetically-linked bioparticles along linear tracks.

FIGS. 2A-Q illustrate additional non-limiting examples of magnetic patterns which are used to guide the motion of magnetically-linked bioparticles along linear tracks.

FIGS. 3A-F illustrate the motion of magnetic beads on various linear track patterns, where the magnetic beads are responding to an external field comprising an in-plane rotating field and a static vertical field.

FIGS. 4A-F illustrate the motion of magnetic beads for three different angles of the field cone, thereby demonstrating that with these magnetic patterns, a vertical field is essential to achieving horizontal transport along the linear tracks.

FIGS. 5A-H illustrate non-limiting examples of magnetic patterns which can be used to implement unidirectional transport of magnetically-linked bioparticles down linear tracks.

FIGS. 6A-D illustrate the motion of magnetic beads on unidirectional magnetic track patterns, where the motion is actuated by an external magnetic field comprising both a rotating in-plane field and a static vertical field.

FIGS. 7A-D illustrate non-limiting examples of track geometries that enable the magnetically-linked bioparticles to make right or left turns.

FIGS. 8A-C illustrate additional non-limiting examples of track geometries that enable magnetically-susceptible objects, e.g. magnetically-labeled bioparticles, to make right or left turns. The dotted lines indicate the paths followed by magnetic beads in response to an external, time varying magnetic field.

FIG. 9 illustrates an experimental example of a storage sites for magnetically-linked bioparticles, which functions similarly to an electrical capacitor. The dotted lines indicate the path a magnetic bead as it is introduced to the storage site and subsequently retrieved from the storage site using an external, time-varying magnetic field.

FIG. 10 shows an image of a portion of a magnetophoretic array comprising a plurality of magnetic tracks, electrically-conducting structures that function as switches, and magnetic disk storage sites.

FIGS. 11A-B show images of a magnetophoretic array. FIG. 11A shows an image of the array. FIG. 11B shows an enlarged image of a portion of the array. Application of current to the electrically-conductive structure (white) positioned in the gap between the magnetic track (grey) and the magnetic disk storage sites (grey) causes magnetically-labeled bioparticles to cross the gap in response to the externally-applied magnetic field.

FIGS. 12A-D illustrate non-limiting examples of track geometries which use both an electrical current pattern and a magnetic pattern to enable switching of magnetically-linked bioparticles between different tracks.

FIG. 13 illustrates one of the basic components (i.e. a “conductor”) of a magnetophoretic single cell memory device. CD4⁺ T cells were labeled with magnetic nanoparticles (Stem Cell nanoparticles, 200 nm diameter, CD2⁺ antigen) and are moved in a rotating magnetic field along linear tracks of Ni₈₁Fe₁₉ patterned magnetic films. The path followed by the magnetically-labeled cells is indicated by the grey line in the lower part of the figure. Cell speed is proportional to the driving frequency, ω, which is the equivalent of Ohm's law for matter, ω=IR

FIG. 14 illustrates one non-limiting example of the basic switching component (i.e. a “transistor”) of a magnetophoretic single cell memory device. Cells can be switched between different tracks by the application of electrical current to the gate. When the gate current is ON, the cells are transferred across the gap (light grey line), whereas the cells are not transferred when the gate current is OFF (dark grey line).

FIG. 15 illustrates a magnetophoretic cell “memory device” array. Cells can be routed to arbitrary array sites by activating the appropriate switches in the array. Here, a single cell is routed down the 3rd row and the 2nd column, to arrive at its final destination in array site number 32 (a chamber performing a function that is equivalent to that of a capacitor in an electrical circuit).

FIG. 16 provides a schematic illustration of “transistor” geometry. Magnetic disks of radius R are separated by a gap of width, d. In the presence of an external magnetic field, Hₑₓₜ, application of current to the electrically conductive “gate” structure (darker grey) allows a magnetic particle (radius=a) to hop across the gap between the magnetic disks. In some embodiments, the “gate” is positioned asymmetrically between the magnetic disks, i.e. separated from one of the disks by a distance, λ.

FIGS. 17A-D illustrate the operation of the “transistor” illustrated in FIG. 16. When the gate bias is OFF, the potential energy landscape depicts the double energy well associated with an insulating state (FIG. 17A). A magnetic bead cannot cross this gap, and therefore continues its movement around the left track (FIG. 17B). When the gate bias is ON, the potential energy landscape shows a single energy minimum at the wire position associated with the conducting state (FIG. 17C). A magnetic particle can traverse the gap (FIG. 17D). Figure adapted from Abedini et. al, Adv. Mater., 2015 (online).

FIGS. 18A-D show data for “transistor” switching efficiency for magnetically-labeled CD4⁺ T cells. Switching efficiency for operating frequencies of 0.2 Hz (squares) and 0.5 Hz (triangles) in FIG. 18A (repulsive mode), and FIG. 18B (attractive mode), with an in-plane rotating magnetic field operating at 45 Oe. Switching thresholds for various transistor geometries are shown in FIG. 18C (repulsive mode) and FIG. 18D (attractive mode).

FIG. 19 illustrates the importing and exporting of single magnetic beads into multiplexed magnetophoretic arrays. Magnetic beads with 2.8-μm diameter are imported into the “42”, “53”, and “64” microchambers of the array, with trajectories shown as dark grey lines. After assembly, the beads can be removed with the trajectories shown as light grey lines.

FIGS. 20A-B illustrate an experimental setup for testing magnetophoretic array devices. A microscope imaging station and magnetic field stage are shown in FIG. 20A. The rotating field is produced by the coil (1), with another coil mounted underneath the platform (2). The rotating field and gate currents were controlled with a custom designed board (3). A magnetophoretic chip is shown mounted in a IC test clip in FIG. 20B.

FIG. 21 shows another view of an experimental setup for testing magnetophoretic array devices. A magnetophoretic array chip is mounted on a microscope stage that includes a heating element, a temperature sensor, and fluidics connections. A rotating magnetic field is provided by pairs of electromagnets.

FIG. 22 depicts a custom electromagnet fabricated by wrapping magnet wire around a 4-pole milled iron plate. A 3D printer was used to establish a level imaging plane and build parts to hold the single cell array device. Electrical connectivity can be made between 72 independent channels of a current controller with PCI slot card.

FIG. 23 depicts a custom permanent magnet rotor which is built by inserting strong NdFeB magnets into machined cavities, which is then mounted onto a rotary bearing.

FIG. 24 illustrates data for preliminary cell viability studies conducted in sealed PDMS chambers maintained at 37° C., with gas exchange mediated by diffusion of CO₂ through the PDMS membrane. Short-term incubator studies indicate that cells remain viable past 72 hours. Viability was assessed with Cytox staining kit at 24-hour intervals.

FIG. 25 illustrates data for cell viability when cells are either labeled or unlabeled with magnetic nanoparticles, which demonstrates the biocompatibility of the labeling procedure.

FIG. 26 illustrates data for drug response when cells are either labeled or unlabeled with magnetic nanoparticles, which demonstrates the biocompatibility of the labeling procedure.

FIG. 27 shows data for transcriptional profiling of magnetically labeled CD4⁺ T cells. A gene expression heatmap reveals transcriptional differences in only 7 of 40 genes (bottom) assessing T cell function, activation and differentiation, survival, exhaustion, and T cell receptors; internal control (corn silk, leftmost). The significant functional and activation genes (highlighted boxes) show relative decreases in expression over time. Samples (right-hand labels) are arranged by time and genes clustered on relative changes in expression. Light grey denotes relatively high expression, while dark grey indicates low expression. Each gene for a given time point was run in triplicate on a FLUIDIGM RT-PCR system, with results averaged and expression graphically displayed relative to housekeeping gene and spike-in assay controls (leftmost lanes).

FIG. 28 illustrates one non-limiting example of a design for a magnetophoretic single cell array platform. White regions depict the microfluidic channels and array sites; dark grey regions show the transistors; and light grey disk-shaped regions depict the magnetic patterns.

FIG. 29 schematically illustrates one non-limiting example of a sequence of operational steps for magnetically sorting cells into a magnetophoretic single cell array device. Step 1: cells are introduced into the microchannel and the flow stopped. Step 2: the nearest cells are sorted into the adjacent microchambers. Step 3: sorting errors are evaluated and corrected as needed (as depicted for the A2 array site). Step 4: finally, excess cells are removed to form a single cell array. The process may occur simultaneously in all channels to build a large single cell array device.

FIG. 30 illustrates one non-limiting example of a magnetophoretic cell array device for detecting the secretion patterns of single cells in situ. Microchambers are redesigned with separate cell trap and bead trap compartments.

FIG. 31 schematically illustrates one non-limiting example of a sequence of operational steps for magnetically sorting cells into a magnetophoretic single cell array device and detecting cytokine secretion patterns. Step 1: cells are arrayed in the microwells. Step 2: a batch of cytokine sensing beads is arrayed in the microwells (each bead is depicted as a different shade of grey). The reagent valve is closed to allow the cell's secretions to bind to the beads. Step 3: the cell valve is closed, and the reagent valve is opened to allow introduction of fluorescent detection labels. After detection, the cytokine sensing beads are rinsed and replaced with a fresh batch to enable sensing at a future time point.

FIGS. 32A-L illustrate one non-limiting approach to magnetophoretic chip fabrication. Starting from a cleaned silicon wafer (FIG. 32A), a photoresist is patterned (FIG. 32B), then a thin stack of Ti/Au is evaporated onto the entire surface (FIG. 32C), after which liftoff is performed (FIG. 32D), and finally a SU8 layer is applied to act as an insulator (FIG. 32E). These steps (FIGS. 32B-E) are repeated with the magnetic permalloy layer (FIGS. 32F-I). Finally, a POEGMA brush is grafted onto the SU8 top layer (FIG. 32J), followed by the installation of a 3D printed chamber and addition of DI water or PBS (FIG. 32K), addition of cells or beads, and finally a planar viewing window is created by covering the chip with a coverslip (FIG. 32L).

FIGS. 33A-D illustrate the operation of a magnetophoretic barrier transistor. The horizontal and vertical magnetic field components are fixed at 50 Oe, while the in-plane field component rotates clockwise at a driving frequency of 0.1 Hz. The gate currents required for reliable switching in each of the transistor geometries are (FIG. 33A) 35 mA, (FIG. 33B) 35 mA, (FIG. 33C) 45 mA, and (FIG. 33D) 40 mA, respectively. The dotted lines depict the trajectories of magnetic particles extracted from video data. The dark grey circles depict the starting points of the overlaid trajectories, and the curved black arrow represents the rotation sense of the horizontal field component with the direction of the vertical field depicted at the center of the curved arrow. Scale bar, 10 μm.

FIGS. 34A-D illustrate the operation of magnetophoretic repulsion transistors. The horizontal and vertical magnetic field components are fixed at 50 Oe, while the in-plane field component rotates clockwise at a driving frequency of 0.1 Hz. The gate currents required for reliable switching in each of the transistor geometries are (FIG. 34A) 35 mA, (FIG. 34B) 30 mA, (FIG. 34C) 35 mA, and (FIG. 34D) 30 mA, respectively. The dotted lines depict the trajectories of magnetic particles extracted from video data. The dark grey circles depict the starting points of the overlaid trajectories, and the curved black arrow represents the rotation sense of the horizontal field component with the direction of the vertical field is depicted at the center of the curved arrow. Scale bar, 10 μm.

FIGS. 35A-H provide examples of data for the switching thresholds of several magnetophoretic transistors. The switching thresholds for 8.4 μm (black lines) and 15.6 μm magnetic beads (dark grey lines) are shown for the transistors depicted in FIG. 33A (FIG. 35A), FIG. 33B (FIG. 35B), FIG. 33C (FIG. 35C), FIG. 33D (FIG. 35D), FIG. 34A (FIG. 35E), FIG. 34B (FIG. 35F), FIG. 34C (FIG. 35G), and FIG. 34D (FIG. 35H). In these tests, the in plane rotating field and the vertical bias field magnitudes are 50 Oe and the driving frequency is 0.1 Hz.

FIGS. 36A-F provide examples of data for magnetophoretic transistor switching thresholds vs. magnetic field strength, frequency, and cone angle. The switching efficiency of 8.4-μm magnetic beads is shown for the transistor depicted in FIG. 33B as a function of (FIG. 36A) the driving frequency ranging from 0.1 Hz (black), 0.3 Hz (medium grey), and 0.6 Hz (light grey) when the field magnitude and cone angle are fixed at 70 Oe and 45°, respectively, (FIG. 36B) the field magnitude ranging from 50 Oe (black), 70 Oe (medium grey), and 90 Oe (light grey) when the cone angle and the driving frequency are fixed at 45° and 0.1 Hz, respectively, and (FIG. 36C) the cone angle ranging from 37° (black), 450 (medium grey), and 65° (light grey) when the field magnitude and driving frequency are fixed at 70 Oe an 0.1 Hz, respectively. The results from similar experiments performed on the transistor depicted in FIG. 34B are shown in (FIGS. 36D-F).

FIG. 37 illustrates magnetophoretic transistor switching of magnetically labeled CD4+ T cells. The overlaid trajectories (dotted lines) of magnetically labeled human T cells are shown with the horizontal and vertical magnetic field components fixed at 50 Oe, while the in-plane field component rotates clockwise at a driving frequency of 0.1 Hz. The gate current is fixed at 50 mA. The dotted lines depict the trajectories of the cells extracted from video data. The black circle depicts the starting points of the overlaid trajectories, and the curved black arrow represents the rotation sense of the horizontal field component with the direction of the vertical field is depicted at the center of the curved arrow.

FIG. 38 illustrates a non-limiting example of the use of a magnetophoretic array device to test the drug sensitivity of single cells. Following the magnetophoretic sorting of single cells into microfluidic compartments (upper figure), the cells in some compartments are exposed to a drug or to a buffer control, and cell growth is monitored over time, e.g. several days, using, for example, a fluorescence-based live cell/dead cell assay.

### DETAILED DESCRIPTION

As used herein, the singular forms “a”, “an”, and “the” include plural references unless the context clearly dictates otherwise. Any reference to “or” herein is intended to encompass “and/or” unless otherwise stated.

Unless otherwise defined, all technical terms used herein have the same meaning as commonly understood by one of ordinary skill in the art in the field to which this disclosure belongs.

Overview of Magnetophoretic Particle Sorting Platforms:

Disclosed herein are novel methods, devices, and systems (constituting “magnetophoretic particle sorting platforms”) for transporting, sorting, trapping, monitoring, analyzing, and recovering magnetically-susceptible objects, e.g. magnetic nanoparticles, magnetic beads, or magnetically-linked bioparticles, in microscale fluid environments. These methods, devices, and systems offer unique advantages over existing technologies with respect to the ability to arrange large ensembles of mobile, magnetically-susceptible particulate species in fluids into preferred positions (e.g. “arrays”) at the micron and sub-micron scale. The potential applications of the technology range from non-biological applications such as assembly of catalyst arrays and parallel chemical synthesis techniques, to biological applications such as single cell genomics and gene expression analysis, the study of single cell physiology, and the study of cell-cell interactions.

In the disclosed methods, devices, and systems, magnetically-susceptible objects are transported by means of a time-modulated potential energy landscape that arises from the superposition of a time-varying external magnetic field and the local magnetic field produced by magnetic “tracks” patterned on a substrate. It is important in the disclosed concepts that the time-varying magnetic field includes a vertical component, i.e., a component that is normal to the plane of the substrate surface in contact with the fluid comprising the magnetic particles. The vertical field component provides unique advantages in the ability to induce magnetic repulsion between nearby magnetically-susceptible objects, and also the ability to break the axial symmetry of the in-plane rotating field component and therefore specify a single, unique position for the magnetic objects for each phase of the time-varying field. This leads to better control and repeatability of particle transport than the approach disclosed in previous work using two-dimensional magnetic fields (i.e. magnetic fields rotating in a single plane) [Lim, et al. (2014), “Magnetophoretic Circuits for Digital Control of Single Particles and Cells”, Nat. Commun. 5:3846; U.S. Published Patent Application No. 2015/0064764 A1].

In many ways, the functionality of the disclosed magnetophoretic devices mimics the operating principles of a random access computer memory device, except that magnetized objects are manipulated instead of electrons. Individual magnetic particles can be imported into specific sites of the array, stored there for desired periods of time and, if desired, exported from or replaced within the array at specified points in time for further analysis. This capability is achieved by organizing magnetized particles (e.g., magnetically-labeled single cells, cytokine sensing beads, etc.) inside a microfabricated platform comprising passive and active magnetic field-emitting structures, which emulate the functionality of conductors, capacitors, diodes, and transistors of electronic circuits. In the disclosed magnetophoretic sorting platforms, magnetically-labeled objects are transported along programmable paths (“conductors”), switch their direction at intersections (“transistors”), are stored in local compartments (“capacitors”), and large numbers of magnetic particles, e.g., magnetically-labeled cells or cytokine sensing beads, are “written” (i.e. directed) into cross-bar array sites (“random access memory). Once placed in the desired array sites, the deposited cells and/or beads may be “read”, e.g., using bright-field or fluorescence microscopy, in a manner analogous to how electronic data is read in RAM memory chips. The acquired images may then be used to monitor a variety of cell functionalities, e.g., cell viability, motility, and secretion patterns.

The different embodiments of the disclosed magnetophoretic sorting devices and systems will, in general, comprise several structural and functional components in common, including:

(1) a substrate in contact with a fluid containing the magnetically-susceptible objects, e.g. cells that are physically-linked to a mobile magnetic particle or bead, thereby rendering the cells responsive to a magnetic force;
(2) a set of one or more magnetic tracks (or “magnetic patterns”) deposited on or embedded in the substrate near the fluid-contacting surface so that the magnetically-susceptible objects within the fluid experience the locally-strong magnetic field gradients arising from the patterned magnetic material and respond to the resulting local forces;
(3) a set of one or more external magnets (or electromagnets) configured to produce a time-varying, external magnetic field, the purpose for which is to magnetize and dynamically adjust the magnetic force interaction between the magnetically-susceptible objects and the patterned magnetic tracks such that the magnetic objects are moved in parallel along the pathways defined by the geometric arrangement of the magnetic tracks; said time-varying magnetic field having magnetic field components that are oriented in directions both parallel to and perpendicular to the fluid/substrate interface;
(4) optionally, a set of one or more patterned, electrically-conductive structures (e.g. “wires” or “nanowires”) deposited on or embedded in the substrate near the fluid-contacting surface and configured to produce a locally-active, time-varying magnetic field-by flowing electrical currents through the conductive wires, wherein the one or more conductive wire patterns are spatially-registered with respect to the one or more magnetic tracks (e.g., positioned between a first magnetizable track and a second magnetizable track), and are disposed so that short-range magnetic fields arising from the conductive wire pattern are used as a gate to switch magnetic objects between different pathways defined by the geometry of the magnetic tracks; and
(5) a magnetic field controller which dynamically adjusts the time-varying external magnetic field and the currents flowing in the electrically-conductive wires so as to precisely control, sort, and switch individual magnetic particles along programmable paths defined by the magnetic tracks.

In many embodiments, the substrate comprising the set of one or more magnetic tracks and the set of one or more electrically-conductive wire patterns may be integrated with a microfluidic structure which further comprises active or passive fluid-handling components including, but not limited to, fluid channels, fluid compartments (e.g., fluid “chambers”, “microchambers”), wells (or “microwells”), sample and reagent reservoirs, micropumps, microvalves, vents, traps, microfilters, micro-separation columns, membranes, and the like, or any combination thereof. The microfluidic structure may serve a variety of functions including, but not limited to, control of fluid delivery into and out of the device, alignment of fluid flow paths with the magnetic tracks, transport of magnetically-susceptible particles over long range distances, trapping of magnetically-susceptible particles at specific locations on the substrate, confinement of magnetically-susceptible particles to specific locations on the substrate (e.g. by defining an array of microchambers), isolation of and/or addressable control of fluid flow to specific locations on the substrate, and the like, or any combination thereof.

The magnetophoretic structural and functional components listed above may be integrated into devices or systems (“platforms”) that are capable of automating the assembly of large arrays of individual magnetic particles, e.g., magnetically-labeled cells, which have been sorted into and trapped within, e.g., an array of microfluidic chambers. In some embodiments, the devices or systems may also coordinate the placement of more than one type of magnetically-susceptible object, e.g., magnetically-labeled single cells of one or more cell types, cytokine sensor beads and/or other bio-conjugated magnetic beads, or any combination thereof, within each location of the array. In single cell applications, the disclosed magnetophoretic sorting platforms may enable measurement of single cell function by compartmentalizing one or more bio-conjugated magnetic sensing beads (e.g., cytokine sensing beads) in close proximity to each single cell. In some embodiments, the platform may also have the ability to remove the spent bead-based assay reagents and replace them with a fresh batch to enable a flexible method for querying longitudinal cell function. Thus, the magnetophoretic single cell analysis platforms disclosed in some embodiments described herein have the potential to reveal unprecedented temporal information about functional diversity in cell populations, e.g., T cell subsets, which may be exploited in a variety of applications, e.g., to develop novel therapies using patient derived cells.

Magnetophoretic device and system components may be organized and packaged in any of a variety of ways known to those of skill in the art. For example, in some embodiments, the substrate comprising the magnetic tracks and/or electrically-conductive wire structures and the integrated microfluidic structure may be packaged as a reusable or disposable device which interfaces with an instrument system comprising the external magnets and magnetic field controller. In some embodiments, the device may further comprise additional structural/functional elements, such as integrated temperature sensors, resistive heating elements, gas sensor, etc. In some embodiments, the instrument system may further comprise one or more of an optical imaging “module” or “subsystem” (or other means for monitoring the status of cells or other objects within the device), a translation stage module (e.g., for positioning microfluidic device(s) relative to the imaging subsystem), a fluidic control module (for controlling delivery of fluids to the device), temperature and gas control modules (for maintaining cell viability within the device), a stimulus module (for delivering chemical or physical stimuli to, for example, single cells within the device), one or more processors for providing instrument control and/or data processing and storage capabilities, etc., or any combination thereof.

Magnetically-Susceptible Objects:

As used herein, the term “magnetically-susceptible object” refers to any nanoscale or micron-scale object or particle which has a magnetic susceptibility (i.e. exhibits some degree of magnetization either inherently or in response to an applied magnetic field) that is larger than the fluid in which it is immersed, and which thus experiences a force as a result of interaction with the magnetic field. Materials exhibiting a positive magnetic susceptibility (i.e., that are attracted to regions of high magnetic field strength) include paramagnetic, ferromagnetic, ferrimagnetic, and antiferromagnetic materials, while diamagnetic materials exhibit a negative magnetic susceptibility (i.e. they are repelled from regions of high magnetic field strength). Examples of magnetically-susceptible objects or particles that are suitable for use in the disclosed methods, devices, and systems include, but are not limited to, magnetic nanoparticles, magnetic beads, silica- or polymer-coated magnetic nanoparticles or beads, and organic- or inorganic-conjugates thereof. In many embodiments of the disclosed methods, devices, and systems, the magnetically-susceptible objects may comprise magnetically-labeled cells or other bioparticles.

Cells and Other Bioparticles:

As used herein, the term “bioparticle” refers to any mobile particle that comprises a biological component and has a magnetic susceptibility which is larger than the surrounding fluid medium. In many embodiments, the bioparticles to be manipulated will comprise cells that have been magnetically-labeled using any of a variety of techniques known to those of skill in the art, e.g. by binding them to antibody-conjugated magnetic nanoparticles where the antibodies are directed towards a specific cell surface antigen. In addition to sorting or otherwise manipulating cells, the disclosed devices and system may be used for manipulating magnetically-labeled cell fragments, cellular organelles (e.g. mitochondria or nuclei) or other sub-cellular structures, micelles, blebs, liposomes, bacteria, virus particles, exosomes, microparticles, nanoparticles, magnetic beads or nanoparticles that have been conjugated to antibodies, enzymes, receptors, ribosomes, proteins, carbohydrate molecules, polysaccharide molecules, lipid molecules, small organic molecules, DNA molecules, RNA molecules, mRNA molecules, or oligonucleotides, or any combination thereof. In some embodiments, the bioparticles comprise micron-sized magnetic particles that are functionalized to capture specific molecules present in the fluid, thereby serving as mobile chemical sensing elements (i.e., “chemical sensing beads”).

For example, chemical sensing beads may comprise magnetic particles conjugated to antibodies, cytokine-specific antibodies, chemokine-specific antibodies, growth factor-specific antibodies, protein-specific antibodies, phosphoprotein-specific antibodies, protein post-translational modification-specific antibodies, another antibody, an aptamer, a glycoprotein, a protein, an enzyme, a small molecule, a drug molecule, a cell signaling agent, a polysaccharide, a fluorophore, an oligonucleotide, an oligonucleotide barcode, or any combination thereof.

In some embodiments, chemical sensing beads may comprise magnetic particles conjugated to a molecule that adheres to the outer membrane of a virus particle selected from the group consisting of influenza virus, rhinovirus, cytomegalovirus, Epstein-barr virus, ebola virus, Marburg virus, zika virus, dengue virus, measles virus, mumps virus, polio virus, rubella virus, varicella-zoster virus, a member of the hepatitis family of viruses, a member of the HIV family of viruses, a member of the herpes family of viruses, an adenovirus, or a retrovirus.

In some embodiments, the use of chemical sensing beads may enable measurement of the concentration (or “level”) of a specific molecule, e.g. a cytokine, a chemokine, a growth factor, a virus particle, etc., using, for example, an immunofluorescence assay and monitoring a fluorescent signal, an optical signal, a color change, an electrical signal, a pH change, an enzymatic reaction, or any combination thereof. In some embodiments, magnetically-susceptible beads may each comprise an attached oligonucleotide barcode that codes for the identity of cells, antigen-specific antibodies, or other molecules conjugated thereto.

Any of a variety of cells may be sorted into specific array sites or otherwise manipulated using the disclosed methods, devices, and systems including, but not limited to, adherent and non-adherent eukaryotic cells, mammalian cells, primary and immortalized human cells or cell lines, primary and immortalized rodent cells or cell lines, cancer cells, normal or diseased human cells from different organs or tissue types (e.g. white blood cells, red blood cells, platelets, epithelial cells, endothelial cells, neurons, glial cells, astrocytes, fibroblasts, skeletal muscle cells, smooth muscle cells, gametes, or cells from the heart, lungs, brain, liver, kidney, spleen, pancreas, thymus, bladder, stomach, colon, small intestine), distinct cell subsets such as CD8⁺ T cells, CD4⁺ T cells, CD44^{high}/CD24^{low} cancer stem cells, Lgr5/6⁺ stem cells, undifferentiated human stem cells, human stem cells that have been induced to differentiate, rare cells (e.g. circulating tumor cells (CTCs), circulating epithelial cells, circulating endothelial cells, circulating endometrial cells, bone marrow cells, progenitor cells, foam cells, mesenchymal cells, or trophoblasts), animal cells (e.g. mouse, rat, pig, dog, cow, or horse), plant cells, yeast cells, fungal cells, bacterial cells, algae cells, adherent and non-adherent prokaryotic cells, and the like.

In some applications, the cells to be sorted or otherwise manipulated may be immune cells. Immune cells may include, for example, T cells, B cells, lymphoid stem cells, myeloid progenitor cells, lymphocytes, granulocytes, B-cell progenitors, T cell progenitors, Natural Killer cells, cytotoxic T cells, helper T cells, alpha beta T cells, gamma delta T cells, plasma cells, memory cells, neutrophils, eosinophils, basophils, mast cells, monocytes, dendritic cells, and/or macrophages, or any combination thereof.

In some applications, the disclosed magnetophoretic devices and systems may be used for the study of T cells. As indicated above, there are a variety of different T cell types, including effector T cells, helper T cells, cytotoxic (killer) T cells, memory T cells, regulatory T cells, natural killer (NK) cells, alpha beta T cells, gamma delta T cells, etc. T cells may be T cell clones, which may refer to T cells derived from a single T cell or to those T cells having identical T cell receptors (TCRs). A T cell may be part of a T cell line which may include T cell clones and/or mixed populations of T cells with different TCRs all of which may recognize the same target (e.g., an antigen, a tumor cell, or a virus). T cells may be obtained from a variety of sources, including peripheral blood mononuclear cells, bone marrow, lymph node tissue, spleen tissue, and tumors. The T cells to be studied may be obtained from a unit of blood collected from a subject, such as an individual or patient, using, for example, Ficoll separation techniques [A. Bøyum (1976), “Isolation of Lymphocytes, Granulocytes and Macrophages”, Scand. J. Immunol. 5(s5):9-15; C. Corkum, et al. (2015), “Immune Cell Subsets and their Gene Expression Profiles from Human PBMC Isolated by Vacutainer Cell Preparation Tube (CPT™) and Standard Density Gradient”, BMC Immunology 16:48]. Cells from the circulating blood of an individual can be obtained by apheresis or leukapheresis. The apheresis product may comprise lymphocytes, including T cells, monocytes, granulocytes, B cells, other nucleated white blood cells, red blood cells, and platelets. The cells can then be washed and re-suspended in media, or magneto-affinity purified as described below, to isolate the cell of interest.

T cells may be isolated from peripheral blood lymphocytes by lysing the red blood cells and depleting the monocytes, for example, by centrifugation through a PERCOLL™ gradient. A specific subpopulation of T cells, such as CD28⁺, CD4⁺, CDC, CD45RA⁺, and CD45RO⁺ T cells, can be further isolated by positive or negative selection techniques. For example, T cells can be isolated by incubation with anti-CD3/anti-CD28 (i.e., 3×28)-conjugated beads, such as DYNABEADS® Human T-Activator CD3/CD28 magnetic beads, or DYNABEADS® CD3/CD28 CTS™ magnetic beads [Thermo Fisher Scientific], at a cell:bead ratio of approximately 1:1 XCYTE DYNABEADS™ for a time period, e.g., about 6 hours, sufficient for positive selection of the desired T cells [Fan, et al. (2015), “Combinatorial Labeling of Single Cells for Gene Expression Cytometry”, Science 347(6222):1258367].

In some embodiments, the magnetically-labeled bioparticles may comprise nematodes, embryos, single cell organisms, other living organisms, or any combination thereof.

Magnetic Nanoparticles and Beads:

In some embodiments, the magnetic nanoparticles or beads utilized in the disclosed methods, devices, and systems may comprise magnetic nanoparticles or beads embedded inside a silica shell or polymeric matrix. In some embodiments, the magnetic nanoparticles or beads may comprise a functionalized surface, e.g. having primary amines or carboxylate groups attached, thereby facilitating covalent conjugation to biomolecules. In some embodiments, the magnetic nanoparticles or beads may comprise a coating of biotin or streptavidin for facilitating non-covalent conjugation of biological molecules. In some embodiments, the magnetic nanoparticles or beads may further comprise optical tags, e.g., fluorescent dyes, quantum dots, or other luminescent tags, to make them fluorescent or otherwise luminescent in one or more optical wavelength ranges. Examples of suitable commercially-available magnetic nanoparticles and beads include, but are not limited to, superparamagnetic Dynabeads (Invitrogen, Grand Island, N.Y., USA), superparamagnetic MyOne™ and M-270™ beads (Dynal Biotech, Madison, Wis., USA), MagPlex® Microspheres (Luminex, Austin, Tex., USA), MagPlex-TAG™ Microspheres (Luminex, Austin, Tex., USA), and the like.

In some embodiments of the disclosed devices and systems, the magnetic nanoparticles utilized for conjugation to cells or other bioparticles may have diameters in the range of about 1 to about 1,000 nm. In some embodiments, the magnetic nanoparticles may have diameters of at least 1 nm, at least 5 nm, at least 10 nm, at least 25 nm, at least 50 nm, at least 75 nm, at least 100 nm, at least 200 nm, at least 300 nm, at least 400 nm, at least 500 nm, at least 600 nm, at least 700 nm, at least 800 nm, at least 900 nm, or at least 1,000 nm. In some embodiments, the magnetic nanoparticles may have diameters of at most 1,000 nm, at most 900 nm, at most 800 nm, at most 700 nm, at most 600 nm, at most 500 nm, at most 400 nm, at most 300 nm, at most 200 nm, at most 100 nm, at most 75 nm, at most 50 nm, at most 25 nm, at most 10 nm, at most 5 nm, or at most 1 nm. Any of the lower and upper values described in this paragraph may be combined to form a range included within the disclosure, for example, the diameter of the magnetic nanoparticles may range from about 25 nm to about 400 nm. Those of skill in the art will recognize that the magnetic nanoparticles used may have any diameter within this range, for example, about 32 nm.

In some embodiments, the magnetic beads utilized for conjugation to cells or other bioparticles may have diameters in the range of about 1 μm to about 50 μm. In some embodiments, the magnetic beads may have diameters of at least 1 μm, at least 5 μm, at least 10 μm, at least 20 μm, at least 30 μm, at least 40 μm, or at least 50 μm. In some embodiments, the magnetic beads may have diameters of at most 50 μm, at most 40 μm, at most 30 μm, at most 20 μm, at most 10 μm, at most 5 μm, or at most 1 μm. Any of the lower and upper values described in this paragraph may be combined to form a range included within the disclosure, for example, the diameter of the magnetic beads may range from about 5 μm to about 40 μm. Those of skill in the art will recognize that the magnetic beads used may have any diameter within this range, for example, about 23 μm.

Magnetic Transport:

In the disclosed methods, devices, and systems, magnetically-susceptible objects are transported by means of a time-modulated magnetostatic potential energy landscape, which is produced by exposing a lithographically-defined or otherwise fabricated pattern of, e.g., Ni₈₁Fe₁₉ (permalloy) thin film on the substrate surface, to a time-varying external magnetic field [Lim B, et al. (2014), “Magnetophoretic Circuits for Digital Control of Single Particles and Cells”, Nat Commun 5: 3846]. It is the superposition of the time-varying external magnetic field and the local magnetic field produced by the magnetic tracks on the substrate that creates the traveling potential energy landscape. The attractive regions appear in locations where the external field is parallel to the normal direction of the pattern curvature. For a system of serially connected magnetic disks (one example of a “magnetic track”), the attractive regions circulate around the periphery of the disks, moving from one disk to the next with speed proportional to the rotation frequency of the external field. The direction of motion is controlled by the sense of the rotating magnetic field. The transport characteristics are thus analogous to Ohm's law for electronic circuits (V=IR), where frequency is like the voltage (ω=I_{c}R), I_{c} is the cell current, and R is a resistance factor.

Magnetic objects will follow one of two distinct types of motion depending on the ability of the objects to remain trapped with respect to the traveling energy landscape. These distinct types of motion are known as the “phase locked” regime and the “phase slipping” regime. In the phase-locked regime, which occurs at low frequencies, all objects move synchronously with the energy landscape, traveling at the exact same speed. In the phase-slipping regime, which occurs at high frequencies, the objects cannot remain trapped in the energy landscape, and instead periodically slip relative to the energy landscape. In the phase-slipping regime, the particles move at a lower time-averaged velocity than that of the energy landscape. Each magnetic object has a specific critical velocity, which defines the crossover from the phase-locked to the phase-slipping regime, and which depends on the object's magnetic moment, size, and shape. As demonstrated in previous work [Yellen, et al. (2007), “Traveling Wave Magnetophoresis for High Resolution Chip Based Separations”, Lab Chip 7:1681-1688; PCT Patent Application Publication No. WO2008/156688 A2], by tuning the velocity of the landscape, it is possible to separate objects based on differences in their critical velocities, corresponding to the differences in their material or geometric properties.

In some embodiments of the disclosed methods, magnetically-susceptible objects are transported in the phase-locked regime. In some embodiments, magnetically-susceptible objects are transported in the phase-slipping regime. In some embodiments, magnetically-susceptible objects are transported in either the phase-locked regime or the phase-slipping regime by means of adjusting the frequency with which the external magnetic field is modulated, or by using mixtures of magnetic particles or beads having different material or geometric properties.

In the phase-locked transport regime, magnetically-susceptible objects move with an average velocity that is linearly related to the frequency with which the external magnetic field is modulated. In some embodiments, the average velocity with which the magnetically-susceptible objects travel along the magnetic tracks may range from about 0 μm/sec to about 200 μm/sec, or more. In some embodiments, the average velocity of the magnetically-susceptible objects may be at least 0 μm/sec, at least 5 μm/sec, at least 10 μm/sec, at least 20 μm/sec, at least 30 μm/sec, at least 40 μm/sec, at least 50 μm/sec, at least 75 μm/sec, at least 100 μm/sec, at least 125 μm/sec, at least 150 μm/sec, at least 175 μm/sec, or at least 200 μm/sec. In some embodiments, the average velocity of the magnetically-susceptible objects may be at most 200 μm/sec, at most 175 μm/sec, at most 150 μm/sec, at most 125 μm/sec, at most 100 μm/sec, at most 75 μm/sec, at most 50 μm/sec, at most 40 μm/sec, at most 30 μm/sec, at most 20 μm/sec, at most 10 μm/sec, or at most 5 μm/sec. Any of the lower and upper values described in this paragraph may be combined to form a range included within the disclosure, for example, the average velocity may range from about 5 μm/sec to about 40 μm/sec. Those of skill in the art will recognize that the average velocity of the magnetically-susceptible objects may have any value within this range, for example, about 23 μm/sec.

Magnetic Tracks:

As used herein, the phrase “magnetic track” refers to a linear, periodic arrangement of magnetic structures (i.e., a “magnetic pattern”) that leads to directional motion of magnetically-susceptible objects when placed in a time-varying external magnetic field. The magnetic tracks thus function as the magnetophoretic equivalent of electrical conductors. In some embodiments, the magnetic pattern may comprise a two-dimensional geometry (or “shape”) that includes T-shapes, I-shapes, linear-shapes, serpentine-shapes, shapes of undulating width, arc-shapes, C-shapes, Y-shapes, stepped-shapes, zigzag-shapes, chevron-shapes, tear-drop shapes, or arbitrary-shapes. In some embodiments, the magnetic pattern comprises a continuous series of sections having either positive or negative curvature, where the magnetizable track is deposited on or embedded within the surface of the substrate, and is in close proximity to, or in direct contact with, the fluid comprising the magnetic objects. In some embodiments, the magnetizable track is deposited on or embedded within the surface of the substrate, and is in close proximity to, or in direct contact with, fluid confined within at least a portion of a microfluidic structure.

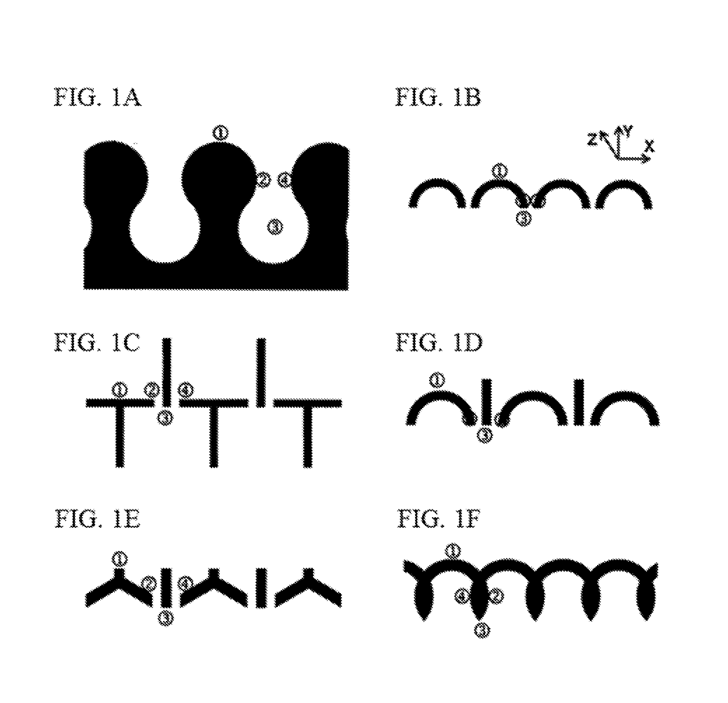

FIGS. 1A-D illustrate various types of magnetic patterns that can be used to achieve bidirectional transport of magnetically-susceptible objects, e.g. magnetically-linked bioparticles, in a time-varying magnetic field having both vertical and horizontal field components. The magnetic particles can be transported in the shifting magnetic field gradients induced by an appropriately timed sequence of varying external magnetic fields. In FIGS. 1A-D, the magnetic field is pointing in the positive z-direction (i.e., out of the page). Starting from the initial condition in which the horizontal field is pointing in the positive y-direction, the attractive position of the magnetic particle is denoted by location (1). As the horizontal field is rotated, the subsequent attractive positions of the magnetic particles are denoted by the (2), (3), and (4) locations, which occur as the clockwise rotating field is shifted by 90 degree rotational increments. When the magnetic particle reaches location (4), it will then move to location (1) on the next magnetic element, which enables the magnetic particle to advance by one spatial period during each complete rotation cycle of the external field.

Various patterns can be used to achieve linear transport of magnetically-susceptible objects down these magnetic tracks. A drop-shaped pattern is shown in FIG. 1A, an arc-shaped C pattern is shown in FIG. 1B, a TI pattern is shown in FIG. 1C, a CI pattern is shown in FIG. 1D, a VI pattern is shown in FIG. 1E, and a spiral pattern is shown in FIG. 1F. Some of these patterns are similar to the types of tracks used to manipulate magnetization bubbles in garnet films, as described by Hsu Chang, Magnetic Bubble Memory Technology, Marcel Dekker Publishing, 1978; however, in the present disclosure the magnetic tracks are used to move physical objects instead of domains of magnetization. In some embodiments, an optimal magnetic track pattern is one in which the magnetic particle can achieve the highest time-averaged horizontal velocity along the tracks. The tracks illustrated in FIGS. 1A-F are bi-directional, which implies that transport direction can be switched from the positive to the negative x-direction by changing the in-plane rotating field from the clockwise to the counter-clockwise direction.

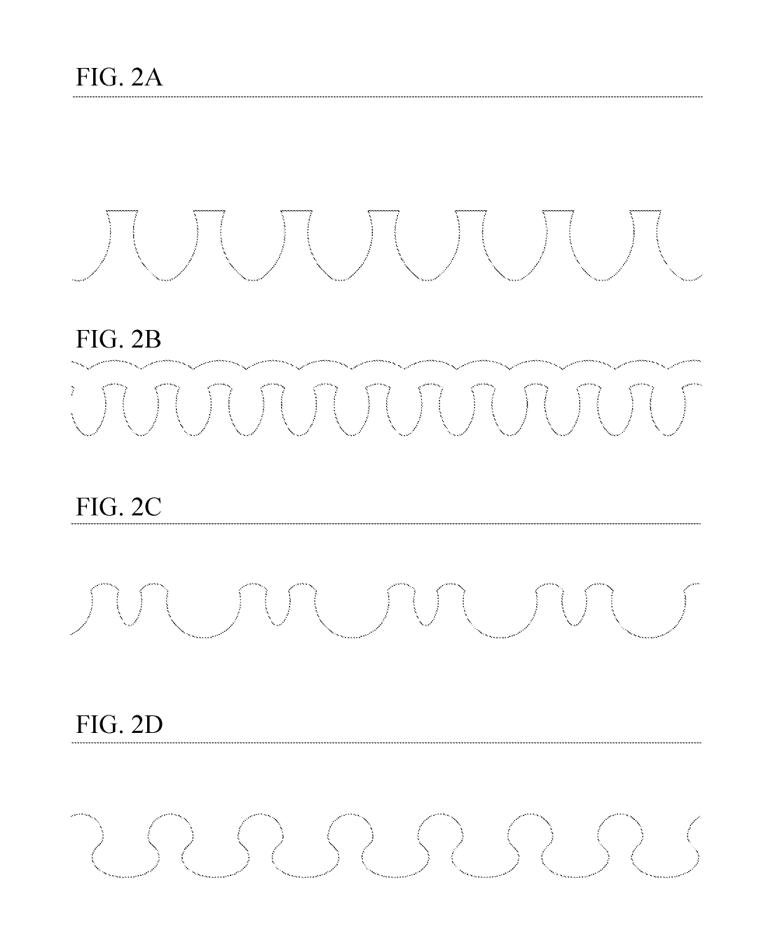

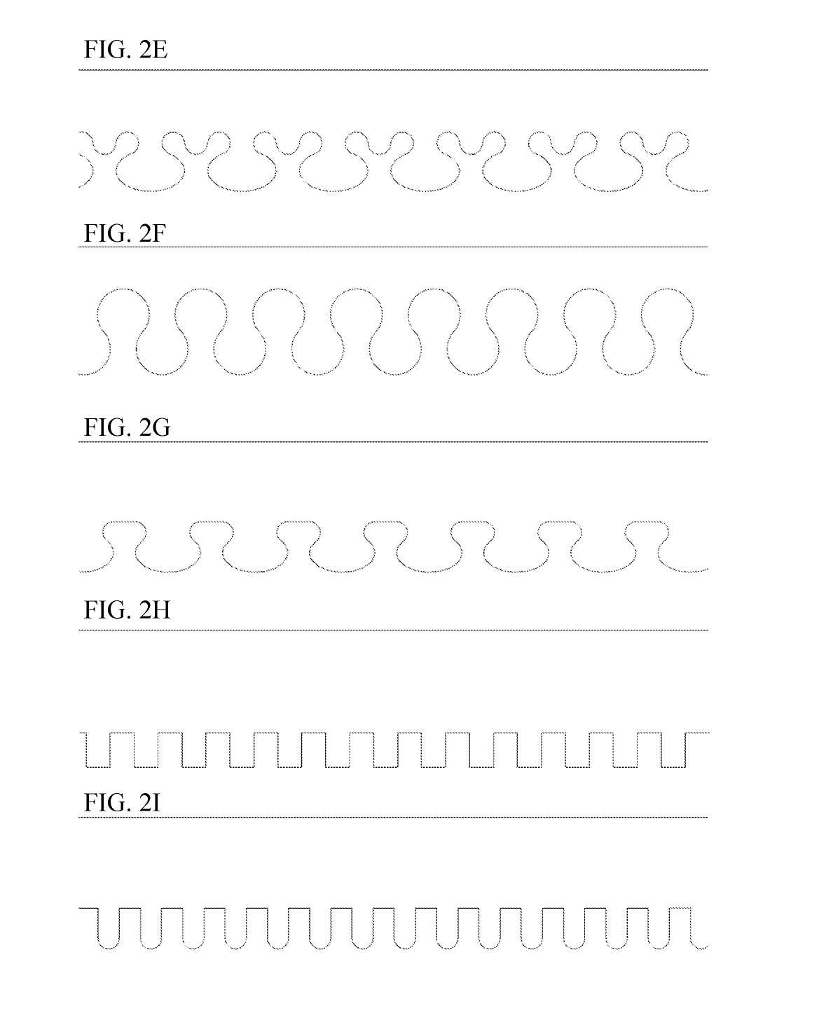

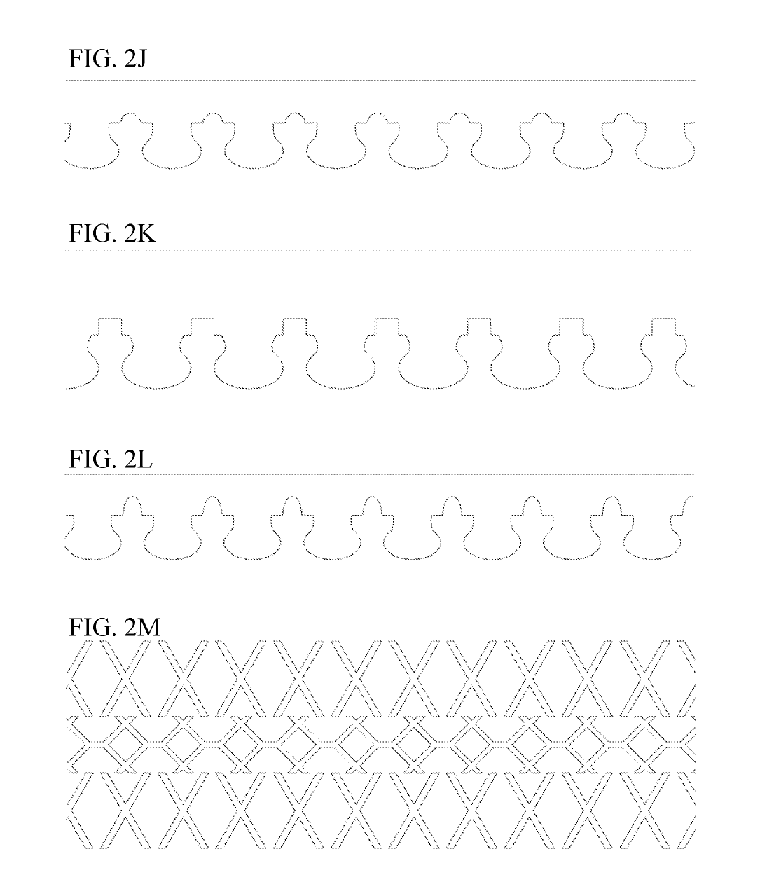

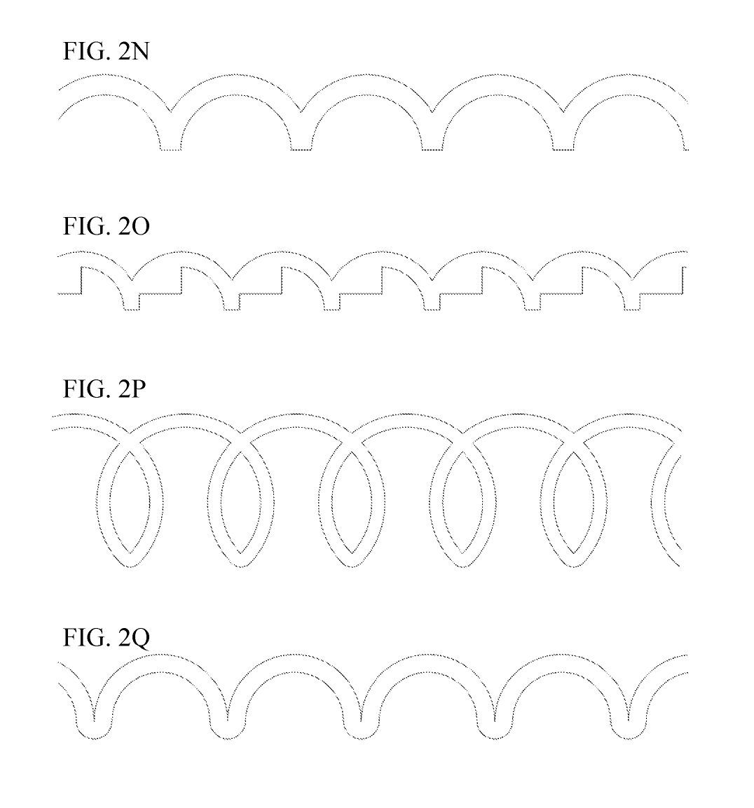

FIGS. 2A-Q illustrate additional non-limiting examples of magnetic patterns which comprise a continuous series of sections having either positive or negative curvature, and which may be used to guide the motion of magnetically-linked bioparticles along linear tracks.

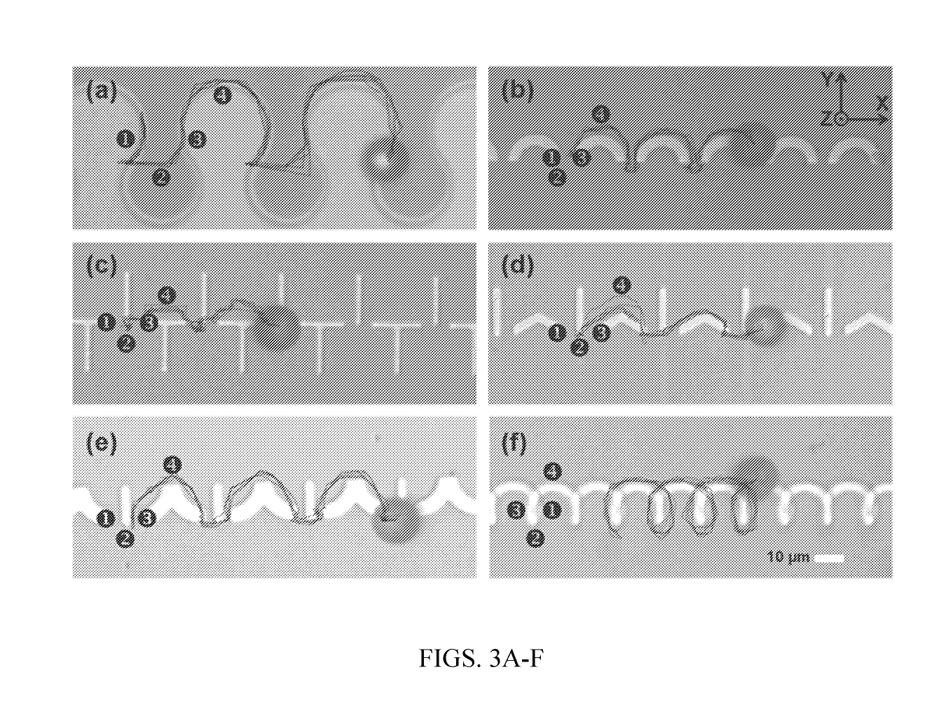

FIGS. 3A-F illustrate the motion of magnetic particles along magnetic tracks of different patterns in a 45 Oe rotating magnetic field. An in-plane magnetic field is rotating in the clockwise direction and a static magnetic field is applied in the positive z-direction. The 15-micron sized magnetic beads used in this example are transported in the positive x-direction. The trajectories of the magnetic beads are shown with the black lines, and are consistent with the positions (1)-(4) shown in FIGS. 1A-F.

FIGS. 4A-F illustrate how a vertical field component is necessary to achieve controlled transport of magnetic particles along the magnetic tracks of FIGS. 1-3. The cone angle for the time varying external magnetic field is defined by the inverse tangent of the vertical to horizontal field components. A cone angle of 90 degrees corresponds to a purely in-plane rotating magnetic field, whereas a cone angle of 0 degrees corresponds to a static vertical field. When the cone angle is less than 30 degrees (FIG. 4A: cone angle=0 degrees; FIG. 4B: cone angle=26 degrees), the 8-micron magnetic beads used in this example move in closed loops and cannot be transported down the magnetic tracks. When the cone angle is in between 30 and 60 degrees, the magnetic beads can be transported along the magnetic tracks (FIG. 4C: cone angle=37 degrees; FIG. 4D: cone angle=45 degrees; FIG. 4E: cone angle=53 degrees). When the cone angle is greater than 60 degrees (FIG. 4F: cone angle=63 degrees), the magnetic beads again move in closed loops and cannot be transported down the magnetic tracks.

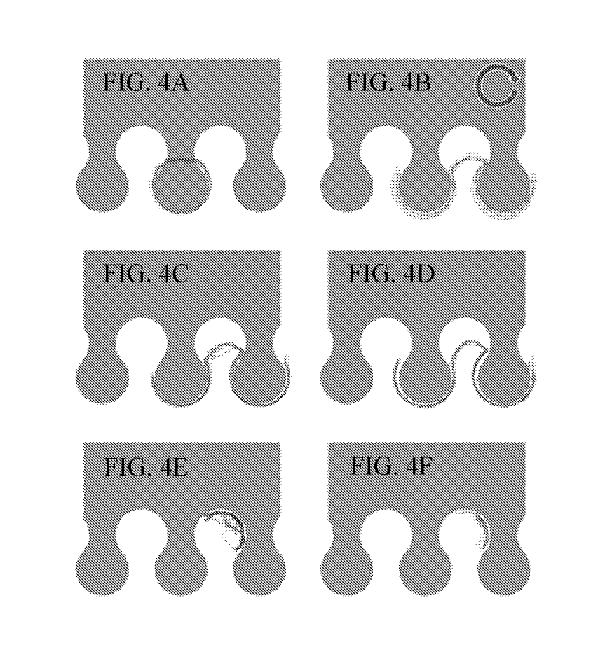

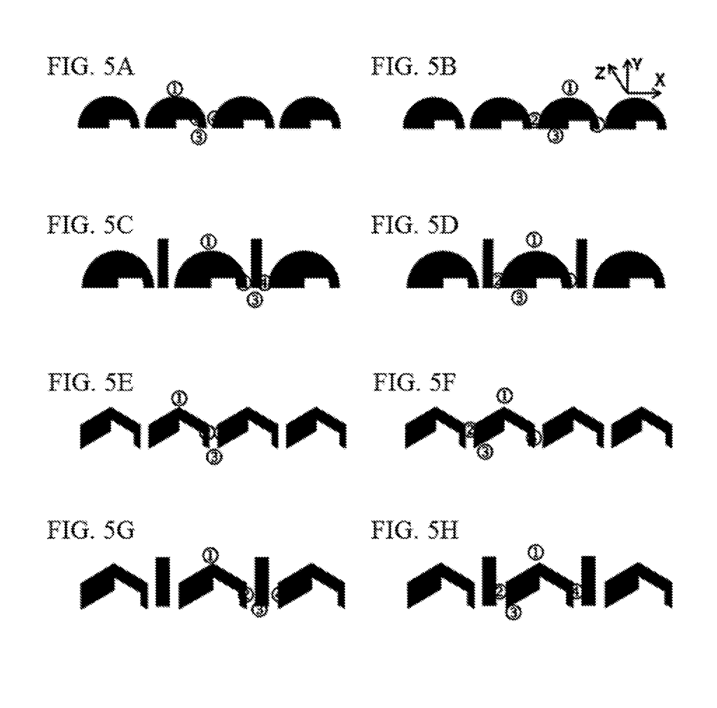

FIGS. 5A-H illustrate magnetic track designs capable of inducing uni-directional magnetic particle transport. These track geometries can move magnetic particles along the positive x-direction in a clockwise rotating field (FIGS. 5A, C, E, and G). However, the magnetic particles move in closed loop trajectories in a counter-clockwise rotating field. These track elements behave similarly to electrical diodes, which permit one-way current flow. One-way flow is implemented by introducing asymmetry in the pattern. Similar types of geometries have been described in the magnetic bubble literature for controlling magnetization domains inside solid-state iron garnet films [Hsu Chang, Magnetic Bubble Memory Technology, Marcel Dekker Publishing, 1978].

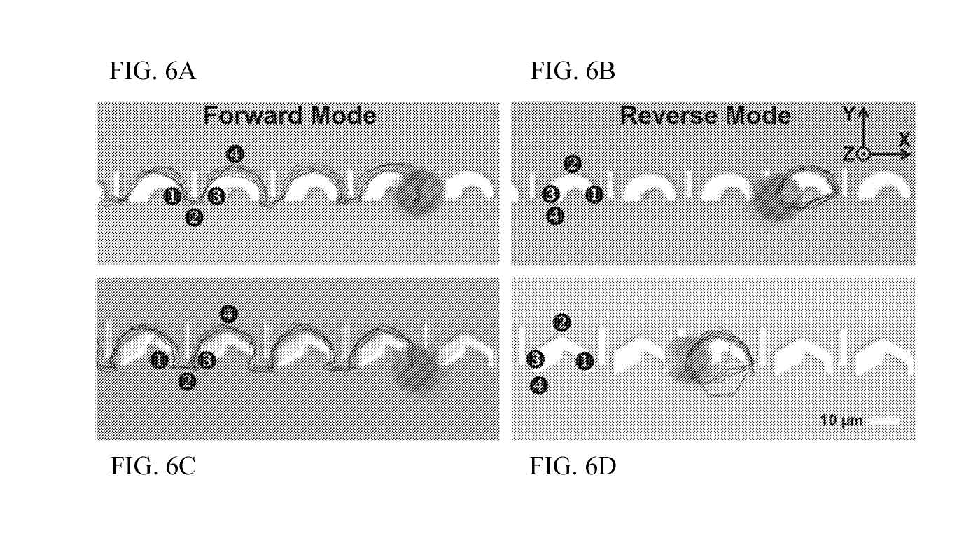

FIGS. 6A-D illustrate uni-directional magnetic particle transport. Due to the asymmetry of the pattern, the magnetic particles are transported in the positive x-direction in a clockwise rotating field, as shown in FIGS. 6A and 6C. The particle trajectories consist of closed loops when the external field is rotating in the counterclockwise direction, as shown in FIGS. 6B and 6D.

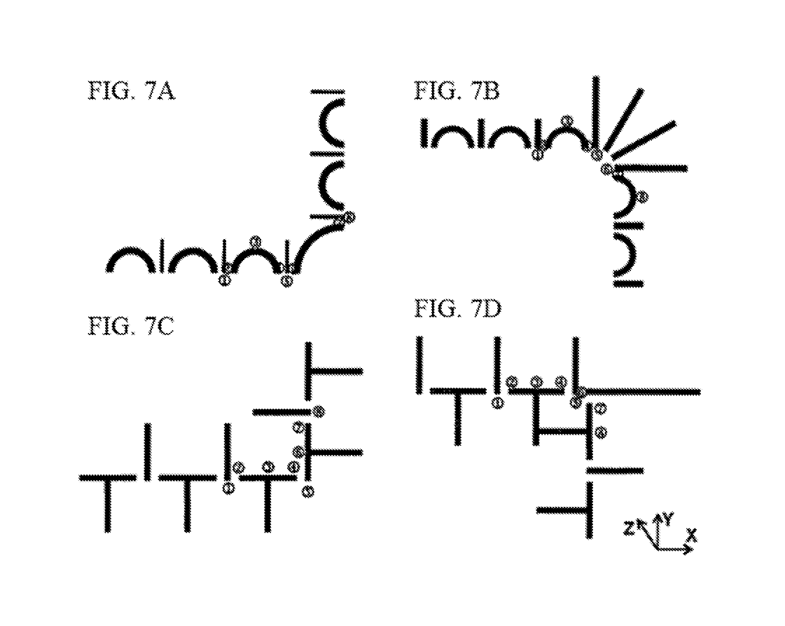

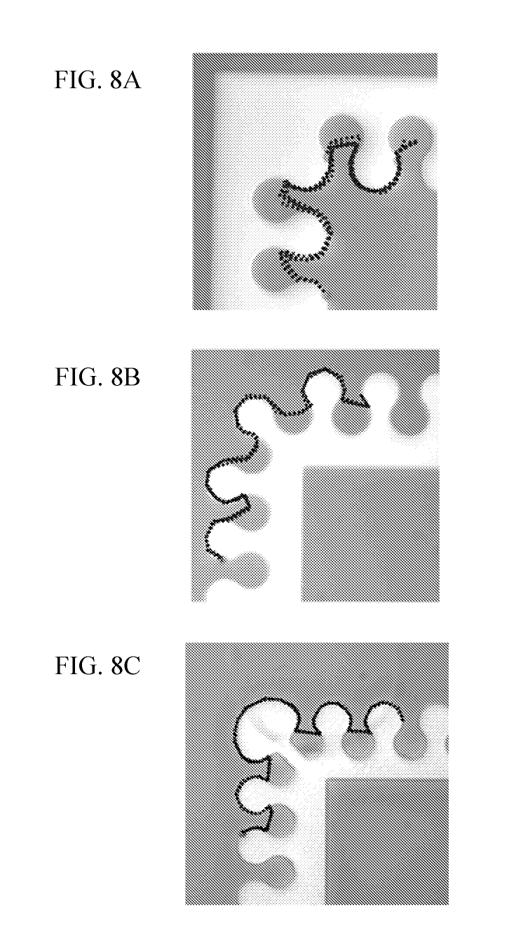

FIGS. 7A-D illustrate magnetic track patterns that induce the magnetic particles to make right-hand or left-hand turns. The left-hand turn on a CI pattern is shown in FIG. 7A, in which the numbers (1)-(8) depict the positions of the magnetic particle at each 90 degree interval in the direction of the in-plane rotating field. Therefore, 2 cycles of the rotating field are shown. The right-hand turn on a CI a pattern is likewise shown in FIG. 7B. The left-hand turn on a TI pattern is shown in FIG. 7C, and a right-hand turn is shown in FIG. 7D. FIGS. 8A-C show additional examples of magnetic tracks that induce magnetic particles to make right-hand or left-hand turns.

Fabrication of Magnetic Patterns on Substrates:

Substrates for use in the disclosed devices and systems may be fabricated from any of a number of suitable materials, or combinations thereof, known to those of skill in the art. In some embodiments, the substrate may be fabricated from silicon. Other suitable materials include, but are not limited to, fused-silica, glass, ceramic, metallic, or polymer materials (e.g. poly-methyl-methacrylate (PMMA), polycarbonate (PC), polystyrene (PS), polypropylene (PP), polyethylene (PE), high density polyethylene (HDPE), polyimide, cyclic olefin polymers (COP), cyclic olefin copolymers (COC), polyethylene terephthalate (PET)), or any combination thereof. In general, a substrate comprising a solid surface upon which magnetic tracks and/or electrically-conducting structures may be fabricated (i.e. deposited on or embedded within) will suffice.

The magnetic tracks or patterns may be fabricated using any of a number of techniques and materials known to those of skill in the art. In general, the choice of fabrication technique used will depend on the choice of substrate material used, and vice versa. Examples of suitable materials for fabricating the magnetic tracks include, but are not limited to, iron, nickel-iron alloys, nickel-molybdenum-iron alloys, cobalt-iron alloys, iron-silicon alloys, other materials having low coercivity and high magnetizability, or any combination thereof. In some embodiments, the magnetic tracks are fabricated using soft magnetic materials that are not permanently magnetized, e.g. paramagnetic or super-paramagnetic materials. In some embodiments, the magnetic patterns are fabricated of Ni₈₁Fe₁₉ (permalloy).

Examples of suitable fabrication techniques (dependent on the choice of substrate and magnetic track materials) include, but are not limited to, photolithographic patterning followed by thin film deposition (e.g. by chemical vapor deposition, plasma-enhanced chemical vapor deposition, sputter coating, etc.) and lift off of a sacrificial material (e.g. a photoresist); photolithographic patterning and etching of the substrate (e.g. using wet chemical etching, plasma etching, or deep reactive ion etching (DRIE))), followed by thin film deposition and polishing; micro-molding, micro-embossing, or laser micromachining, followed by thin film deposition and polishing; 3D printing or other direct write fabrication processes using curable materials; and similar techniques.

As discussed above, in some embodiments the magnetic tracks comprises a continuous series of pattern sections having either positive or negative curvature. In general, the width of the tracks will vary in a periodic manner, and may range from about 1 μm to about 100 μm. In some embodiments, the magnetic tracks may have average widths of at least 1 μm, at least 2 μm, at least 3 μm, at least 4 μm, at least 5 μm, at least 10 μm, at least 15 μm, at least 20 μm, at least 30 μm, at least 40 μm, at least 50 μm, or at least 100 μm. In some embodiments, the magnetic tracks may have average widths of at most 100 μm, at most 50 μm, at most 40 μm, at most 30 μm, at most 20 μm, at most 15 μm, at most 10 μm, at most 5 μm, at most 4 μm, at most 3 μm, at most 2 μm, or at most 1 am. Any of the lower and upper values described in this paragraph may be combined to form a range included within the disclosure, for example, the average width of the magnetic tracks may range from about 3 μm to about 20 μm. Those of skill in the art will recognize that the magnetic tracks may have any average width within this range, for example, about 12 μm.

In general the thickness of the magnetic tracks may range from about 10 nm to about 10 μm, or more, where thicker tracks provide for stronger local magnetic fields and faster mean velocities for magnetic particle transport. In some embodiments, the magnetic tracks may have a thickness of at least 10 nm, at least 25 nm, at least 50 nm, at least 75 nm, at least 100 nm, at least 125 nm, at least 150 nm, at least 175 nm, at least 200 nm, at least 500 nm, at least 1 μm, at least 5 μm, or at least 10 μm, or more. In some embodiments, the magnetic tracks may have a thickness of at most 10 μm, at most 5 μm, at most 1 μm, at most 500 nm, at most 200 nm, at most 175 nm, at most 150 nm, at most 100 nm, at most 75 nm, at most 50 nm, at most 25 nm, or at most 10 nm. Any of the lower and upper values described in this paragraph may be combined to form a range included within the disclosure, for example, the thickness of the magnetic tracks may range from about 50 nm to about 125 nm. Those of skill in the art will recognize that the magnetic tracks may have any thickness within this range, for example, about 110 nm. In some embodiments, the use of techniques such as electroplating may allow fabrication of magnetic tracks of thicknesses that are much greater than 10 μm.

In some embodiments, the magnetic track(s) of the disclosed devices and systems comprise a multi-layered stack structure which further comprises two or more magnetic layers with a non-magnetic layer disposed between adjacent magnetic layers. In these embodiments, the non-magnetic layer may be fabricated from any of a number of suitable materials known to those of skill in the art, for example, using non-magnetic metals, silicon, fused-silica, glass, ceramic, or a polymeric material. Such multi-layered stack structures may function in a manner similar to spin valves, i.e. structures which consist of magnetic layers spaced apart by a non-magnetic layer, e.g., a non-magnetic metal or an oxide layer, and for which electrical resistance can easily be switched between a low conductance state and a high conductance state in response to a change in the magnetization of the layers arising from a change in the strength of the external magnetic field. Such structures may therefore function both as magnetic tracks and as part of electrically-conducting patterns used to provide switching capability in magnetophoretic circuits.

In some embodiments, the surfaces of the magnetic track that interface with the fluid may be coated with a protective or insulating layer, e.g. a silicon dioxide layer, a silicon nitride layer, another type of oxide layer, a polymer layer, or any combination thereof. In other embodiments, the surface of the magnetic tracks may be coated with a non-fouling layer, as well be discussed in more detail below. In general, the thickness of such insulating layers may range from about 10 nm to about 1000 nm, which depends on the geometry of the underlying magnetic track structure and the strength of the fields these tracks can produce in the fluid. In some embodiments, the insulating layer may have a thickness of at least 10 nm, at least 25 nm, at least 50 nm, at least 75 nm, at least 100 nm, at least 125 nm, at least 150 nm, at least 175 nm, at least 200 nm, at least 500 nm, or at least 1000 nm. In some embodiments, the insulating layer may have a thickness of at most 1000 nm, at most 500 nm, at most 200 nm, at most 175 nm, at most 150 nm, at most 100 nm, at most 75 nm, at most 50 nm, at most 25 nm, or at most 10 nm. Any of the lower and upper values described in this paragraph may be combined to form a range included within the disclosure, for example, the thickness of the insulating layer may range from about 50 nm to about 125 nm. Those of skill in the art will recognize that the insulating layer may have any thickness within this range, for example, about 118 nm.

Magnetophoretic “Conductors”, “Diodes, and “Capacitors”:

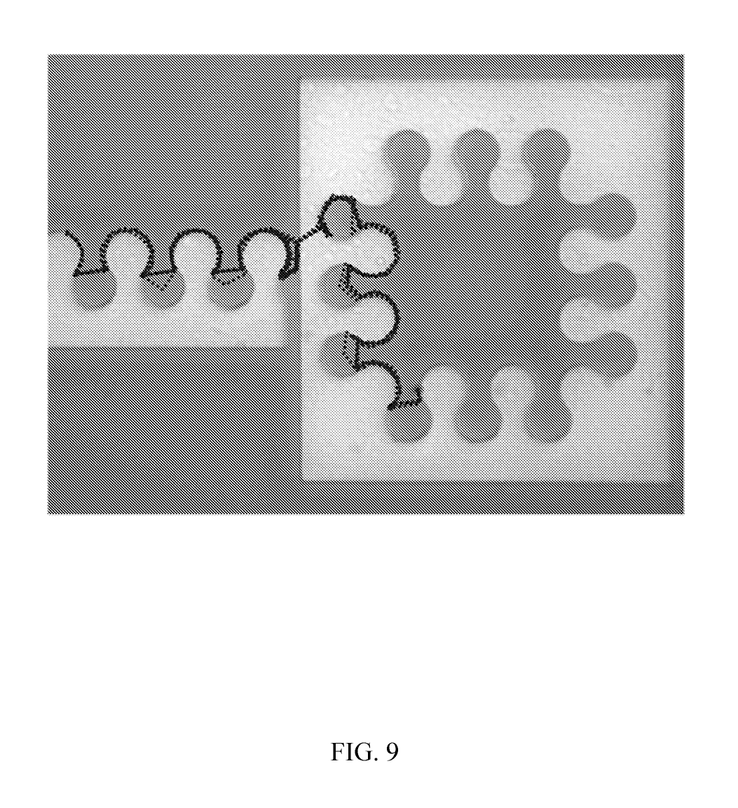

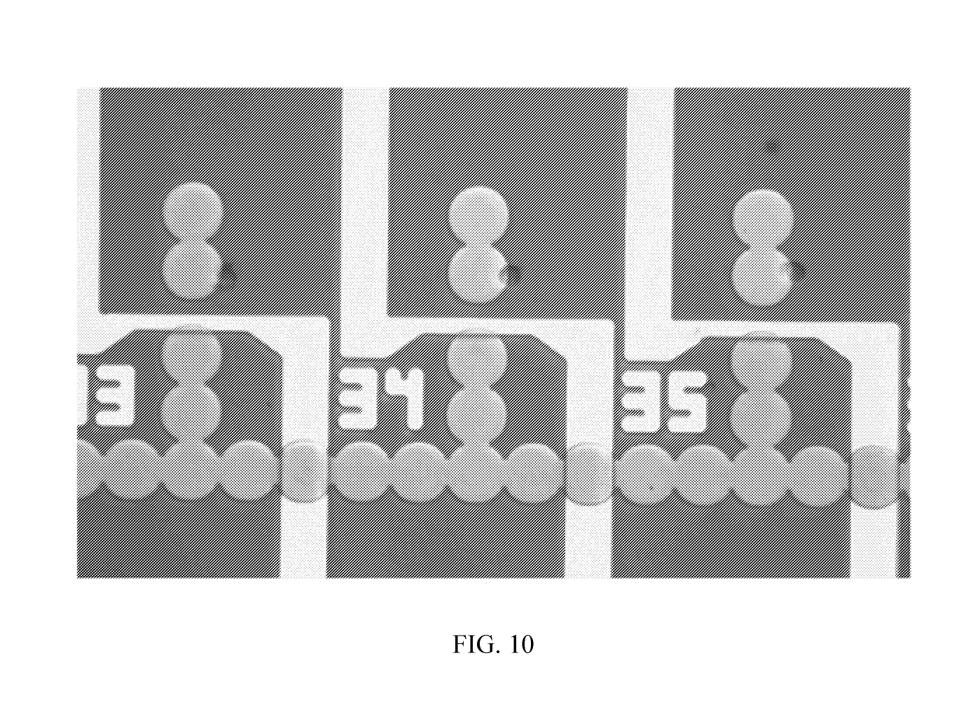

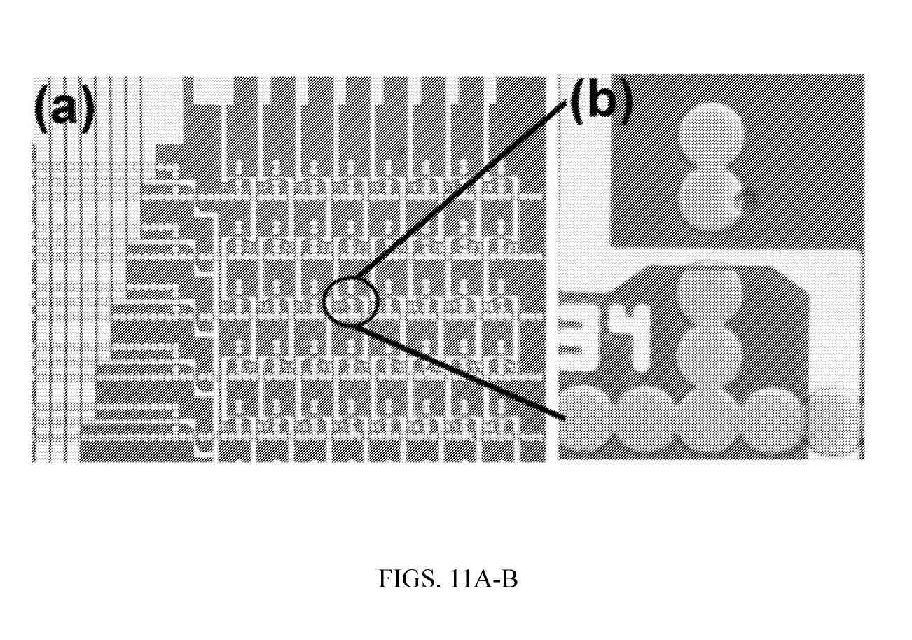

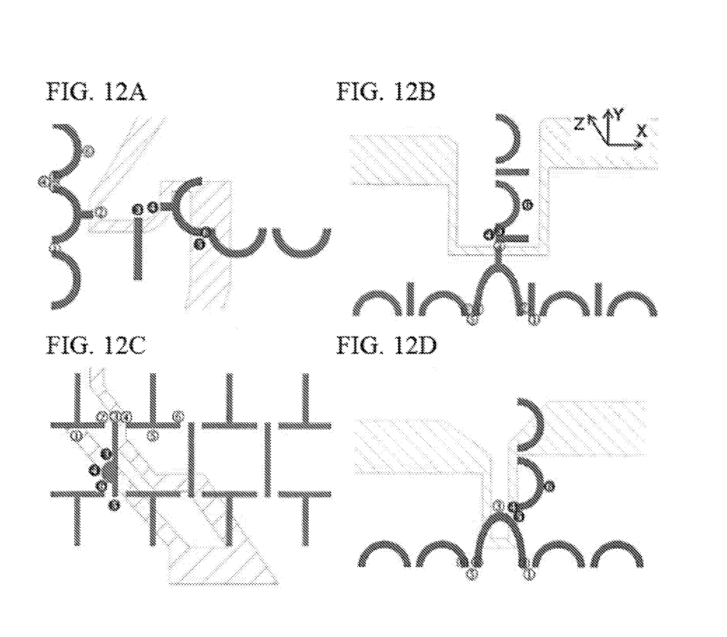

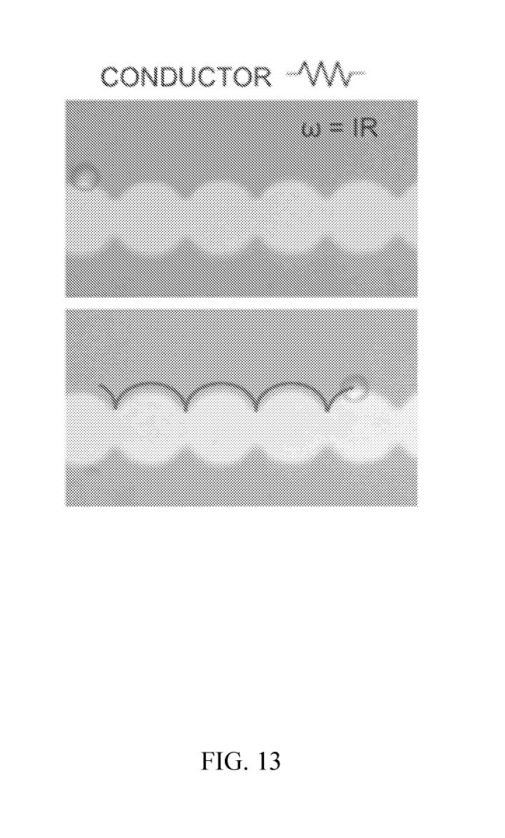

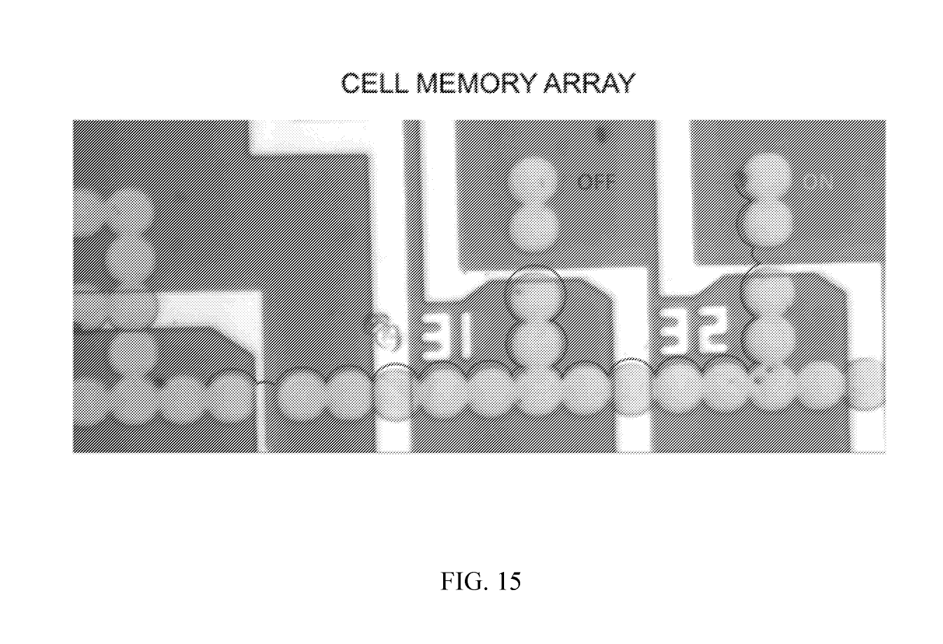

The magnetic tracks of the disclosed methods and devices emulate the functionality of conductors, capacitors, diodes, and, in some cases as discussed below where the magnetic track patterns are aligned with electrically-conductive structures that provide a gating functionality, the transistors of electronic circuits. As illustrated in FIG. 13, the magnetic tracks constitute magnetophoretic “conductors”, where magnetically-susceptible objects are transported with a mean velocity that is linear related to the frequency with which the external magnetic field is modulated. The magnetophoretic “diode” track designs illustrated in FIGS. 5A-H are capable of inducing unidirectional magnetic particle transport, i.e., they function in a similar fashion to electrical diodes which permit one-way current flow. A small gap between two adjacent magnetic structures may be used to create storage sites (“parking spots”) for single magnetic particles, similarly to the storage of charge in an electrical capacitor. Single magnetic particles, e.g., magnetically-labeled single cells, can thus be semi-permanently stored in localized magnetophoretic “capacitors” (see, for example, FIG. 9). FIG. 10 and FIGS. 11A-B show images of magnetophoretic arrays that comprise a plurality of magnetic tracks, electrically-conducting structures that function as switches as will be described below, and magnetic disk storage sites. In FIG. 15 (right-hand side), a single magnetically-labeled cell is stored in the “32” “capacitor” in a small array of magnetophoretic circuit elements. The dark grey lines indicate the paths followed by magnetically-labeled objects when the “transistor” gate current is turned off (capacitor “31”) or on (capacitor “32”).

Magnetophoretic “Transistors” and Integrated Magnetophoretic Circuits:

In order to develop scalable hardware for organizing large numbers of magnetic particles such as magnetically-labeled single cells, it is necessary to build integrated systems comprising both passive and active magnetophoretic circuit elements that mimic the integrated elements of electronic circuits. For example, passive circuit elements (e.g., “conductors”, “diodes”, and “capacitors”) are created using magnetic patterned thin film structures as described above, whereas active circuit elements (e.g., “transistors”) may be created using electrically-conductive structures, e.g., thin metallic wires, which can switch the trajectories of magnetic particles by modulating the local magnetic field. The embedded magnetic pattern and electrically-conductive wire patterns are registered with respect to one another and arranged into circuit architectures that resemble a computer memory. The magnetic pattern is disposed to control the trajectory of magnetized particles in a manner similar to the electrical conductors of integrated circuits, whereby the rotation frequency of the external field is linearly proportional to the magnetic particle currents to produce an integrated circuit element for controlling particle transport, which is consistent with Ohm's law for electrical currents. The magnetic pattern also has elements, which are disposed to trap and retain the magnetized particles, e.g. magnetically-labeled cells, in storage sites, in a manner similar to capacitive memory elements of computer circuits. The electrical wire pattern is disposed to switch magnetized objects between two stable locations, and therefore direct the future path of the magnetized particles in a manner similar to the transistors of integrated circuits. These circuit-like magnetophoretic circuit components may be combined into hierarchical architectures that enable magnetized particles such as magnetically-labeled cells to be placed into arbitrary storage sites within large arrays, in a manner which is consistent with the way digital information is imported into, stored, and exported from computer memory arrays.

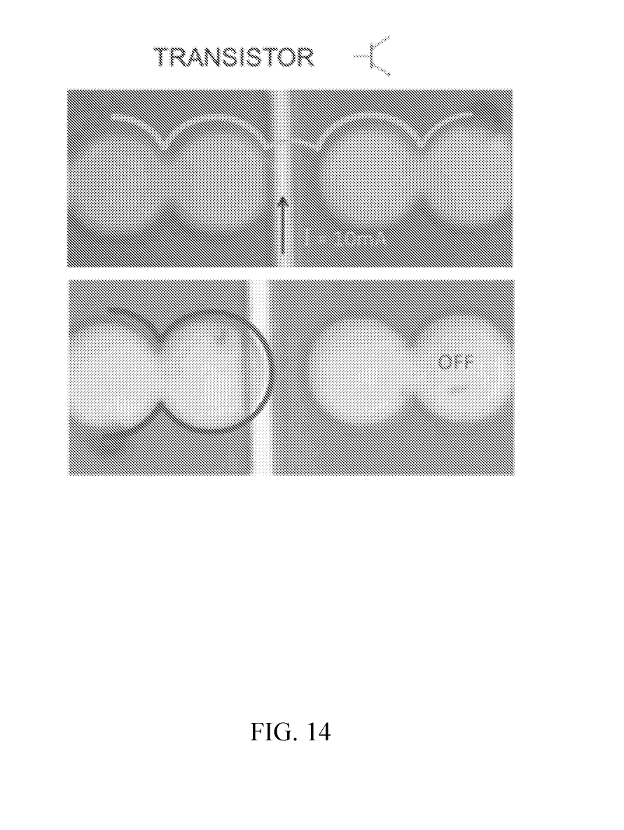

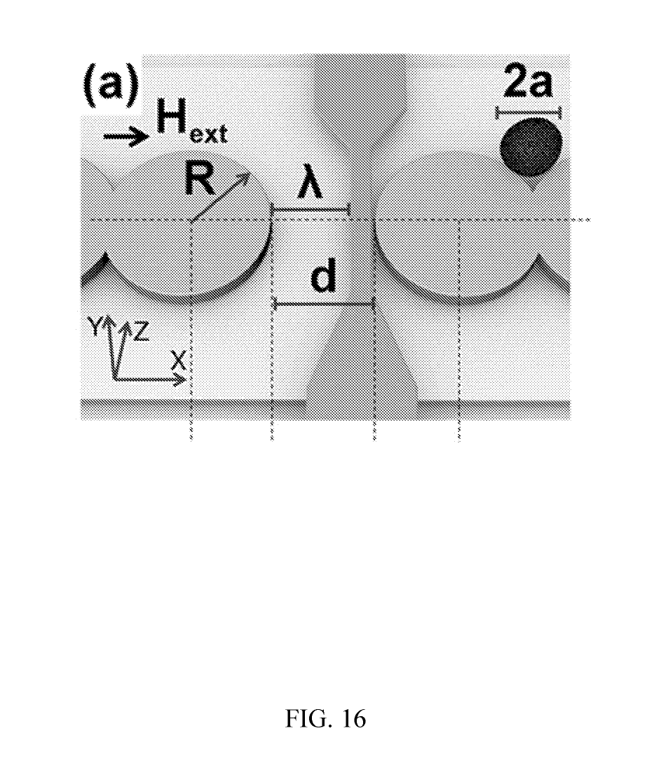

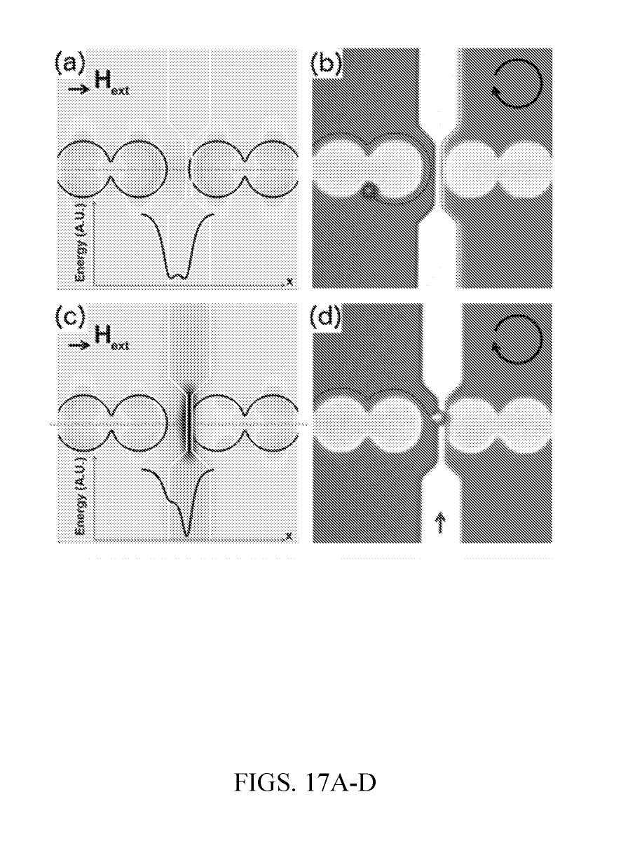

Magnetically-susceptible objects, e.g., cells or other magnetic bioparticles, may be placed into and retrieved from specific “capacitors” within an array using active circuits based on 3-terminal “transistor” devices (FIG. 14, FIG. 16). The operation of these “transistors” is illustrated in FIGS. 17A-D. This circuit architecture has strong analogies with conventional MOSFET transistors, in which a semiconducting gap between two magnetic disks can be transformed from an insulating to a conducting state by the application of a gate current. In the insulating state, a double well energy barrier prevents spontaneous transfer of magnetic particles across the gap, thus having analogies with the Fermi level of semiconductor devices. When current is applied to the gate electrode (i.e. the electrically-conductive nanowire structure), the locally perturbed magnetic field overcomes the field of the nearby magnetic track structure and switches the device into a conducting state.

FIGS. 12A-D provide non-limiting examples of the combination of magnetic track patterns and electrically-conductive switching patterns which allow magnetic particles to be transferred between different magnetic tracks. The electrical current lines are shaded with diagonal lines. The white numbered circles depict the motion of the magnetic particle when there is no applied electrical current, while the black numbered circles depict the motion in the presence of an applied electrical current. It is understood that the electrical current is supplied at an appropriate time and with sufficient current strength, so as to provide a competing magnetic field to transfer the magnetic particle between different tracks. In all of these examples, the switch is turned on to move the magnetic particles between the positions designed as (2) and (3), at the appropriate time synchronized with respect to a rotating magnetic field. In these examples, the magnetic field is rotating in the counter-clockwise orientation. The magnetic particle transfer happens when the in-plane magnetic field direction is switched from the positive x-direction (2) to the positive y-direction (3).

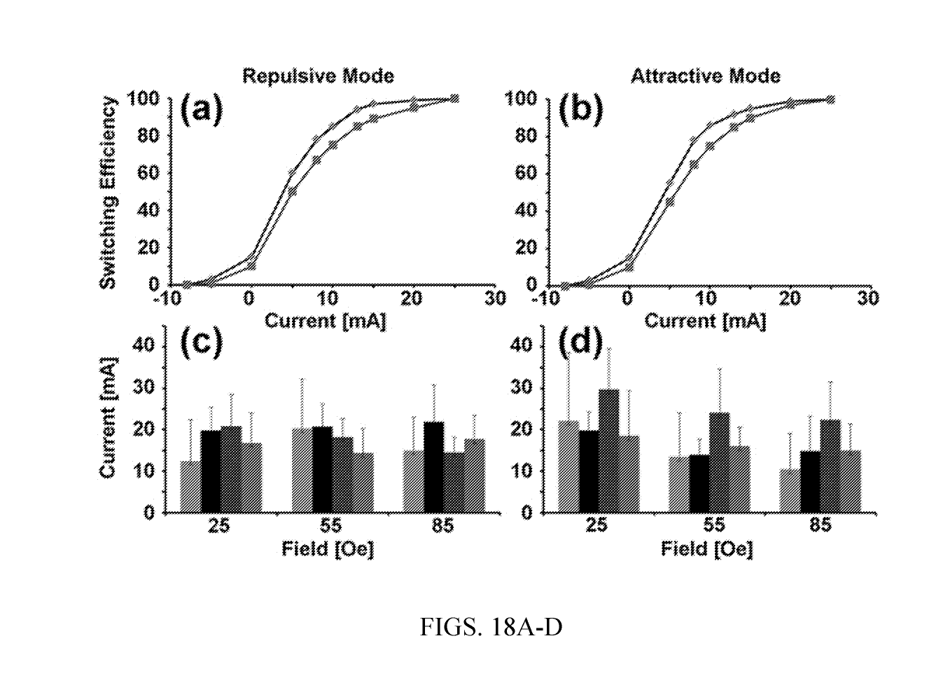

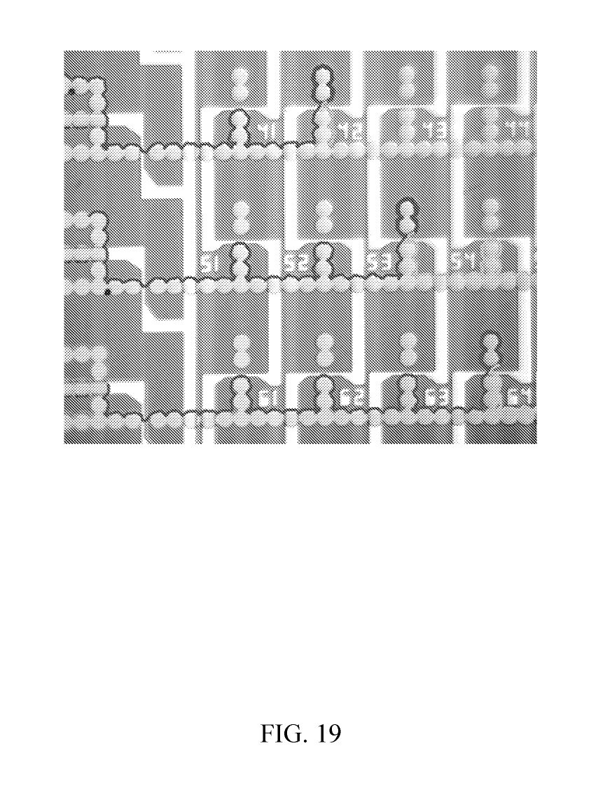

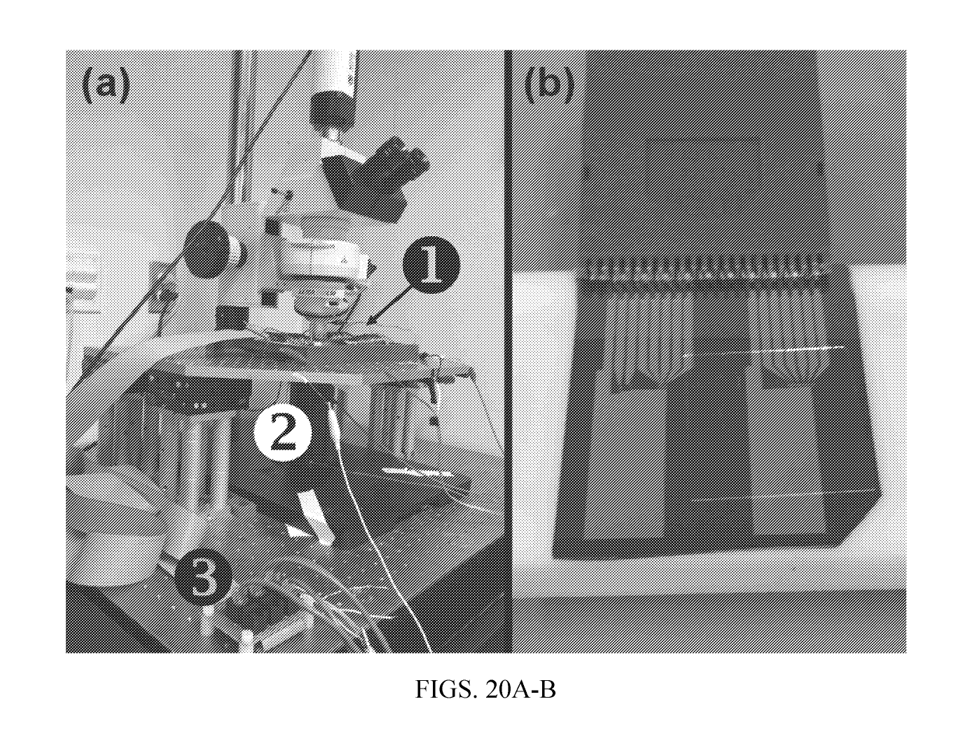

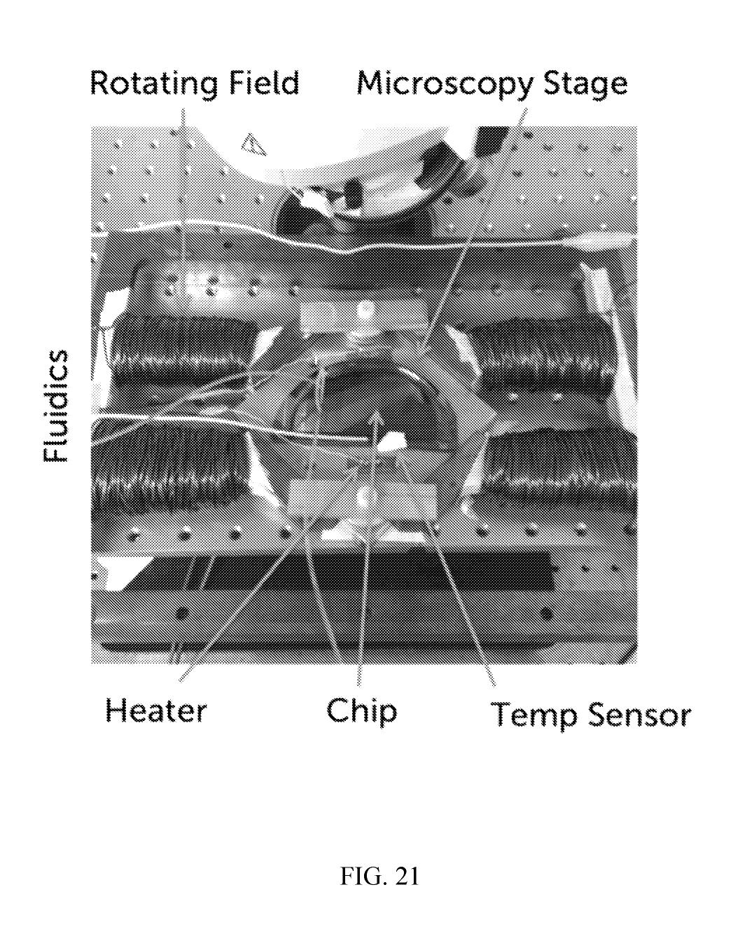

The switching thresholds that define transistor performance have recently been quantified for both single magnetic beads and magnetically-labeled CD4+ T cells (FIGS. 18A-D) [Abedini-Nassab R, et al. (2015), “Characterizing the Switching Thresholds of Magnetophoretic Transistors. Adv Mater, 27, 6176-6180]. Transistor switches are used to achieve a variety of functions in magnetophoretic device arrays, such as cell or bead sorting, isolation, and retrieval. It is also possible to develop multiplexers capable of organizing arrays of single beads and cells (FIG. 19). The multiplexer systems are based on the crossbar memory architecture, which allows N×N array elements to be controlled with only 2×N control wires. It will be understood by those of skill in the art that a three-wire memory architecture could be used to control an N×N×N number of array elements with 3×N control wires, and that even higher degrees of multiplexing are also possible.

Fabrication of Electrically Conducting Structures:

Patterns of electrically-conducting structures (e.g. “wires” or “nanowires”) for use in creating magnetophoretic “transistors” may be fabricated using any of a variety of materials and techniques known to those of skill in the art. Examples of suitable materials for fabricating the electrically-conducting structures include, but are not limited to, gold (Au), platinum (Pt), silver (Ag), aluminum (Al), copper (Cu), zinc (Zn), indium tin oxide (ITO), graphene, carbon nanotubes, organic conductors, a metal with conductivity larger than 100,000 S/m, or any combination thereof. Examples of suitable fabrication techniques (typically dependent on the choice of material, and vice versa) include, but are not limited to, photolithographic patterning followed by thin film deposition (e.g. by chemical vapor deposition, plasma-enhanced chemical vapor deposition, sputter coating, etc.) and lift off of a sacrificial material (e.g. a photoresist); photolithographic patterning and etching of the substrate (e.g. using wet chemical etching, plasma etching, or deep reactive ion etching (DRIE))), followed by thin film deposition and polishing; micro-molding, micro-embossing, or laser micromachining, followed by thin film deposition and polishing; 3D printing or other direct write fabrication processes using curable materials; and similar techniques. In some embodiments, the electrically conducting structure comprises a p-n junction patterned in silicon or another semiconducting material. In general, the electrically-conducting structures are configured to form one or more junctions used to sort magnetically-susceptible objects between two pre-defined magnetic paths according to a relationship between the geometry of the magnetic pattern and the pattern of electrically conducting material

In general, the width of the electrically-conductive pattern elements may range from about 100 nm to about 10 μm. In some embodiments, the electrically-conductive pattern elements may have widths of at least at least 100 nm, at least 200 nm, at least 300 nm, at least 400 nm, at least 500 nm, at least 600 nm, at least 700 nm, at least 800 nm, at least 900 nm, at least 1 μm, at least 2 μm, at least 5 μm, or at least 10 μm. In some embodiments, the electrically-conductive pattern elements may have widths of at most 10 μm, at most 5 μm, at most 1 μm, at most 900 nm, at most 800 nm, at most 700 nm, at most 600 nm, at most 500 nm, at most 400 nm, at most 300 nm, at most 200 nm, or at most 100 nm. Any of the lower and upper values described in this paragraph may be combined to form a range included within the disclosure, for example, the width of the electrically-conductive pattern elements may range from about 300 nm to about 800 nm. Those of skill in the art will recognize that the electrically-conductive pattern elements may have any width within this range, for example, about 3 μm, which is an accessible size that can be fabricated by photolithography in a typical mask aligner.

In general the thickness of the electrically-conductive pattern may range from about 10 nm to about 2 μm. In some embodiments, the electrically-conductive pattern may have a thickness of at least 10 nm, at least 25 nm, at least 50 nm, at least 75 nm, at least 100 nm, at least 125 nm, at least 150 nm, at least 175 nm, at least 200 nm, at least 300 nm, at least 400 nm, at least 500 nm, at least 1 μm, or at least am. In some embodiments, the electrically-conductive pattern may have a thickness of at most 2 μm, at most 1 μm, at most 500 nm, at most 400 nm, at most 300 nm, at most 200 nm, at most 175 nm, at most 150 nm, at most 100 nm, at most 75 nm, at most 50 nm, at most 25 nm, or at most 10 nm. Any of the lower and upper values described in this paragraph may be combined to form a range included within the disclosure, for example, the thickness of the magnetic tracks may range from about 50 nm to about 300 nm. Those of skill in the art will recognize that the magnetic tracks may have any thickness within this range, for example, about 210 nm, which is an accessible thickness that can be fabricated by the photolithographic liftoff process. Electroplating techniques can be used to fabricate thicker wires, which has the advantage of producing higher currents by means of achieving lower electrical resistances.

Time-Varying Magnetic Fields—Sources & Properties:

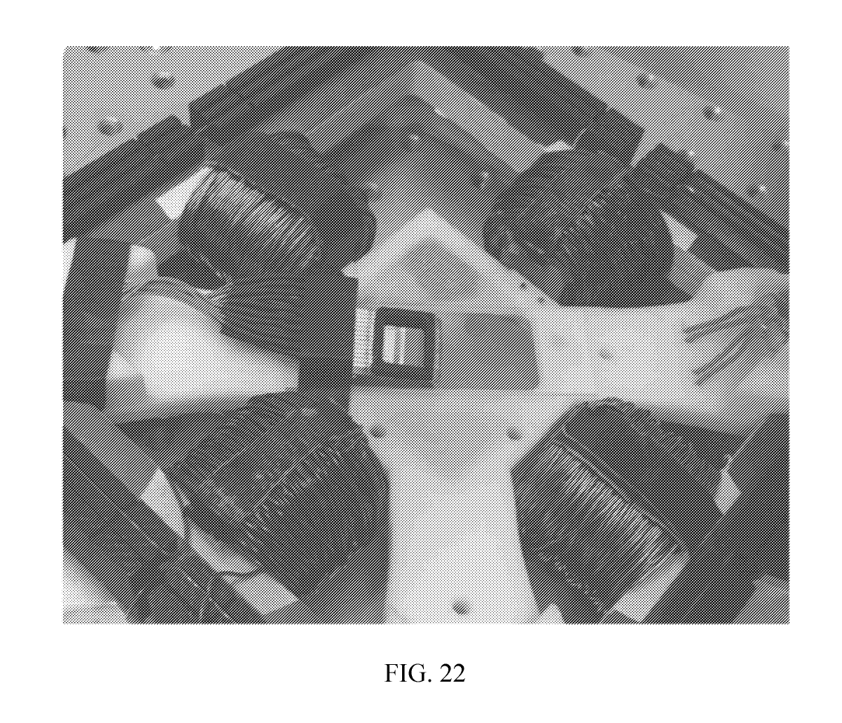

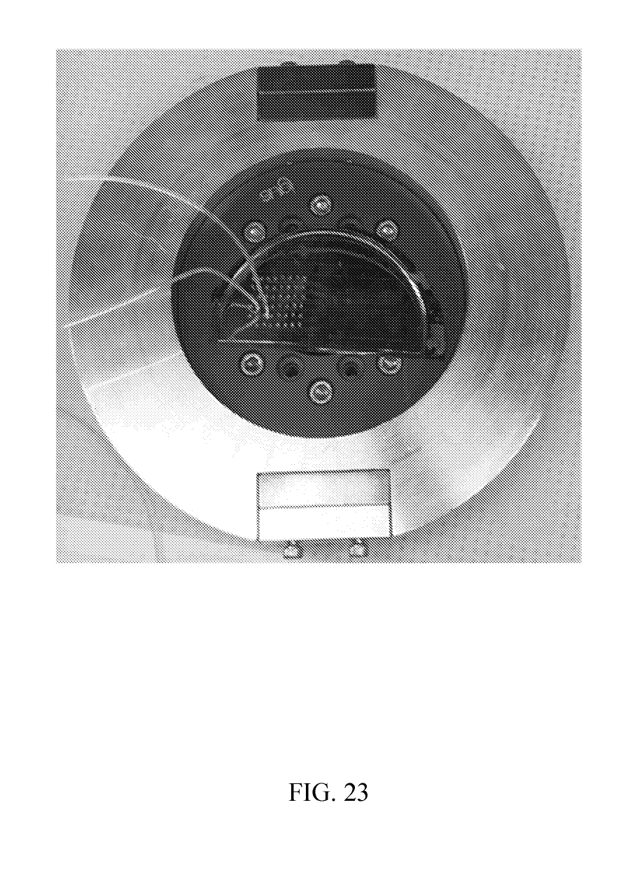

The local magnetic field at any point within an array of magnetophoretic structures is the result of the vector addition of a long-range, time-varying external magnetic field whose primary purpose is to magnetize the magnetically-susceptible objects and magnetic tracks used for transport, and a local, short-range magnetic field arising from the magnetic track and/or electrically-conductive structures of the device which produce the local field gradients and field variations which establish local potential energy minima. The vector combination of the long-range, time-varying external magnetic field and the local, short-range magnetic field gives rise to local, strongly inhomogeneous, time-varying magnetic fields that guide magnetically-susceptible objects (e.g. magnetic nanoparticles or magnetic beads) along the pattern of magnetic tracks. Any of a variety of sources may be used to provide the long-range, time-varying external magnetic field including, but not limited to, one or more appropriately positioned and/or moveable permanent magnets (e.g. rotating permanent magnets), electromagnets, or any combination thereof. For example, external in-plane (two-dimensional) rotating magnetic fields may be produced by passing current through pairs of solenoid coils with ferrite cores controlled by, e.g., LabVIEW software (National Instruments) [Lim, et al. (2014), “Magnetophoretic Circuits for Digital Control of Single Particles and Cells”, Nat. Commun. 5:3846; U.S. Published Patent Application No. 2015/0064764 A1]. The sense of field rotation may be adjusted by applying a phase difference, 6=+90⁰ between the orthogonal coils. Three-dimensional magnetic fields, i.e. having a vertical component that is normal to the plane of the substrate, may be produced using, e.g. an additional pair of orthogonal solenoid coils (FIG. 22). Tri-axial fields, including both in plane and out of plane fields, may be operated synchronously or asynchronously in a manner such that the motion of the magnetically susceptible objects can be moved along desired paths. FIG. 23 depicts a custom permanent magnet rotor which is built by inserting strong NdFeB magnets into machined cavities, which is then mounted onto a rotary bearing.

As stated above, for the magnetic track designs of the present disclosure it is important that the time-varying magnetic field includes a vertical component, i.e., a component that is normal to the plane of the substrate surface. The magnetic track geometries illustrated in FIGS. 1-4 are substantially different from the previously disclosed magnetic patterns used to achieve controlled transport in a purely in-plane rotating magnetic field [Lim, et al. (2014), “Magnetophoretic Circuits for Digital Control of Single Particles and Cells.” Nat. Commun. 5:3846; U.S. Published Patent Application No. 2015/0064764 A1]. The vertical field provides unique advantages in the ability to induce magnetic repulsion between nearby magnetically-susceptible objects, and also the ability to break the axial symmetry of the in-plane rotating field and specify a single, unique position for the magnetic objects for each phase of the time-varying field. This leads to better control and repeatability of particle transport.

The cone angle for the time-varying magnetic field is defined by the inverse tangent of the vertical to horizontal magnetic field components. A cone angle of 90 degrees corresponds to a purely in-plane rotating magnetic field, whereas a cone angle of 0 degrees corresponds to a static vertical magnetic field. In some embodiments, the cone angle may range from about 20 degrees to about 70 degrees. In some embodiments the cone angle may be at least 20 degrees, at least 30 degrees, at least 40 degrees, at least 50 degrees, at least 60 degrees, or at least 70 degrees. In some embodiments, the cone angle may be at most 70 degrees, at most 60 degrees, at most 50 degrees, at most 40 degrees, at most 30 degrees, or at most 20 degrees. In some embodiments, the cone angle may range from about 30 degrees to about 60 degrees. Any of the lower and upper values described in this paragraph may be combined to form a range included within the disclosure, for example, the cone angle may range from about 40 degrees to about 60 degrees. Those of skill in the art will recognize that the cone angle may have any value within this range, e.g., about 58 degrees.

In some embodiments, the time-varying magnetic field can be a horizontally rotating magnetic field, with a fixed vertical field; a field in which all three axial components oscillate at the same frequency or different frequencies; a field which oscillates along only one axis in the horizontal direction, and has either static or time-varying external field components in the vertical direction; or a pulsed magnetic field having a square wave, a rectangular wave, or any periodically or non-periodically varying magnetic field profile.

In some embodiments, the frequency with which the time-varying external magnetic field is modulated may range from about 0.02 Hz to about 10 Hz. In some embodiments, the frequency may be at least 0.02 Hz, at least 0.05 Hz, at least 0.1 Hz, at least 0.2 Hz, at least 0.3 Hz, at least 0.4 Hz, at least 0.5 Hz, at least 1 Hz, at least 2 Hz, at least 3 Hz, at least 4 Hz, at least 5 Hz, at least 6 Hz, at least 7 Hz, at least 8 Hz, at least 9 Hz, or at least 10 Hz. In some embodiments, the frequency may be at most 10 Hz, at most 9 Hz, at most 8 Hz, at most 7 Hz, at most 6 Hz, at most 5 Hz, at most 4 Hz, at most 3 Hz, at most 2 Hz, at most 1 Hz, at most 0.5 Hz, at most 0.4 Hz, at most 0.3 Hz, at most 0.2 Hz, at most 0.1 Hz, at most 0.05 Hz, or at most 0.02 Hz. Any of the lower and upper values described in this paragraph may be combined to form a range included within the disclosure, for example, the frequency may range from about 0.1 Hz to about 5 Hz. Those of skill in the art will recognize that the frequency may have any value within this range, e.g., about 5.5 Hz.

In some embodiments, the strength of the externally applied magnetic field may range from about 5 Gauss to about 10,000 Gauss. In some embodiments, the magnetic field strength may be at least 5 Gauss, at least 10 Gauss, at least 25 Gauss, at least 50 Gauss, at least 100 Gauss, at least 200 Gauss, at least 300 Gauss, at least 400 Gauss, at least 500 Gauss, at least 600 Gauss, at least 700 Gauss, at least 800 Gauss, at least 900 Gauss, at least 1,000 Gauss, at least 2,000 Gauss, at least 3,000 Gauss, at least 4,000 Gauss, at least 5,000 Gauss, at least 6,000 Gauss, at least 7,000 Gauss, at least 8,000 Gauss, at least 9,000 Gauss, or at least 10,000 Gauss. In some embodiments, the magnetic field strength may be at most 10,000 Gauss, at most 9,000 Gauss, at most 8,000 Gauss, at most 7,000 Gauss, at most 6,000 Gauss, at most 5,000 Gauss, at most 4,000 Gauss, at most 3,000 Gauss, at most 2,000 Gauss, at most 1,000 Gauss, at most 900 Gauss, at most 800 Gauss, at most 700 Gauss, at most 600 Gauss, at most 500 Gauss, at most 400 Gauss, at most 300 Gauss, at most 200 Gauss, at most 100 Gauss, at most 50 Gauss, at most 25 Gauss, at most 10 Gauss or at most 5 Gauss. Any of the lower and upper values described in this paragraph may be combined to form a range included within the disclosure, for example, the magnetic field strength may range from about 100 Gauss to about 2,000 Gauss. Those of skill in the art will recognize that the magnetic field strength may have any value within this range, e.g., about 560 Gauss.

In some embodiments, the deposited or embedded magnetic track material is permanently magnetized and its magnetization is unaffected by the long-range, time-varying magnetic field source. In some embodiments, the deposited or embedded magnetic track material can be re-magnetized by the long-range, time-varying magnetic field source.

Microfluidic Structures & Devices:

In some embodiments, the disclosed magnetophoretic sorting devices may further comprise integrated microfluidic structures to enable magnetically susceptible objects, e.g., cells, to be compartmentalized, incubated, retrieved, and/or maintained for extended periods of time, e.g., while under continuous microscopic observation. Examples of passive microfluidic structures suitable for use in the disclosed devices include, but are not limited to, one or more inlet and outlet ports, fluid channels, fluid chambers, wells or microwells, walls, grooves, indentations, pillars, protrusions, vents, and similar structures, which may be used to control fluid flow and guide or compartmentalize magnetically-susceptible objects, e.g. cells or other bioparticles, within a magnetophoretic array device (e.g., a device comprising an array of magnetophoretic circuit components and, optionally, a corresponding array of microfluidic structures). In some embodiments, the microfluidic structures may further provide active control of fluid flow into and out of an array device, or the compartmentalization of single cells and/or beads at specific sites within the array, e.g., within an array of microchambers, using active microfluidic components such as microvalves and/or micropumps.

Fabrication of Microfluidic Structures & Devices:

In some embodiments, microfluidic structures may be fabricated as a separate part, and subsequently either mechanically clamped against or permanently bonded to the magnetophoretic device substrate. Examples of suitable fabrication techniques include conventional machining, CNC machining, injection molding, 3D printing, alignment and lamination of one or more layers of laser- or die-cut polymer film, or any of a number of microfabrication techniques such as photolithography and wet chemical etching, dry etching, deep reactive ion etching, or laser micromachining. In some embodiments, the microfluidic structures may be 3D printed from an elastomeric material.

Microfluidic structures may be fabricated using any of a variety of materials known to those of skill in the art. In general, the choice of material used will depend on the choice of fabrication technique, and vice versa. Examples of suitable materials include, but are not limited to, silicon, fused-silica, glass, any of a variety of polymers, e.g. polydimethylsiloxane (PDMS; elastomer), polymethylmethacrylate (PMMA), polycarbonate (PC), polystyrene (PS), polypropylene (PP), polyethylene (PE), high density polyethylene (HDPE), polyimide, cyclic olefin polymers (COP), cyclic olefin copolymers (COC), polyethylene terephthalate (PET), epoxy resins, a non-stick material such as teflon (PTFE), a variety of photoresists such as SU8 or any other thick film photoresist, or a combination of these materials.

In some embodiments, some portion of the microfluidic structure may be optically transparent to facilitate observation and monitoring of particulate objects, e.g. magnetically-labeled cells, entrapped within the device. In some embodiments, the different layers in a magnetophoretic device comprising multiple layers may be fabricated from different materials, e.g. the microfluidic structure (e.g. a fluid channel layer) may be fabricated from an elastomeric material while the device substrate and a cover plate (top) may be fabricated from glass or another suitable material.

In some embodiments, the magnetophoretic device may comprise a three layer structure that includes the magnetophoretic device array substrate (comprising the magnetic tracks and, optionally, an electrically-conductive pattern), a microfluidic structure layer (e.g. a fluid channel and fluid chamber layer), and a cover plate, whereby the volume of the microfluidic chambers is determined by the cross-sectional area of the microchamber and the thickness of the microfluidic structure layer. In some embodiments, the magnetophoretic device (e.g., the substrate, microfluidic structure(s), and a cover plate) may comprise two layers, three layers, four layers, five layers, or more than five layers.

As indicated above, in some embodiments the thickness of a microfluidic structure layer will determine the depth of the fluid channels and microchamber in the device, and will thus influence the total volume of the microchambers. In general, the thickness of the microfluidic structure layer (or depth of microfluidic channels and chambers) will be between about 1 μm and about 1 mm. In other embodiments, the thickness of the microfluidic structure layer (or depth of the microfluidic channels and chambers) may be at least 1 μm, at least 5 μm, at least 10 μm, at least 20 μm, at least 30 μm, at least 40 μm, at least 50 μm, at least 100 μm, at least 200 μm, at least 300 μm, at least 400 μm, at least 500 μm, at least 600 μm, at least 700 μm, at least 800 μm, at least 900 μm, or at least 1 mm. In other embodiments, the thickness of the microfluidic (or depth of the microfluidic channels and chambers) structure layer may be at most 1 mm, at most 900 μm, at most 800 μm, at most 700 μm, at most 600 μm, at most 500 μm, at most 400 μm, at most 300 μm, at most 200 μm, at most 100 μm, at most 50 μm, at most 40 μm, at most 30 μm, at most 20 μm, at most 10 μm, at most 5 μm, or at most 1 μm. Any of the lower and upper values described in this paragraph may be combined to form a range included within the disclosure, for example, the thickness of the microfluidic structure layer (or depth of the microfluidic channels and chambers) may range from about 50 μm to about 100 μm. Those of skill in the art will recognize that thickness of the microfluidic structure layer (or depth of the microfluidic channels and chambers) may have any value within this range, for example, about 95 μm.

In general, the dimensions of fluid channels and microfluidic chambers in magnetophoretic device designs will be optimized to (i) provide uniform and efficient delivery of magnetically-susceptible objects, e.g. magnetically-labeled cells and other bioparticles, to the plurality of microchambers comprising an array-type device, and (ii) to minimize sample and reagent consumption. In general, the width of fluid channels or microfluidic chambers may be between about 10 um and about 2 mm. In some embodiments, the width of fluid channels or microfluidic chambers may be at least 10 μm, at least 25 μm, at least 50 m at least 100 μm, at least 200 μm, at least 300 μm, at least 400 μm, at least 500 μm, at least 750 μm, at least 1 mm, at least 1.5 mm, or at least 2 mm. In other embodiments, the width of fluid channels or microfluidic chambers may at most 2 mm, at most 1.5 mm, at most 1 mm, at most 750 μm, at most 500 μm, at most 400 μm, at most 300 μm, at most 200 μm, at most 100 μm, at most 50 μm, at most 25 μm, or at most 10 μm. Any of the lower and upper values described in this paragraph may be combined to form a range included within the disclosure, for example, the width of the fluid channels may range from about 100 m to about 1 mm. Those of skill in the art will recognize that the width of the fluid channel may have any value within this range, for example, about 80 μkm.

In general, the volumes of the microfluidic chambers used in the magnetophoretic methods and devices of the present disclosure may range from about 1,000 μm³ to about 1 mm³. In some embodiments, the microchamber volume may be at least 1,000 μm³, at least 10,000 μm³, at least 100,000 μm³, at least 1,000,000 μm³, at least 0.2 mm³, at least 0.5 mm³, or at least 1 mm³. In some embodiments, the microchamber volume is at most 1 mm³, at most 0.5 mm³, at most 0.2 mm³, at most 1,000,000 μm³, at most 100,000 μm³, at most 10,000 μm³, or at most 1,000 μm³. Any of the lower and upper values described in this paragraph may be combined to form a range included within the disclosure, for example, the microchamber volume may range from about 100,000 μm³ to about 0.2 mm³. Those of skill in the art will recognize that the microchamber volume may have any value within this range, for example, about 8,000 μm³.

In magnetophoretic array devices, e.g. devices comprising an array of magnetophoretic circuit elements and a corresponding microfluidic structure comprising an array of fluid channels and microchambers (fluid compartments) that are in register with the magnetophoretic circuit elements, the number of magnetophoretic circuit elements or microchambers in the array may range from about 1 to about 10⁶, or more. In some embodiments, the number of magnetophoretic circuit elements or microchambers in the array may be at least 1, at least 10, at least 100, at least 1,000, at least 10⁴, at least 10⁵, or at least 10⁶. In some embodiments, the number of magnetophoretic circuit elements or microchambers in the array may be at most 10⁶, at most 10⁵, at most 10⁴, at most 1,000, at most 100, or at most 1. Any of the lower and upper values described in this paragraph may be combined to form a range included within the disclosure, for example, the number of magnetophoretic circuit elements or microchambers in the array may range from about 100 to about 10,000. Those of skill in the art will recognize that the number of magnetophoretic circuit elements or microchambers in the array may have any value within this range, for example, about 1,200.

In some embodiments, the pitch (or spacing) between magnetophoretic circuit elements and the corresponding microchambers in magnetophoretic arrays may range from about 10 m to about 1,000 μm, or more. In some embodiments, the pitch between magnetophoretic circuit elements or microchambers may be at least 10 μm, at least 25 μm, at least 50 μm, at least 75 μm, at least 100 μm, at least 200 μm, at least 300 μm, at least 400 μm, at least 500 μm, at least 600 μm, at least 700 μm, at least 800 μm, at least 900 μm, or at least 1,000 μm. In some embodiments, the pitch between magnetophoretic circuit elements or microchambers may be at most 1,000 μm, at most 900 μm, at most 800 μm, at most 700 μm, at most 600 μm, at most 500 μm, at most 400 μm, at most 300 μm, at most 200 μm, at most 100 μm, at most 75 μm, at most 50 μm, at most 25 μm, or at most 10 μm. Any of the lower and upper values described in this paragraph may be combined to form a range included within the disclosure, for example, the pitch between magnetophoretic circuit elements or microchambers may range from about 75 μm to about 300 μm. Those of skill in the art will recognize that the pitch between magnetophoretic circuit elements or microchambers may have any value within this range, for example, about 110 μm.

If fabricated as a separate part (or set of parts), the microfluidic structure may be assembled and attached to the magnetophoretic device substrate mechanically, e.g. by clamping it against the substrate (with or without the use of a gasket) using an appropriate fixture and fasteners, or it may be assembled and bonded directly to the magnetophoretic device substrate using any of a variety of techniques (depending on the choice of materials used) known to those of skill in the art, for example, through the use of anodic bonding, thermal bonding, or any of a variety of adhesives or adhesive films, including epoxy-based, acrylic-based, silicone-based, UV curable, polyurethane-based, or cyanoacrylate-based adhesives.

Magnetophoretic Devices Comprising Pumps or Valves:

In some embodiments, the magnetophoretic devices of the present disclosure may further comprise active fluidic components such as pumps (e.g. micropumps) or valves (e.g. microvalves) to provide additional control of fluid flow, e.g. to enable addressable control of fluid deliver to specific fluid compartments, and to enable isolation of magnetic particles, e.g. magnetically-labeled cells and other bioparticles, within specific fluid compartments. In some embodiments, one or more micropumps or microvalves may be fabricated within or directly integrated with the magnetophoretic device itself (e.g. in embodiments where the magnetophoretic device comprises pre-packaged assay buffers, magnetic-particles, reagents, or other fluids used in the operation of the device). In some embodiments, one or more conventional pumps or valves may reside externally to the device, e.g. as a component included in an instrument module with which the magnetophoretic device interfaces, and be connected to the device via appropriate tubing. Examples of suitable micropumps (or fluid actuation mechanisms) for use in the devices of the present disclosure include, but are not limited to, electromechanically- or pneumatically-actuated miniature syringe or plunger mechanisms, membrane diaphragm pumps actuated pneumatically or by an external piston, pneumatically-actuated reagent and buffer pouches or bladders, or electro-osmotic pumps. Examples of suitable microvalves for use in the devices of the present disclosure include, but are not limited to, pinch valves constructed using a deformable membrane or tube and pneumatic, magnetic, electromagnetic, or electromechanical (solenoid) actuation, one-way valves constructed using deformable membrane flaps, miniature check valves and gate valves; one-shot “valves” fabricated using wax or polymer plugs that can be melted or dissolved, or polymer membranes that can be punctured, and the like. In some embodiments of the disclosed magnetophoretic devices, each microchamber in a plurality of microchambers within the device will be individually addressable and isolatable by means of one or more microvalves positioned at the inlet(s) and/or outlet(s) of each microchamber, thereby allowing the individual microchambers to be reversibly sealed in an addressable manner. In some embodiments, one or more subsets of a plurality of the microchambers will be addressable and isolatable as groups by means of one or more microvalves positioned at common inlet(s) and/or outlet(s) for the one or more subsets. In some embodiments, the inlets and outlets of the device, or fluid channels therein, may include integrated check valves for controlling the directionality of fluid flow.

Active and Passive Non-Fouling Strategies:

In some embodiments, the magnetophoretic devices may incorporate additional patterned sets of electrodes, and the system may include a negative dielectrophoresis (nDEP) module for providing a non-uniform electric field, which is applied so as to repel labeled cells and other bioparticles from the substrate surface. This would provide an active non-fouling strategy for preventing non-specific adhesion of cells or other bioparticles to the array, which would complement passive non-fouling strategies based on functionalizing the magnetic track or substrate surfaces with, for example, surface-initiated poly[oligo(ethylene-glycol) methyl ether methacrylate] (POEGMA) polymer brush coatings [Ahmad S A, et al. (2010), “Protein Patterning by UV-Induced Photodegradation of Poly(oligo(ethylene glycol) methacrylate) Brushes”, Langmuir 26: 9937-9942; Hucknall A, et al. (2009), “Versatile Synthesis and Micropatterning of Nonfouling Polymer Brushes on the Wafer Scale”, Biointerphases 4: FA50-FA57].

In some embodiments, the fluid-contacting surfaces of the magnetic track or substrate may be functionalized with hydrophobic coatings (e.g., polytetrafluoroethylene (Teflon), PDMS, fluorosilanes, fluoropolymers, silicone-based spray-on coatings, super-hydrophobic materials) or hydrophyllic coatings (e.g., polyethylene glycol and its derivatives, POEGMA, sulfonates), zwitterionic polymers containing carboxybetaine or sulfobetaine, or another material that resists adhesion of biomaterials. In some embodiments, the substrate surface (or portions thereof) may be functionalized with more than one coating layer in any combination of anti-fouling materials. In other embodiments, the non-fouling layer may be locally functionalized to capture specific molecules present in the fluid to serve as a chemical sensing element. In some embodiments, a non-fouling layer may be disposed between the magnetizable tracks and a microfluidic structure.

Microfluidics Controllers:

In some embodiments, the disclosed sorting platforms will comprise a microfluidics controller that provides programmable control of the one or more fluid actuation mechanisms used to drive fluid flow in the magnetophoretic devices. Examples of suitable fluid actuation mechanisms for use in the disclosed methods, devices, and systems include application of positive or negative pressure to fluid reservoirs connected to one or more device inlets or outlets, electrokinetic forces, electrowetting forces, passive capillary action, capillary action facilitated through the use of membranes and/or wicking pads, and the like.

Control of fluid flow through the magnetophoretic devices will typically be performed through the use of one or more pumps (or other fluid actuation mechanisms) and one or more valves which, in some embodiments, will be housed externally to the magnetophoretic devices in a user-controlled instrument module. Examples of suitable pumps include, but are not limited to, syringe pumps, programmable syringe pumps, peristaltic pumps, diaphragm pumps, and the like. In some embodiments, fluid flow through the system may be controlled by means of applying positive pneumatic pressure at one or more inlets of external reagent and buffer containers connected to the magnetophoretic device, or at one or more inlets of the magnetophoretic device itself. In some embodiments, fluid flow through the device may be controlled by means of drawing a vacuum at one or more outlets of a waste reservoir connected to the device, or at the one or more outlets of the device. Examples of suitable valves include, but are not limited to, check valves, electromechanical two-way or three-way valves, pneumatic two-way and three-way valves, and the like.

In some embodiments, fluid flow within the magnetophoretic device may be activated at the same time as magnetic transport is being performed. In some embodiments, fluid flow within the device may be turned off while magnetic transport is being performed. In some embodiments, various combinations of fluid flow and magnetic transport may be performed at different times in the sequence of operational steps which the magnetophoretic device is designed to perform.

Different fluid flow rates may be utilized at different points in the magnetophoretic device operating sequence. For example, in some embodiments of the disclosed methods, devices, and systems, the volumetric flow rate through all or a portion of the magnetophoretic device may vary from about −10 ml/sec to about +10 ml/sec. In some embodiments, the absolute value of the volumetric flow rate may be at least 0.00001 ml/sec, at least 0.0001 ml/sec, at least 0.001 ml/sec, at least 0.01 ml/sec, at least 0.1 ml/sec, at least 1 ml/sec, or at least 10 ml/sec, or more. In some embodiments, the absolute value of the volumetric flow rate may be at most 10 ml/sec, at most 1 ml/sec, at most 0.1 ml/sec, at most 0.01 ml/sec, at most 0.001 ml/sec, at most 0.0001 ml/sec, or at most 0.00001 ml/sec. The volumetric flow rate at a given point in time may have any value within this range, e.g. a forward flow rate of 1.2 ml/sec, a reverse flow rate of −0.07 ml/sec, or a value of 0 ml/sec (i.e. stopped flow).

Temperature Controllers:

In some embodiments, the disclosed magnetophoretic sorting platforms may further comprise a temperature controller for maintaining a user-specified temperature within the magnetophoretic device, e.g., to enable cells to be incubated and maintained for extended periods while under continuous microscopic observation, or for ramping temperature between two or more specified temperatures over two or more specified time intervals. Examples of temperature control components that may be incorporated into the magnetophoretic device or instrument system include, but are not limited to, resistive heating elements (e.g. indium tin oxide resistive heating elements), Peltier heating or cooling devices, heat sinks, thermistors, thermocouples, infrared light sources, and the like, which are regulated using electronic feedback loops. In some embodiments, photolithographic patterning or 3D printing techniques may be used to fabricate compact, integrated device components (FIG. 22).

In some embodiments of the system, the temperature controller may provide for a programmable temperature change at one or more specified, adjustable times prior to performing specific device operational steps. In some embodiments of the system, the temperature controller may provide for programmable changes in temperature over specified time intervals. In some embodiments, the temperature controller may further provide for cycling of temperatures between two or more set temperatures with specified frequencies and ramp rates so that thermal cycling for amplification reactions may be performed.

Gas & pH Controllers:

In some embodiments, the disclosed magnetophoretic sorting platforms may comprise gas and pH controllers and related components (e.g. sensors) for maintaining a user-specified percentage of gas, e.g. CO₂, or user-specified pH in buffers, growth media, or other fluids being delivered to the magnetophoretic device. Examples of suitable sensors include non-dispersive infrared (NDIR) CO₂ sensors (used in conjunction with an attenuated total internal reflection (ATR) optics for dissolved CO₂ sensing), metal insulator semiconductor field effect transistor (MISFET)-type sensors for dissolved CO₂ sensing (e.g. having Pt—NiO thin films as the active CO₂ sensing material deposited on the gate electrode), CO₂-sensitive electrodes (e.g., Mettler Toledo's InPro 5000i dissolved CO₂ sensor series), pH-sensitive electrodes, pads immersed in the fluid, which produce a color change corresponding to the amount of dissolved CO₂ or the pH in the fluid such as those sold under the tradename Presens® sensor spots [PreSens Precision Sensing, GmbH, Regensburg, Germany], and the like. For control of CO₂ and pH, suitable sensors are used in a feedback loop to control acid/base titrations and CO₂ injection. In some embodiments, CO₂ or other gas concentrations, or pH, may be monitored directly in the fluid contained within the device. In some embodiments, CO₂ or other gas concentrations, may be monitored in a gas or atmosphere which is in equilibrium with the fluid within the device.

Optical Imaging Modules:

In some embodiments, the disclosed magnetophoretic sorting platforms may further comprise an optical imaging module configured to capture and process images of, for example, all or a portion of the plurality of microchambers in a magnetophoretic array device, wherein the optical imaging module further comprises an illumination subsystem, an imaging subsystem, and optionally a processor. In some embodiments, the optical imaging module is configured to perform bright-field, dark-field, fluorescence, luminescence, chemiluminescence, phosphorescence, phase-contrast, quantitative phase contrast imaging, confocal microscopy imaging, super resolution microscopy imaging, or time resolved fluorescence microscope imaging. In some embodiments, dual wavelength excitation and emission (or multi-wavelength excitation or emission) fluorescence imaging may be performed. In some embodiments, two-photon fluorescence imaging may be performed. In some embodiments, coherent Raman imaging may be performed. In some embodiments, the imaging module may be configured to perform other spectroscopic measurements. In some embodiments, the optical imaging module is configured to perform automated image processing.

In some embodiments, the imaging module provides for optical monitoring of cells or beads within microchambers to identify specified subsets of cells or beads, e.g. dead cells, live cells, pairs of cells, cells exhibiting specific cell surface markers, internal cellular proteins labeled with fluorescent markers, fluorescent chemical sensing beads, etc., and then provides feedback to the user and/or directly to the magnetic field controller (via automated image processing) that may be used, for example, to enable isolation or removal of selected cells (or co-localized beads). In many embodiments, the magnetophoretic sorting system includes an embedded computer or processor (although a peripheral computer or processor may be used in some embodiments) that runs software for controlling and coordinating the activities of the imaging module, magnetophoretic transport controller, fluidics controller, and other functional subsystems.

In some embodiments, a plurality of microchambers with a magnetophoretic device may be imaged in its entirety within a single image. In some embodiments, a series of images may be “tiled” to create a high resolution image of the entire plurality of microchambers within the array.

Any of a variety of light sources may be used to provide the imaging or excitation light, including but not limited to, tungsten lamps, tungsten-halogen lamps, arc lamps, lasers, light emitting diodes (LEDs), or laser diodes. In many embodiments, a combination of one or more light sources, and additional optical components, e.g. lenses, filters, apertures, diaphragms, mirrors, and the like, will comprise an illumination sub-system.

Any of a variety of image sensors may be used for imaging purposes, including but not limited to, photodiode arrays, charge-coupled device (CCD) cameras, or CMOS image sensors, microlenslet arrays, scanners, or other optical detection means. Imaging sensors may be one-dimensional (linear) or two-dimensional array sensors. In many embodiments, a combination of one or more image sensors, and additional optical components, e.g. lenses, filters, apertures, diaphragms, mirrors, and the like, will comprise an imaging system sub-system. In those embodiments, where the optical imaging module is configured to perform other types of spectroscopic measurements, the module may comprise one or more photomultipliers, photodiodes, avalanche photodiodes, or other photosensors.

The optical imaging module will typically include a variety of optical components for steering, shaping, filtering, or focusing light beams. Examples of suitable optical components include, but are not limited to, lenses, mirrors, prisms, diffraction gratings, colored glass filters, narrowband interference filters, broadband interference filters, dichroic reflectors, optical fibers, optical waveguides, and the like. In some embodiments, the optical imaging module will further comprise one or more translation stages or other motion control mechanisms for the purpose of moving the magnetophoretic device relative to the illumination and/or imaging sub-systems, or vice versa.

Other Techniques for Monitoring Magnetic Particles, e.g. Labeled Single Cells or Cell Clusters, within Magnetophoretic Arrays:

In some embodiments, non-optical techniques may be used to monitor magnetically-susceptible objects, e.g., labeled single cells or cell clusters, within magnetophoretic array devices. Examples of suitable techniques include, but are not limited to, electrochemical sensing (e.g. using set(s) of electrodes patterned on the substrate surface), autoradiography, matrix-assisted laser desorption/ionization (MALDI) mass spectrometry, and the like. Implementation of these and similar techniques may require specialized modifications to the magnetophoretic device and/or the functional modules of the magnetophoretic sorting platform.

Physical and Chemical Stimuli:

In another aspect of the disclosed devices and systems, the magnetized objects (e.g., cells or other bioparticles) are placed in the magnetophoretic sorting arrays and observed, e.g., using a fluorescence microscope, over long periods of time during which the cell (or bioparticle) array may optionally be exposed to pharmaceutical compounds, cytokines, growth hormones, other cells, or other chemical or physical stimuli, and the response of the cells may be monitored using suitable indicators, e.g. fluorescent indicators.

In some embodiments of the disclosed devices and systems, the objects within an array device, e.g. magnetically-labeled cells, may optionally be contacted with an activating agent, physical or chemical stimulus, or test compound at known, user-adjustable times while monitoring a property or response of the cells, whereby specific cells displaying a unique response to the external stimulus may be subsequently retrieved from the array for follow-on genomic analysis, gene expression analysis, or clonal expansion. Magnetophoretic sorting platforms may thus be used to measure time-dependent or transient changes in stimulus-induced gene expression, for example, or the time-dependent dose-response curve for a drug candidate. Other means for monitoring the impact of activating agents, test compounds, and physical or chemical stimuli on cells compartmentalized within the array include, but are not limited to, monitoring the number of cell divisions, cell size, cell shape, organelle number, organelle shape, organelle size, reporter gene expression, or any combination thereof, as a function of time. In some embodiments, the level of a cellular protein, a phosphoprotein, a degree of protein localization, or the level of an organelle function, or any combination thereof, is measured using a fluorescence-based assay following exposure to the test compound, e.g. a drug.

Examples of cell activating agents and test compounds include, but are not limited to, drugs, small organic molecules and other pharmaceutical compounds, T-cell activating pharmacological agents (e.g. phorbol 12-myristate 13-acetate), anti-CD3/TCR or anti-Thy-1 monoclonal antibodies, cytokines, hormones, growth hormones, peptides and proteins, oligonucleotides and nucleic acids, enterotoxins, carbohydrates, lectins, lipids, antibiotics, small molecule chemotherapies (alkylating agents, topoisomerase inhibitors, microtubule-targeting agents, antibody-cytotoxin conjugates, antimetabolites, and the like), targeted small molecule therapeutics (kinase inhibitors, anti-estrogens, anti-androgens, phosphatase inhibitors, HSP90 inhibitors, histone deacetylase inhibitors, histone acetyltransferase inhibitors, histone and DNA demethylase inhibitors, histone and DNA methyltransferase inhibitors, BET bromodomain inhibitors, proteasome inhibitors, and the like), nanoparticle- or microparticle-encapsulated drugs (small molecules, proteins, or nucleic acids), aptamers, cDNAs, siRNAs, sgRNAs, microRNAs, mRNAs, antibodies, antigens, enzymes (e.g. kinases), protein therapeutics, other cells, viruses, retroviruses, lentiviruses, micelles, nanoparticles, liposomes, and the like.

Examples of physical and chemical stimuli include, but are not limited to, temperature jumps, pH changes, ionic strength changes, changes in Ca²⁺ concentration, changes in Mg²⁺ concentration, changes in oxygen concentration or other gas concentrations, changes in the concentration of nutrients like glucose or amino acids, exposure to lysis buffers, pressure changes, exposure to electric fields, exposure to magnetic fields, exposure to acoustic fields, exposure to light stimuli, exposure to electromagnetic radiation, exposure to non-electromagnetic radiation, and the like. In some embodiments, the fluidics controller or equivalent modular system component will be configured to provide precise control of the timing and duration of the delivery of one or more chemical or physical stimuli.

System Processor and Instrument Control Software:

In many embodiments, the instrument system will comprise a computer (or processor) and computer-readable media that includes code for providing a user interface as well as manual, semi-automated, or fully-automated control of all system functions, e.g. control of the magnetic field controller, the fluidics control sub-system, the temperature and gas control sub-systems, the imaging system, and the motion of the stage. In some embodiments, the system computer or processor may be an integrated component of the instrument system (e.g. a microprocessor or mother board embedded within the instrument). In some embodiments, the system computer or processor may be a stand-alone module, for example, a personal computer or laptop computer.

Examples of magnetic field control functions provided by the instrument control software include, but are not limited to, control of the on/off timing, duration, and frequency of the time-varying external magnetic field(s), and in the case of electromagnets, the strength of the magnetic field as well.

Examples of fluid control functions provided by the instrument control software include, but are not limited to, volumetric fluid flow rates, fluid flow velocities, the timing and duration for magnetically-labeled cell sample(s) and/or magnetic bead addition, assay reagent addition, the delivery of chemical or physical stimuli, valve switching, and rinse steps.

Examples of temperature control functions provided by the instrument control software include, but are not limited to, specifying temperature set point(s) and control of the timing, duration, and ramp rates for temperature changes.

Examples of gas control functions provided by the instrument control software include, but are not limited to, control of CO₂ concentration.

Examples of imaging system control functions provided by the instrument control software include, but are not limited to, autofocus capability, control of illumination or excitation light exposure times and intensities, control of image acquisition rate, exposure time, and data storage options.

Examples of translation stage system control functions provided by the instrument control software include, but are not limited to, control of the stage position, orientation, and the timing and time duration thereof.

In some embodiments of the disclosed systems, software-based control mechanisms may be used to automate the placement and retrieval of magnetically-susceptible objects, e.g. magnetically-labeled cells or magnetic beads, in large magnetophoretic arrays. In one non-limiting example, a software program may be used to control 32 independent current channels, which allows the transistor switches to be actuated with arbitrary phase, frequency, and amplitude, thereby providing a flexible interface to time the gate electrodes, which enables automatic placement of magnetically-labeled cells and beads into arrays. In some embodiments, the use of microfluidic control systems comprising multiple, independently-controllable flow channels and integrated fluidic valves may provide better control of the micro-environment of single cells within arrays, and enable one to control the timing and exposure level of the arrayed cells to different stimulatory compounds. In some embodiments, the sorting platform may utilize a microfabricated valve system to open and close microfluidic chambers, as needed, e.g., to control the exposure of bead-based sensing reagents to cell secretions.

Image Processing Software:

In some embodiments of the instrument system, the system will further comprise computer-readable media that includes code for providing image processing and analysis capability. Examples of image processing and analysis capability provided by the software include, but are not limited to, manual, semi-automated, or fully-automated image exposure adjustment (e.g., white balance, contrast adjustment, signal-averaging and other noise reduction capability, etc.), automated edge detection and object identification (e.g., for identifying microchambers, cells, and/or beads in the image), automated statistical analysis (e.g., for determining the number of cells or beads identified per microchamber, or for identifying microchambers that contain more than one cell or more than one magnetic bead), and manual measurement capabilities (e.g., for measuring distances between objects, etc.). In some embodiments, the instrument control and image processing/analysis software will be written as separate software modules. In some embodiments, the instrument control and image processing/analysis software will be incorporated into an integrated package. In some embodiments, the system software may provide integrated real-time image analysis and instrument control, so that the results of the imagine processing and analysis may be used in a manual, semi-automatic, or fully automatic feedback loop to control the instrument, e.g., to prolong magnetophoretic transport steps until a target percentage of microchambers in an array each contain a single cell or single bead, or to magnetophoretically remove one of the cells from microchambers in which two or more cells are detected. The population statistics for microchamber occupancy is typically defined by a Poisson distribution, where after the magnetic organization step the probability of observing “k” cells in a microchamber is given by P(k)=(λ^{k}e^{-λ})/k!, where λ is the mean number of cells in each microchamber. To ensure that greater than 90% of the microchambers contain at least one cell, the value λ=2.5 is chosen, from which the expected assembly statistics are that approximately 8% of microchambers contain no cells, approximately 20% of microchambers contain one cell, approximately 25% of microchambers contain two cells, approximately 21% of microchambers contain 3 cells, and approximately 26% of microchambers contain more than 3 cells without error correction.

Magnetophoretic Sorting Platform Applications:

The disclosed methods, devices, and systems have a variety of potential applications, including biological and non-biological applications, for example:

1. Single Cell Cytokine Sensing Platforms:

As will be described in more detail below, one embodiment of the disclosed devices and systems comprises an in situ single cell cytokine-sensing platform. In some embodiments, the magnetophoretic sorting platform may be capable of organizing, maintaining, and continuously monitoring at least 100 single cells, at least 1,000 single cells, at least 10,000 single cells, at least 100,000 cells, or more, in a microfabricated cell culture platform. The sorting platform should be capable of automating the placement of magnetic bead-based cytokine sensors next to each of the arrayed single cells, and should also be capable of calibrating the sensing beads. The sorting platform will enable in situ sensing of the cytokine secretion profile of single cells, and identification of functional heterogeneity among T cell subsets. Surface functionalization techniques may be used to optimize the magnetic bead-based cytokine sensors to enable multiplexed secretion analysis from single cells. Another important feature of the disclosed sorting platform will be its capability to retrieve and export specific single cells for follow-on genetic analysis, clonal expansion, or immortalization. At present, no existing single cell platform is able to automate the large-scale analysis of both the functional and gene expression profile of single cells. The ability to identify correlations between cell function and gene expression may yield tremendous insights for drug discovery purposes and the identification of behavioral phenotypes that are predictors of epigenetic regulatory processes.

2. Platforms for the Study of Cell-Cell Interactions:

Beyond the parallel detection of secreted cytokines from single cells, the advantage of the disclosed magnetophoretic platform is its flexibility to add functional modules, which may be used to facilitate the collection of increasing amounts of information about cellular interactions. For example, in some embodiments the platform's ability to organize N different objects in each microchamber may be used to form single cell pairs, of the same cell type or of different cell types, and even small communities of cells of the same or mixed cell type, to better mimic the environmental and cellular interactions of native tissue. The analysis of functional behavior in small groups of cells may be of particular importance in studies aimed at particular human disease models. Magnetic bead-based chemical sensors of one or more sensor types may be introduced into the same compartments with the pairs of cells, or small communities of cells, in order to perform sensing of, for example, secreted cell products arising from cell-cell interactions. In general, the functional flexibility of the disclosed magnetophoretic sorting platforms enables transporting and sorting of any combination of magnetically-labeled cells and/or magnetic bead-based sensors into each individual microchamber of a plurality of microchambers contained within a device.

Non-limiting examples of cell-cell interactions that may be studies using the disclosed methods, devices, and systems include: immunological interactions in heterogeneous sets of two or more immune cells; the study of immune surveillance (i.e. the identification of cancerous and/or precancerous cells by the immune system and the subsequent elimination of cancerous or precancerous cells before they can cause harm) or immunotherapies in heterogeneous sets of immune cells and cancer cells; the study of neuromuscular junctions in heterogeneous sets of neuron cells and muscle cells; the study of neuronal signaling and the drug-dependence thereof in heterogeneous sets of neuron cells, glial cells, and astrocytes; the study of properties of tumor microenvironments in heterogeneous sets of tumor cells and endothelial cells, epithelial cells, macrophages, neutrophils, NK cells, fibroblasts, stromal cells, smooth muscle cells, adipocytes, and other cells; the study of adhesion between pairs of cells; the study of interactions between immune cells and pathogens; the study of interactions between leukocytes and endothelial cells; and the study of tight junctions, gap junctions, or any other junction involving direct contact between the membranes of two different cells.

3. Platforms for Performing Other Cell-Based Assays and Operations:

Other assay functions that can be implemented using the disclose magnetophoretic methods, devices, and systems, and which are not mainly involved with quantifying the expression changes of single human cells include, but are not limited to:

3a. Isolation of Individual Cells for On-Chip Assay Cultures.

This embodiment of the disclosed magnetophoretic sorting platform is similar technology to conventional cell sorting cytometers, however greatly miniaturized.

3b. Retrieval of Single Immune Cells for Immortalization or Clonal Expansion.

The disclosed magnetophoretic platforms may be configured for retrieval of single immune cells for subsequent immortalization of clonal expansion for use in immunotherapeutic or cellular approaches to disease treatment and therapy. The ability to actively monitor single cells in a confined and controlled environment may allow selection of specific high priority cells from the array for clonal expansion.

3c. Single Cell Antibody-Dependent Cell-Mediated Cytotoxicity (ADCC) Assays.

The disclosed magnetophoretic sorting platforms may be configured to perform ADCC assays. This is essentially a Target & Effector reaction that requires antibody for successful cytotoxicity reaction.

3d. Cytotoxic T Lymphocyte (CTL) Reactions (Antibody-Independent):

The disclosed magnetophoretic sorting platforms may be configured to perform antibody-dependent cytotoxic T lymphocyte (CTL) reactions, such as those mediated by direct contact cytotoxic mechanisms (i.e. granzyme B, perforin secretion).

3e. Cell-Based Neutralization Assays.

The disclosed magnetophoretic sorting platforms may be configured to perform cell-based neutralization assays in which antibody is introduced to the compartmentalized cells, attaches to those cells expressing the corresponding antigen, and initiates a cytotoxicity reaction pathway. The ability to make single cell temporal observations may yield important information regarding the details of these processes.

3f. Immunogenicity Assessment for Candidate Vaccines.

The disclosed magnetophoretic sorting platforms may be configured to perform immunogenicity assessment for candidate vaccines by expose isolated single cells in the array to candidate vaccine compounds. The goal would be to identify which cells become polyfunctional, i.e., that express multiple cytokines. In some embodiments, the identified cells may subsequently be retrieved from the array for further analysis of gene expression analysis (including kinetic analysis).

3g. Cell Lineage Tracing of Specific Cells of Interest.

The disclosed magnetophoretic sorting platforms may be configured to perform cell lineage tracing of specific cells of interest, e.g., immortalized and proliferative B cells. Immortalized cells are useful for antibody production ex vivo. One would like to prevent immortalization in vivo because such cells may be cancerous.

3h. Identification and Extraction of Polyfunctional CD4⁺ and/or CD8⁺ T Cells.

The disclosed magnetophoretic sorting platforms may be configured to perform identification and extraction (retrieval) of polyfunctional CD4⁺ and/or CD8⁺ T cells for downstream analysis or clonal expansion.

3i. Stem Cell Isolation, Culture, Manipulation, & Extraction.

The disclosed magnetophoretic sorting platforms may be configured to perform stem cell isolation, culture, manipulation, and extraction, etc.

3j. Cell Lineage and Aging Studies.

The disclosed magnetophoretic sorting platforms may be configured to perform cell lineage and aging studies. These can be of relevance in learning about the type of mutations that occur in single cells, their rates of mutations, and generally how a system ages. One may also study approaches to repair the mutations using gene editing techniques such as CRISPR.

3k. Sex Typing of Sperm and Directed Fertilization.

The disclosed magnetophoretic sorting platforms may be configured to perform sex typing of sperm and directed fertilization. Using markers that label the sperm (e.g., for male/female, or other traits) one may create an array of ovum and then selectively mate the desired sperm with specific ovum for high efficiency in vitro fertilization. The embryos may then be studied to determine cell division rate, and other critical developmental features.

3l. Study and Selection of Yeast or Bacterial Cell Strains.

The disclosed magnetophoretic sorting platforms may be configured to study and select yeast cells exhibiting desired properties, e.g., one may use the disclosed magnetophoretic platforms to study yeast cells and to select those strains which are the most efficient for producing drugs, converting products (e.g., beer or wine), or for use in other manufacturing processes. Similar studies and selection processes may be performed using bacteria.

3m. Quorum Sensing in Bacteria.

The disclosed magnetophoretic sorting platforms may be configured to study quorum sensing in multiple bacteria, where the numbers of bacterial cells within each compartment within the array are well controlled.

3n. Microbiome Studies.

The disclosed magnetophoretic sorting platforms may be configured to perform microbiome studies, i.e. to study the interaction between cells and bacteria in order to better understand the relationship between the microbiome and the cells of the gut or other tissues.

3o. Organ-On-a-Chip Studies.

The disclosed magnetophoretic sorting platforms may be configured to create spatial organizations of single cells without physical compartments (only electromagnetic barriers), and allow these to grow to confluence to create “heart on a chip”, “liver on a chip”, “gut on a chip”, and similar in vitro tissue models.

4. Single Cell Molecular Barcoding and Counting Platforms:

In some embodiments, the disclosed magnetophoretic sorting platforms may be configured to perform single cell molecular barcoding and counting assays, as recently described in Fan, et al. (2015), “Combinatorial Labeling of Single Cells for Gene Expression Cytometry”, Science 347(6222):628; and Science 347(6222):1258367, U.S. Patent Application Publication No. US2015/0299784 A1, and in U.S. Pat. Nos. 9,290,808 and 9,290,809. In this application, magnetically-labeled single cells may be randomly sorted into an array of microchambers. A combinatorial library of magnetic beads bearing cell- and molecular-barcoding capture probes are then added so that each single cell is compartmentalized alongside a single bead. The bead library has a cell barcode diversity of on the order of ˜10⁶, or greater, so that each cell is paired with a unique cell barcode, whereas the molecular barcode diversity is on the order of ˜10⁵, or greater, so that each individual mRNA molecule (or other oligonucleotide target molecules, as defined by the target molecule recognition sequence portion of the molecular-barcoding capture probes) within a cell becomes specifically labeled. After cell lysis, performed by introducing a suitable lysis buffer to the array of microchambers, the released mRNA molecules (or other target oligonucleotide molecules) hybridize to the beads, which are subsequently retrieved from the array and pooled for reverse transcription, amplification, and sequencing. For single cell gene expression profiling studies, complementary DNA strands (cDNAs) from all polyadenylated transcripts of each cell are covalently archived on the bead surface, therefore any selection of genes can be analyzed. The digital gene expression profile for each cell is reconstructed when barcoded transcripts are assigned to the cell of origin and counted. In some embodiments, the reverse transcription reaction may be performed within the microchambers of the magnetophoretic array, prior to retrieval of the beads. In some embodiments, the amplification (e.g. PCR amplification or isothermal amplification) and sequencing reactions (e.g. cyclic sequencing by synthesis reactions) may also be performed within the microchambers of the magnetophoretic array. In some embodiments, each individual bead within the plurality of magnetic beads may comprise two or more target molecule recognition sequences. In some embodiments, more than one magnetic bead may be co-compartmentalized with each single cell within the magnetophoretic array, wherein different beads comprise different target recognition sequences directed to one or more different oligonucleotide target molecules (e.g. mRNA molecules, tRNA molecules, fragments of genomic DNA, and the like). Selective retrieval of all of the beads from within a single compartment would then allow downstream processing of molecular barcodes for counting different types of target molecules associated with the same single cell. In some embodiments, one or more molecular sensing beads, e.g., cytokine sensing beads, and molecular barcoding beads may be co-compartmentalized (simultaneously or sequentially) with single cells to monitor, e.g., cytokine secretion patterns or changes in cytokine secretion pattern following exposure to a chemical stimulus, followed by lysis of the cell and molecular barcoding of the released mRNA molecules to correlate changes in gene expression profile with changes in secretion patterns.

5. Large-Scale, Parallel Sequencing-by-Synthesis Platforms:

In some embodiments, the disclosed magnetophoretic sorting platforms may be configured to perform sequencing by synthesis reactions on large arrays of magnetic beads, each comprising a strand of clonally-amplified template DNA or RNA. Clonally-amplified template sequences attached to magnetic beads comprising a capture adaptor sequence may be prepared off-chip, for example using an emulsion PCR technique [H. P. J. Buermans and J. T. den Dunnen (2014), “Next Generation Sequencing Technology: Advances and Applications”, Biochim. et Biophys. Acta 1842:1932-1941], and then magnetophoretically sorted into an array of microfluidic chambers, or they may be prepared on-chip by magnetophoretically sorting single capture beads into the array of microfluidic chambers, introducing the complementary adapter-labeled template sequence fragments into the array device at a sufficiently low concentration that the probability of more than a single template sequence fragment being compartmentalized in a given microfluidic chamber is extremely low, and performing an amplification reaction within the device. During sequencing, the clonally-amplified template sequences may be read one nucleotide at a time as fluorescently-tagged dNTPs are introduced in repetitive cycles and incorporated by a DNA polymerase in a manner similar to that used in the Illumina sequencing technology [H. P. J. Buermans and J. T. den Dunnen (2014), “Next Generation Sequencing Technology: Advances and Applications”, Biochim. et Biophys. Acta 1842:1932-1941]. Each of the four dNTP species (A, C, T, G) comprises a different fluorescent label which serves to identify the base and acts as a reversible terminator to prevent multiple base extensions. After imaging the array, the fluorescent group may be cleaved off, the reversible terminator de-activated, and the template strands made ready for the next incorporation cycle. The template sequences may read by following the fluorescent signal associated with each extension reaction step for each bead in the array. In some embodiments, alternative sequencing by synthesis chemistries may be utilized, and the sequence of the template may be read by monitoring changes in light intensity, pH or electrical current.

6. Large-Scale, Parallel Solid-Phase Synthesis Platforms:

In some embodiments, the disclosed magnetophoretic sorting platforms may be configured to transport magnetic beads comprising surfaces functionalized with chemically-reactive groups (e.g. primary amines, carboxylates, or tBOC or FMOC-protected versions thereof, or a bead-bound nucleoside having a 5′-4,4′-dimethoxytrityl (DMT) protecting group) for the purpose of performing parallel or combinatorial solid-phase synthesis of peptides or oligonucleotides (or analogues thereof). In these embodiments, the magnetophoretic devices are fabricated from materials that are inert to activating agents and chemical solvents, and one or more magnetic beads (solid-phase synthesis support beads) are sorted into each microfluidic compartment of a plurality of microfluidic compartments, and subjected to a cyclic series of deprotection, coupling, rinsing, capping, and cleavage steps using any of a variety of suitable coupling chemistries known to those of skill in the art (see, for example, Shin, et al. (2005), “Combinatorial Solid Phase Peptide Synthesis and Bioassays”, J. Biochem. Molec. Biol. 38(5):517-525; “Chandrudu, et al. (2013) “Chemical Methods for Peptide and Protein Production”, Molecules, 18:4373-4388; S. Roy and M. Caruthers (2013), “Synthesis of DNA/RNA and Their Analogs via Phosphoramidite and H-Phosphonate Chemistries”, Molecules 18:14268-14284). In some embodiments, the magnetic beads may be sorted into and remain in specified microfluidic compartments for the duration of the cyclic series of synthesis reactions, wherein different sequences of coupling reagents are introduced into different microfluidic compartments thereby enabling parallel synthesis of libraries of different peptide or oligonucleotide compounds. In some embodiments, sets of magnetic beads may be sorted into each microfluidic compartment, wherein different coupling reagents are introduced into different microfluidic compartments at each coupling step, and wherein the magnetic beads are transported out of the microfluidic compartments, pooled, mixed, and subsequently redistributed between each coupling step, thereby enabling combinatorial synthesis of large libraries of peptides or oligonucleotides using the split-pool synthesis strategy. In some embodiments, the peptides or oligonucleotides synthesized on the magnetic beads may be released from the beads following synthesis, for example, the peptides or oligonucleotides attached to individual magnetic synthesis beads may be released into the individual compartments within which the beads reside for use in homogeneous bioassays or for other purposes. In some embodiments, the peptides or oligonucleotides synthesized on the magnetic beads may be used in situ for performing heterogeneous (solid-phase) bioassays or used for other purposes.

7. Platforms for Assembly and Study of Catalyst Arrays:

In another non-limiting example of a non-biological application, in some embodiments the disclosed magnetophoretic sorting devices and systems may be configured to perform assembly and characterization of catalyst arrays, e.g., arrays of magnetized metal nanoparticles that may serve as catalysts for growth of carbon nanotube (or other types of nanotube) arrays using, e.g., catalytic chemical vapor deposition or other techniques known to those of skill in the art (A.-C. Dupuis (2005), “The Catalyst in the CCVD of Carbon Nanotubes—A Review”, Progr. in Materials Sci. 50(8): 929-961; Levchenko, et al. (2013), Chapter 2 in Nanotechnology and Nanomaterials: Syntheses and Applications of Carbon Nanotubes and Their Composites, edited by S. Suzuki, ISBN 978-953-51-1125-2, InTech, May 9, 2013; Hu, et al. (2015), “Growth of High-Density Horizontally Aligned SWNT Arrays Using Trojan Catalysts). In some embodiments, the sorting and assembly of magnetized metal nanoparticles into densely-packed clusters defined by the magnetophoretic circuit and/or a microfluidic structure may provide for the controlled growth of patterns of nanotube structures on device substrates. In some embodiments, the device substrate may comprise a conductive substrate or conductive coating (e.g. indium tin oxide (ITO)) applied to a non-conductive substrate. In some embodiments, the sorting of a plurality of individual magnetized metal nanoparticle catalysts (wherein the plurality of nanoparticles comprises particles having the same or different material or catalytic properties) into separate microfluidic compartments, and the subsequent introduction of chemical reactants and substrates into the compartments, may enable high-throughput optimization of solution-phase catalytic reaction conditions, where reactions are monitored, for example, by colorimetric or electrochemical detection techniques. In some embodiments, the magnetized metal nanoparticle catalysts may comprise biological enzymes.

The following examples are illustrative only and are not intended to be limiting in scope.

### Example 1—A General Strategy for the Spatiotemporal Organization of Single Cells and Discrete Numbers of Cells in a Cell Analysis Platform

General strategies for analyzing the secretion of single cells, changes in their gene expression profiles in real time, and their response to different drugs and drug cocktails are first discussed. Next, a magnetophoretic single cell sorting platform is described, which can be used to organize a discrete numbers of different types of single cells into each of the compartments, which may occur at different times, and in different combinations of cell types and cell numbers. The analytical techniques described in section (A) may be used in combination with the multi-cell systems described in section (B) to study single cell signaling and reprogramming of cell states.

A. Placement of Single Cells of Cell Type a in an Magnetophoretic Array Chip and Analysis of Secretion Patterns:

A magnetophoretic array device comprising the circuit components described above may be designed to sort single cells of a specified cell type and/or magnetic beads into an array of microfluidic chambers, followed by analysis of secretion patterns using any of a variety of analysis techniques known to those of skill in the art, including but not limited to the following:

(i) Analyze the secretion of cell type A with capture antibodies patterned at the bottom of the compartment and fluorescently-tagged detection antibodies. If these are cytokine capture antibodies, then the purpose of these systems is to determine if the single cells are monofunctional, bifunctional, or polyfunctional. This is the equivalent of single cell ELISA, however where spatial patterns of the capture antibodies can be used to analyze several types of cytokines secreted by single cells. Other sorts of cellular secretions, such as whole virus particles, can be detected by a similar approach, wherein the capture antibodies contain fragments that recognize receptors on the outer surface of the virus.
(ii) Analyze the secretion of cell type A with cytokine capture antibodies conjugated to magnetic bead-based sensors. The purpose of this is to avoid the fabrication problems of creating spatial patterns of capture antibodies in each compartment. Instead, wavelength multiplexing (e.g., using fluorescent dyes having different emission spectra conjugated to the detection antibodies) can be used to determine the cytokines released into the external medium nearby the single cells. When the target binds with a bead-based sensor and corresponding detection antibody, a color change will indicate the presence of the secreted product.
(iii) Analyze gene expression changes in cell type A with fluorescent gene reporters engineered into the single cells. The purpose of this is to allow for genes to be engineered into single cells, such that a change in expression can be actively monitored through a change in the fluorescent state of a single cell. This will allow us to analyze early expression changes shortly after activation of specific transcription processes.
(iv) Use CRISPR to edit the genes of cell type A while in the array. This approach is similar to that described above, except that the introduction of reporter genes is occurring in situ in the array.
(v) Analyze phenotype changes of single cells responding to changes in temperature, gas levels, or pH changes of the medium, exposure to different drug compounds at different concentrations and exposure durations, or exposure to growth hormones or other chemical or physical stimuli.
(vi) Use of additional instruments such as laser tweezers or micropipettes to extract material from individual cells in their compartment, or introduce new magnetic beads, particles, drugs, or other compounds to compartmentalized single cells of interest in real time.

B. Organization of Single Cell Pairs of Multiple Types in a Single Compartment:

The magnetophoretic methods and devices disclosed herein may further designed to introduce single cells or multiple cell types, in any combination, into each compartment of a plurality of compartments. The resulting interactions between pairs of cells or clusters of cells may be subsequently analyzed as various experimental parameters are manipulated, including but not limited to:

(i) Control of the separation distance between cells of type A and type B as a function of time. The purpose of this capability is to distinguish between cells that interact by physical contact or through soluble mediators, such as secreted cytokines, chemokines, interleukins, cytolytic proteins, receptors, etc. The cell interaction may be controlled so as to facilitate physical contact for a pre-determined time duration, or their interaction separation distances may be restricted to predefined values (e.g., 1 μm, 2 μm, 5 μm, 10 μm, etc.).
(ii) Introduce a cell of type A and a cell of type B into the same compartment for a predetermined time, and then retrieve the individual cells for follow on analyses. The purpose of this function is to direct the cell pair interaction to re-program single cells by physical (or nonphysical) contact, and then analyze any changes that occur in their expression levels, or introduce these programmed cells to unexposed single cells for follow on signaling events. These exposed cells may also be clonally expanded or reintroduced into a patient's body for immune-defense applications.
(iii) Sequential introduction of cell type A to a series of cell type B. This could involve the placement of a single cell of type A into one of the compartments, followed by placement of a single cell of type B into the same compartment for a predetermined time, and subsequently followed by the removal of the type B cell from the compartment. At a future time, another single cell of type B can be placed into the compartment with the single cell of type A. This process can be repeated sequentially as many times as necessary, in order to investigate exhaustion or regeneration of single cell programming processes or cytolytic kill events.
(iv) Introduction of single cells of arbitrary cell type and number into the compartments. This could involve the placement of three or more single cells of the same cell type or of different cell types into the same compartment, where these single cells can be introduced at the same time, or sequentially at different times.
(v) Removal (extraction) of cells that have undergone one or more rounds of mitosis from the compartments, and placement in a new compartment. This feature may be used to study cell lineage, and to trace the evolution of mutations or changes in phenotype during cell division.

Note that in the above discussion, a single cell may consist of any adaptive or innate immune cells of interest, including but not limited to T cells, B cells, natural killer (NK) cells, NK T cells, macrophages, dendritic cells, gamma-delta T cells, etc. One example of a cell pair for use in studying cell-cell interactions includes the co-compartmentalization of a single helper CD4⁺ T cell and a single CD8⁺ cell, where the goal is to study the cytolytic “kill” event during HIV infection. The analysis of cell interactions may also not be restricted to the study of a pair of single immune cells. The magnetophoretic cell sorting platform may be suitable for studying cellular interactions comprising more than two types of immune cells, or comprising sets of cells, e.g., a set of cells comprising n=x of type 1 cells, n=y of type 2 immune or non-immune cells, n=z of type 3 immune or non-immune cells, etc. These could be cancer cells, stem cells, nerve cells, etc.

In the most general sense, the goal is to understand the programmed interaction between a target cell and an effector cell. Target and effector cells may consist of any combination of adaptive or innate immune cells as well as tissue specific cell types, such as endothelial cells, interstitial cells, having cell ratios of 1:1, 1:2, 1:3, . . . , 1:n target-to-effector cell ratios, etc.

### Example 2—Specific Examples of the Study of Viral Latency and Activation Mechanisms at the Single Cell Level

The following discussion contains a list of non-limiting prophetic examples of the types of single cell interrogations that can be conducted on latent HIV infection using the disclosed methods, devices, and systems, and their relation to the discovery of pharmaceutical compounds that can activate cells from the latent state. In some embodiments, the disclosed methods, devices, and systems may be used in studies of pharmaceutical compounds that block activation of cells from the latent state, or that eliminate active virus and therefore trap virus in a latent state. Additionally, a list of other viral infections that can be investigated using a similar approach is provided.

A. Analysis of HIV Latency in Single Cells:

(i) Analyze the latency activation mechanism occurring in single HIV-1 infected CD4⁺ T cells during exposure to single dose of anti-latency compounds.
(a) where the anti-latency compounds include one of the following: vorinostat, brominostat, or other recently developed pharmaceutical compounds.
(b) where the single dose of anti-latency compounds is dosed at periodic intervals or at different concentrations to determine latency activation kinetics.
   (ii) Analyze the latency activation mechanism occurring in single HIV-1 infected CD4⁺ T cells during exposure to two or more types of anti-latency compounds.
(a) where the anti-latency compounds include one of the following: vorinostat, brominostat, or other recently developed pharmaceutical compounds.
(b) where the single dose of anti-latency compounds is dosed at periodic intervals or at different concentrations to determine latency activation kinetics.
(c) where the readout mechanism consists of the detection of a fluorescent gene, detection of a secreted cytokine or secreted HIV virus particles, or some other output that signifies activation from a latent state.
   (iii) Analyze the epigenetics of the single HIV-1 infected CD4⁺ T cells after various intervals of exposure to anti-latency compounds, which involves retrieving one or more of the identified single cells from the magnetophoretic array and performing genetic analysis, including one of the following, single cell PCR, single cell RT-PCR, or single cell mRNA expression. This can be carried out at multiple time points immediately after latency activation in order to determine the kinetics of epigenetic regulation occurring within single cells.
(a) where the CD4⁺ cells are exposed to CD8⁺ cells at different time points before or after latency activation to determine the effects of cell-cell contact on the gene regulation.
   (iv) Use of a magnetophoretic cell sorting platform to organize arrays of latently infected single cells from patient derived cells
(a) Expose patient derived blood cells to an HIV-encoding virus with fluorescent reporter gene, then introduce HIV-1 specific CD8⁺ T cells to induce cytotoxic compounds which destroy any non-latent CD4⁺ T cells, followed by collecting the remaining CD4⁺ T cells and introducing them into specific compartments of the single cell array.
   (v) Analyze the phenotype of single HIV-1 infected CD4⁺ T cells within the magnetophoretic array by introducing fluorescent markers, including: fluorescently-tagged antibodies to one or more cell surface receptors, lipophilic fluorescent cell membrane dyes, fluorescent, cell-permeant nuclear dyes, etc.

B. These same magnetophoretic cell sorting platform capabilities can also be used to analyze latency processes occurring in:

(i) Human cytomegalovirus latency
(ii) Other herpes viruses, e.g., varicella zoster, herpes simplex, etc.
(iii) Latent M. tuberculosis macrophage infection

These same magnetophoretic cell sorting platform capabilities can also be used to detect the amount of virus secreted by single cells in order to analyze the degree of infection, for example, in influenza, rhinovirus, or other respiratory infections.

### Example 3—Single Cell Cytokine Sensing Platform

Work is in progress to develop magnetophoretic platforms for organizing, maintaining, monitoring, and retrieving single cells in large arrays of individual compartments. Microfluidic control systems comprising multiple, independently-controllable flow channels and integrated fluidic valves will be utilized to provide improved control of the micro-environment of single cells within the array and to provide the capability to expose cells in the array to different chemical stimuli. In some embodiments, the magnetophoretic sorting systems may also provide the capability to expose cells in the array to different physical stimuli.

Organizing Cells in Single Cell Arrays:

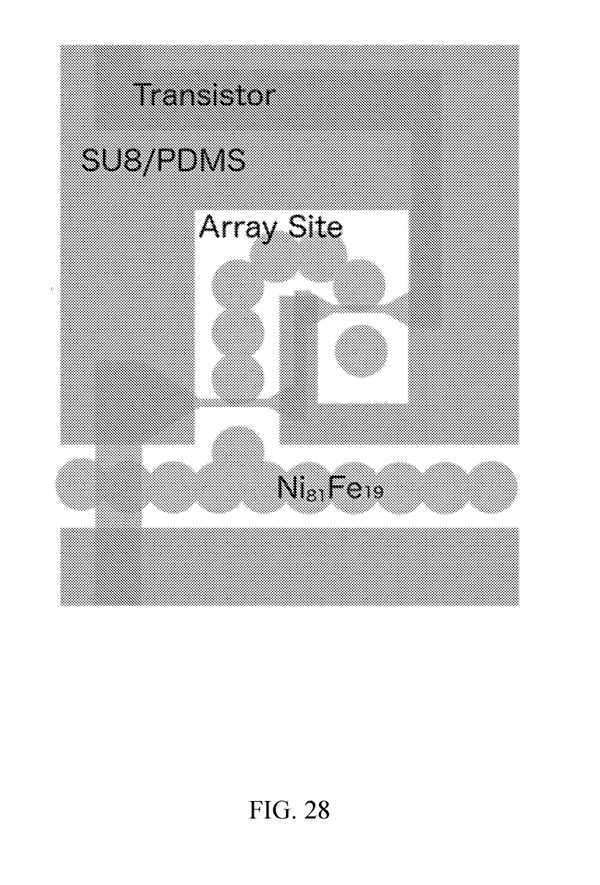

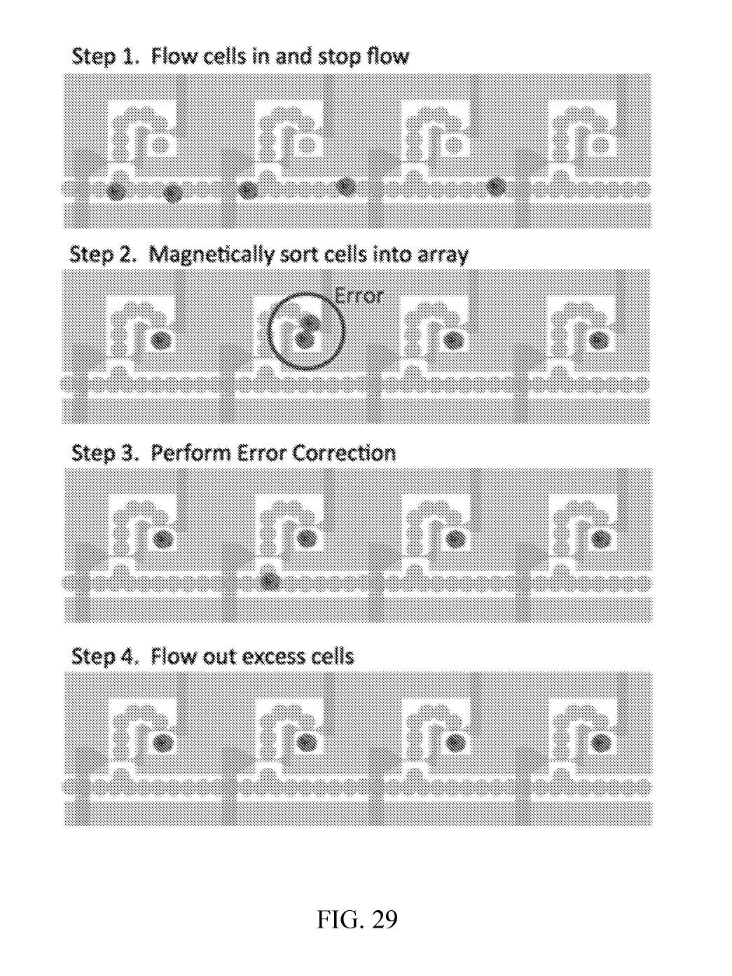

Proof-of-principle experiments have demonstrated the ability of the disclosed devices and systems to organize small arrays of magnetically-labeled cells and beads. In some embodiments, the cell sorting platforms under development may enable automated sorting of at least 1,000 cells and/or beads, in any combination of cell types or bead types, and in any cell-to-bead ratio. In these embodiments, a microfluidic flow control module may be used to deliver magnetized cells to the microfluidic array (passive delivery), after which the magnetic transport mechanism will be used to specifically transport cells into the desired microchambers (active delivery) (FIGS. 28 and 29).

Two different methods for forming microfluidic channels are being investigated for prototype development, each having advantages and disadvantages. The most well-established method is based on molding microchannels in PDMS [Xia, Y., and Whitesides, G M (1998), “Soft Lithography”, Angew Chem Int Edit 37: 550-575], in which a thick photoresist, such as SU-8, is used as an inverted master. Microchannels with thicknesses of approximately 10 μm-50 μm will be bonded to the microfabricated silicon substrate using a plasma asher to introduce reactive oxide groups on the PDMS and substrate, which results in a strong permanent bond when the surfaces are placed in contact. The main challenge in this approach is to align the microchannels with respect to the microfabricated substrate with 5 μm resolution or better. Due to the short time window for bonding the PDMS to the substrate after plasma treatment, this approach may induce problems in the weak adherence of microchannels to the substrate.

An alternative strategy is to use SU-8 photoresist itself to define the microchannels, and then bond a PDMS lid to form the microchannels. This approach will have better spatial resolution; however, past research has shown that direct bonding of PDMS to SU-8 can be difficult [Gajasinghe R, et al. (2014), “Experimental Study of PDMS Bonding to Various Substrates for Monolithic Microfluidic Applications”, J Micromech Microeng 24: 075010; Patel J N, et al. (2013), “SU-8- and PDMS-based Hybrid Fabrication Technology for Combination of Permanently Bonded Flexible and Rigid Features on a Single Device”, J Micromech Microeng 23: 065029; Yeh P Y, et al. (2012), “Nonfouling Hydrophilic Poly(ethylene glycol) Engraftment Strategy for PDMS/SU-8 Heterogeneous Microfluidic Devices”, Langmuir 28: 16227-16236; Zhang Z Y, et al. (2011), “Sealing SU-8 Microfluidic Channels Using PDMS”, Biomicrofluidics 5: 046503]. To overcome this weak bonding association, atomic layer deposition (ALD) can be used to conformally coat the SU-8 microchannels with an Al₂O₃ layer. The oxide groups of this deposited Al₂O₃ layer can be modified to promote strong adhesion to PDMS using the plasma treatment described above. It is also possible to directly modify the SU-8 to enable strong adherent bonding with PDMS by exposing it to a strong acid, ozone, oxygen plasma, an amine terminated polymer, such as (3-aminopropyl)triethoxysilane. Once the microchannels are formed, a biopsy punch or other suitable hole-forming technique may be used to create the fluidic connections. An Elvesys® flow controller (Elveflow, Paris, France) will then be used to apply programmable pressure (0-2000 mbar) to induce reproducible fluid flow in the microfluidic circuits.

The cell organization procedure starts by selecting an optimal concentration of magnetized cells for microfluidic introduction into the array. Cells are introduced to the microchannels and the flow stopped to assess the cell density in the flow channels (Step 1, FIG. 29). The ideal concentration is 1-2 cells per microchamber, thereby balancing the need for rapid passive population of the array with minimal error correction required to form the single cell array. These conditions ensure that, after magnetic sorting with all transistors turned ON, most chambers will contain at least one cell.

A unique feature of this magnetic sorting apparatus is the ability to control cell positions with micron spatial resolution (FIGS. 28 and 29). The cells are moved by two disks during each cycle of the rotating field, thus it will take ˜10 field cycles to sort all cells into array (Step 2, FIG. 29). Assuming a clock cycle of 0.1-1.0 Hz, single cell arrays can be organized within a few minutes, regardless of array size.

After the magnetic sorting step, some assembly errors will require correction (Step 3, FIG. 29). Image analysis and cell tracking algorithms will automatically identify the number of cells in each microchamber. Cases of dual occupancy will be automatically corrected by removing excess cells with the transistor switches, controlled by software modules. This error correction procedure takes advantage of the spatiotemporal control of magnetophoretic transistors, which can selectively export specific cells in the microchambers by timing the current pulse in the gate electrodes. Finally, the excess cells will be removed with the microfluidic flow controllers, leading to a uniform array of single cells (Step 4, FIG. 29). At this point the magnetic field can be removed, or alternatively a static magnetic field can be applied to retain cells in the microchambers. In principle, this cell arraying process may be repeated to form single cell pairs or sets of cells comprising larger numbers of cells; however, a primary goal of the present development work is to form and sense the secretion patterns in single cell arrays.

Cell Labeling Methods:

Cells may be magnetically-labeled using any of a variety of techniques known to those of skill in the art. For example, human donor CD4⁺ and CD8⁺ T-cells may be magnetically-labeled by conjugating them to antibody labeled magnetic nanoparticles (StemCell Technologies, Vancouver, Canada). In this case, any of a number of T cell subset markers, such as CD3, CD4 and/or CD8, may be used as the antigen for antibody-based labeling. Optimization of the cell separation and labeling conditions may be used to determine the optimal concentrations needed to perform cell manipulations on the disclosed cell sorting platforms.

Cell Incubation & Monitoring in Sorted Arrays:

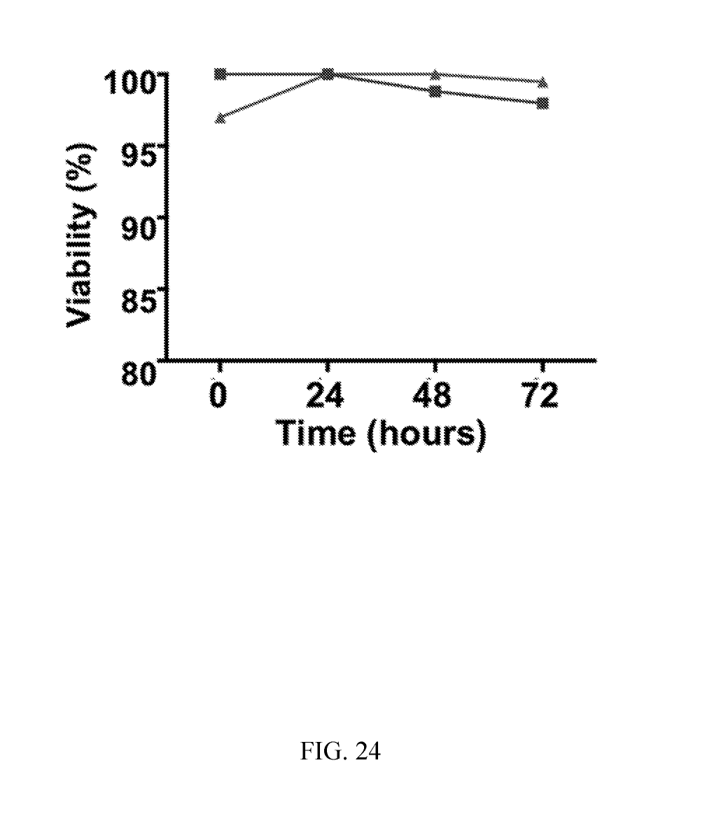

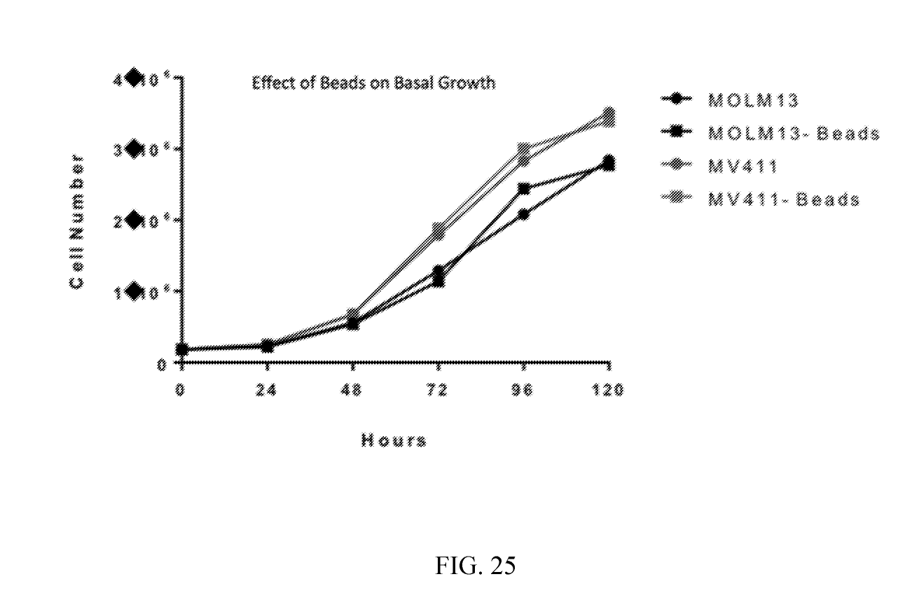

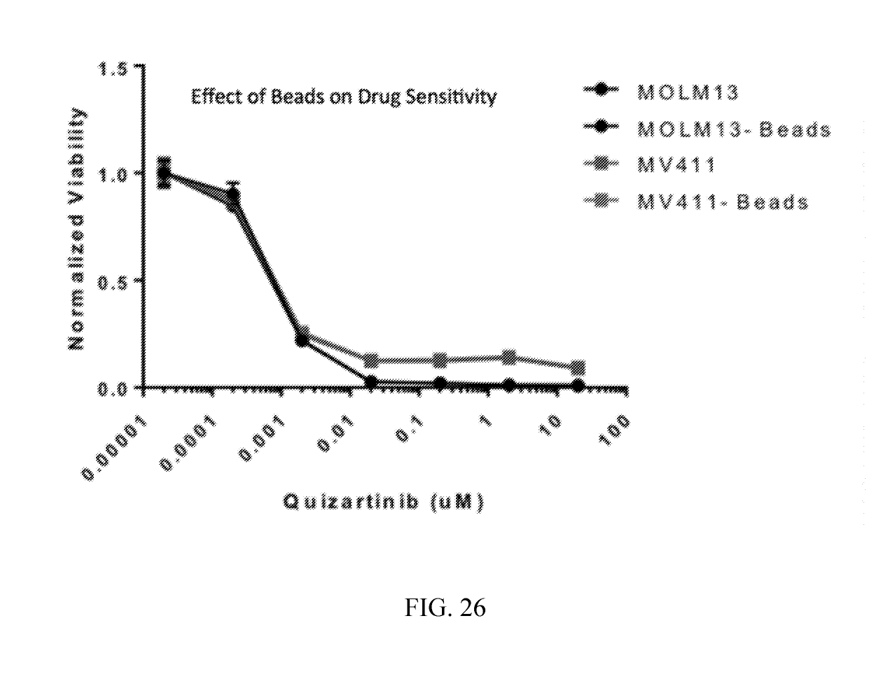

Temperature and gas control systems may be optimized to maintain the arrayed cells for extended periods of time (e.g., days) to accommodate a range of potential biological applications. In some embodiments, temperature control elements (e.g. resistive heating elements) may be integrated into the microfluidic chambers (e.g., PDMS chambers). Cell culture media, housed in a suitable incubator (e.g., a Galaxy S14 incubator (Eppendorf NA)) at, for example, 37° C. and 5% CO₂, may be continuously pumped into the incubator in order to allow cells to exchange gas and receive nutrients. At several time points (e.g., 0, 12, 24, 48, and 72 hours), Cytox cell staining dye or another suitable indicator may be introduced into the microfluidic chambers in order to conduct live/dead viability assays. Operating parameters and cell culture conditions may be adjusted as needed to maintain the correct cell culture environment for the application at hand. Imaging system software may be used to control motorized translation stage(s), filter wheels and shutters, exposure time(s), and auto-focusing in order to create a series of images (or videos) of each cell in the array at user-specified time intervals (or frame rates) of, for example, approximately 1 image every 5 minutes. Cell morphology and motility studies may be conducted by post-processing the acquired images or video using image tracking software. FIG. 24 illustrates data for preliminary cell viability studies conducted in sealed PDMS chambers maintained at 37° C., with gas exchange mediated by diffusion of CO₂ through the PDMS membrane. Short-term incubator studies indicate that cells remain viable past 24 hours. Viability was assessed with Cytox staining kit at 6-hour intervals. FIGS. 25 and 26 illustrate cell viability and drug response data for cells that are unlabeled, or that are labeled with magnetic nanoparticles. The data indicate the labeling process has no negative impact on cell viability or sensitivity.

Cell Sorting Data Analysis:

Data from single cell sorting studies may be analyzed using any of a variety of techniques known to those of skill in the art, e.g., graphically using relationships such as: 1) single cell placement efficiency vs. cell concentration, 2) single cell placement efficiency after error correction; 3) viability of arrayed cells vs. time; and 4) single cell motility measurements in arrayed microchambers as a function of the applied static magnetic field. These types of measurements will allow optimization of the sorting platform for, e.g., the placement and calibration of cytokine sensing beads in the array.

Organizing Multiple Cytokine Sensing Beads into Microchambers, and Calibration of Sensors:

Proof-of-principle experiments (FIG. 19) have demonstrated the ability to form small arrays of beads. In some embodiments, the sorting platforms of the present disclosure may be used to assemble at least 4 different cytokine sensing beads into each microchamber containing single cells. Magnetic beads may be purchased from a variety of vendors (e.g., Thermo Fischer, Millipore, Biorad, etc.). Luminex beads are ideal for some sorting applications, since they are color-coded with controlled ratios of red and infrared fluorescent dyes, which are incorporated into magnetically doped polymers. The magnetic properties may be leveraged for magnetic organization into the arrays, while the fluorescent dyes may be used to decode the beads and determine the surface-functionalized cytokine sensing antigens. For example, Thermo Fischer (Waltham, Mass.) sells multiplexed Luminex xMAP® immuno-assays, which can detect from 3 to 30 different cytokines and growth factors.

As an example of the use of the disclosed sorting platforms, a first set of experiments will involve the placement of a set of cytokine sensing beads in each microchamber, where the sorting procedure is optimized for a providing a specific immune type sensing panel. Cytokine, chemokine, or growth factor sensors may be selected from the list including, but not limited to, IL-2, IL-4, IL-5, IL-10, IL-13, IFN-γ, TNF-α and TNF-β, a member of the transforming growth factor beta superfamily including TGF-β1, TGF-β2, and TGF-β3, epithelial growth factor (EGF), hepatocyte growth factor (HGF), vascular endothelial growth factors (VEGF family), a member of the platelet derived growth factor (PDGF) family, fibroblast growth factor (FGF). Each set of magnetic beads will be assembled one at a time using the methodology illustrated in FIGS. 28 and 29. The error correction step is not necessary for these experiments, since there is no disadvantage to having more than one bead of each type in the array. After organizing the 4 sets of bead sensors in the array, the growth medium may be spiked with known levels of cytokines, and the cytokines subsequently detected with fluorescent antigens in sandwich assays. Well-established protocols may be used for these types of calibration experiments. Each cytokine sensor may be independently calibrated to obtain sensitivity curves as a function of the spiked cytokine concentrations. Calibration tests may be conducted in 96 well plates, and compared with corollary experiments conducted in the microfluidic assay. After the sensitivity curve for each cytokine is established, the experiments may be repeated in cytokine mixtures in order to determine the effects of cross-signaling and other forms of interference.

Integrating Microfluidic Valves:

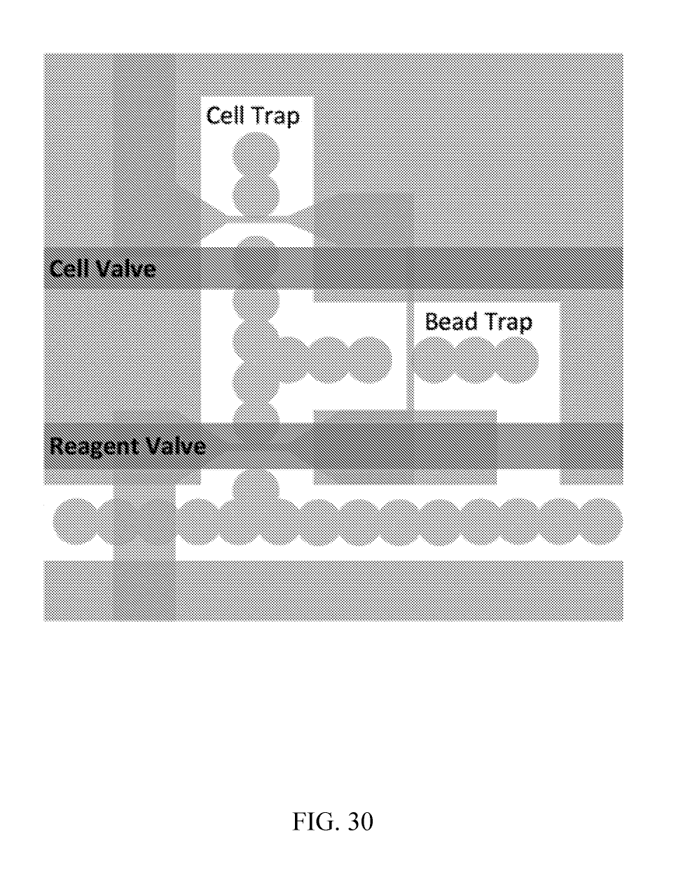

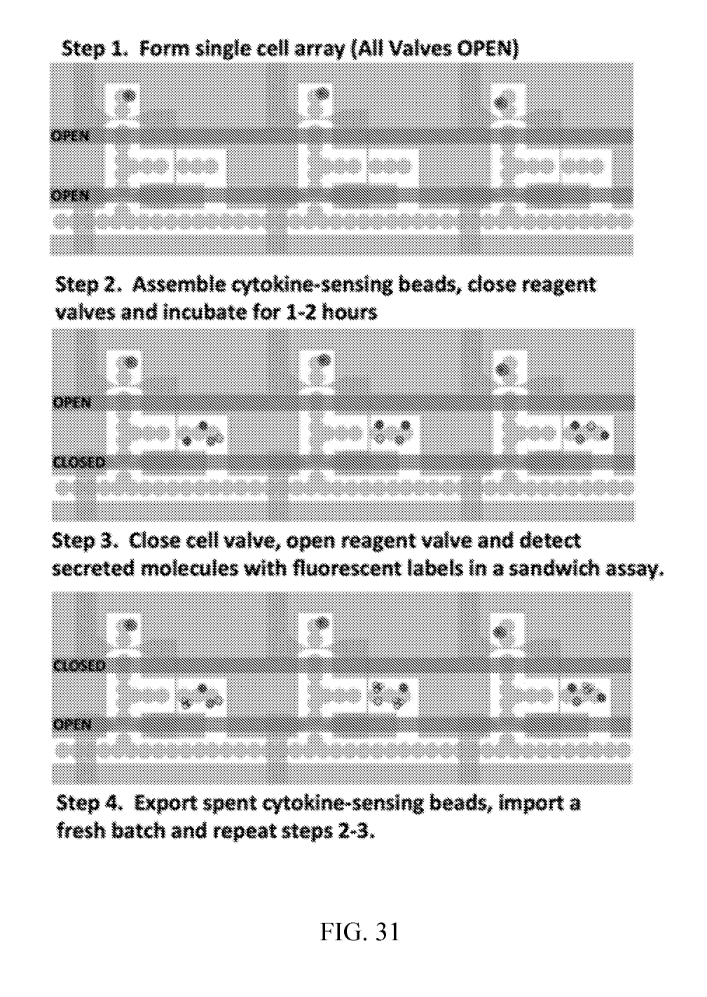

To better control the cell microenvironment and its exposure to cytokine sensing beads, microfluidic valves may be integrated with each microchamber. FIGS. 30 and 31 provide an illustration of one suitable valve structure design that includes valves that can perform both microfluidic isolation of cells and reagents. For example, cell secretions may be captured by cytokine sensing beads when the cell valve is open and the reagent valve is closed. Subsequently, the cell valve may be closed and the reagent valve opened to perform the sandwich assay and detect molecules adhered to the cytokine sensing beads.

Microfluidic valves may be fabricated using any of a number of valve designs and fabrication techniques known to those of skill in the art, for example, the Quake-style microvalve architectures [Frimat J P, et al. (2011), “A Microfluidic Array with Cellular Valving for Single Cell Co-Culture”, Lab Chip 11: 231-237; Fu A Y, et al. (2002), “An Integrated Microfabricated Cell Sorter”, Anal Chem 74: 2451-2457; Unger M A, et al. (2000), “Monolithic Microfabricated Valves and Pumps by Multilayer Soft Lithography”, Science 288: 113-116]. The latter approach forms hollow microchannels in a thin PDMS membrane, which are controllably deformed when static pressure is applied and thereby obstruct fluid flow. Microchannels may be fabricated, for example, in 50 μm thick SU-8 and bonded to a 30 μm thick PDMS membrane lid. In order to control gas exchange, the valves may be actuated with a humidified 5% CO₂ gas mixture, which is known to diffuse through PDMS and therefore provides an additional mechanism to maintain the correct cell culture conditions.

In one embodiment of the disclosed sorting platform, an Elvesys (Elveflow, Paris, France) microfluidic flow controller may control up to 16 different microfluidic valves. Combined with 72 independent current controllers, it is possible to organize and control the microenvironments of 576 single cells. Incorporation of additional flow switch matrices in the microfluidic flow controller can be used to implement larger single cell arrays.

Organizing Single Cells and Cytokine Sensing Beads in Each Microchambers:

To demonstrate the ability to assemble single cells and 4 different cytokine sensors into the respective individual microchambers, single cells will first be assembled in the cell traps of each microchamber using the methodology described in FIGS. 28 and 29. Next, the first set of Luminex cytokine sensing beads will be introduced into the bead traps using the methodology described in FIGS. 30 and 31. This step will be repeated three more times, each with a different cytokine sensing bead, in order to assemble at least 4 different cytokine sensors in each microchamber. Serial placement of the beads may be used to demonstrate “proof of principle” without requiring complicated automation algorithms based on real-time image detection. In some embodiments of the disclosed sorting platform, control software will be used to automate the introduction of a pre-mixed suspension of cytokine sensing beads. After the assembly step, the identities of these beads would be determined by analyzing the ratio of the fluorescence of two different dyes contained within these beads. This approach would thereby optimize the speed and efficiency for introducing cytokine-sensing beads to the array.

Cytokine Sensing Data Analysis:

Data from cytokine sensing studies may be analyzed using any of a variety of techniques known to those of skill in the art, e.g., graphically using relationships such as: 1) fluorescent bead signal vs. spiked cytokine concentration; 2) bead placement efficiency in each microchamber; 3) viability of arrayed cells vs. time. Such studies may set the stage for measuring the secretion patterns of large arrays of single cells following exposure to different stimulation conditions.

Assessing Single Cell Secretion Patterns:

As a non-limiting example of the utility of the disclosed sorting platforms, naïve CD4⁺ cells from patient donors will be magnetically isolated and used to characterize the cytokine secretion profiles of single cells. Following high purity isolation (>99%), naïve CD4⁺ cells will undergo differential Th1 or Th2 polarization, as previously described [Blom L, et al. (2013), “In vitro Th1 and Th2 Cell Polarization is Severely Influenced by the Initial Ratio of Naïve and Memory CD4+ T cells”, J Immunol Methods 397: 55-60]. Selective in vitro polarization will allow testing of the system's ability to detect an anticipated cytokine profile in a control setting based on human T cells (i.e. the release of IFN-γ, IL-2 for Th1 cells, or the release of IL-4, and IL-5 for Th2 cells). Isolated, polarized naïve CD4 cells will then be organized in single cell array format alongside the cytokine sensing beads. Thereafter, the chip will be uniformly stimulated with PMA and ionomycin at different concentrations and exposure durations, followed by rinsing for 10 minutes with fresh cell culture media. Post stimulation, the reagent valves will be closed for 1 hour in order to allow the cell's secreted molecules to diffuse within the microchambers and associate with the cytokine sensing beads. After the 1-hour incubation period, the cell valve will then be closed and the reagent valve opened to allow for the introduction of fluorescent detection antigens in each microchamber. The fluorescent signals from all beads will be detected with automatic stage translations and image capture, based on imaging system software. Finally, the system will be rinsed for 10 minutes with fresh media, and this process will be repeated.

The rationale for performing in situ detection of labeled cytokines comes from the ability to observe temporal fluctuations in the secreted cytokine patterns of each cell. For example, one may initially observe significant secretion of only one cytokine (e.g., IFN-γ) within the first hour, however in subsequent time periods other cytokines may be secreted due to the autocrine response. This ability to query the sensors at multiple time points in automated format will provide a powerful tool for probing the kinetics of cellular secretion patterns. However, the inherent limitation of this sensing strategy is that the captured cytokines are permanently bound to the beads. One thus requires the capability to remove spent cytokine sensors need and replace them with a fresh batch in order to detect the ebb of cytokine secretion patterns.

Removal of Spent Cytokine Sensing Beads and Replacement:

One of the main advantages of using mobile sensors is the ability to replace spent sensors on demand. Simultaneous activation of the magnetophoretic “transistors” in all compartments may be used to facilitate removal of the spent cytokine bead sensors. The successful removal of the 6 μm diameter Luminex cytokine sensing beads may be assessed with automated image analysis. The microscope stage may be raster-scanned to compile overlaid fluorescent and bright-field images at each position in the array. If some cytokine sensing beads cannot be removed from the microchambers due to non-specific adhesion, the bound beads may be catalogued and omit them from subsequent analyses. Next, the cytokine bead sensors may be sequentially introduced in the manner described in FIGS. 30 and 31 in order to repopulate the array with fresh cytokine sensing beads. In some embodiments, the time required to remove and replace beads in the microchambers may be less than 30 minutes. Using a 60-120 minute incubation period for cytokine elution (Step 2, FIG. 31), a sensing cycle may be performed approximately once every 2 hours. This process may be repeated multiple times, e.g. in 12-hour studies, to provide high-resolution longitudinal information about cell secretion patterns.

Single Cell Secretion Pattern Data Analysis:

The data from single cell secretion studies may be analyzed by any of a variety of techniques known to those of skill in the art, e.g. graphically by means of, e.g., 1) heat maps depicting heterogeneity among the secretion patterns of single cells, which may be used to characterize the diversity of T cell subsets in patient samples; 2) the kinetics of the secretion patterns of individual cells, i.e., plots of cytokine concentrations as a function of time; and 3) plots of the relationships between the cell secretion patterns and the stimulation conditions.

Beyond the parallel detection of secreted cytokines from single cells, an important advantage of this cell sorting platform is its flexibility to add modules, which can provide ever more information about cellular interactions. For example, the platform's ability to organize N different objects in each microchamber, as compared to the single object capability of the FLUIDIGM platform (e.g., a single cell), may be used to form single cell pairs and even small communities of cells to better reflect the environmental and cellular interactions of native tissue.

Another important feature of the disclosed ell sorting platform is its capability to retrieve and export specific single cells for follow-on genetic analysis, clonal expansion, or immortalization. At present, no existing single cell platform is able to automate the large-scale analysis of both the function and gene expression profile of single cells. The ability to identify correlations between cell function and gene expression may yield tremendous insights for drug discovery purposes and the identification of behavioral phenotypes that are predictors of epigenetic regulatory processes.

Finally, not limited to sensing just a handful of cytokines, the platform can be readily be extended to detect more than 50 different cytokines, chemokines, and growth factors eluted from single cells with existing Luminex bead kits. Compared to the photolithographically-fabricated cytokine sensors of the DEAL and microengraving approaches [Ma C, et al. (2011), “A Clinical Microchip for Evaluation of Single Immune Cells Reveals High Functional Heterogeneity in Phenotypically Similar T cells”, Nat Med 17: 738-U133; Vermesh U, et al. (2011), “High-Density, Multiplexed Patterning of Cells at Single-Cell Resolution for Tissue Engineering and Other Applications”, Angew Chem Int Edit 50: 7378-7380; Fan R, et al. (2008), “Integrated Barcode Chips for Rapid, Multiplexed Analysis of Proteins in Microliter Quantities of Blood”, Nat Biotechnol 26: 1373-1378; Xue Q, et al. (2015), “Analysis of Single-Cell Cytokine Secretion Reveals a Role for Paracrine Signaling in Coordinating Macrophage Responses to TLR4 Stimulation”, Sci Signal 8: ra59; Lu Y, et al. (2015), “Highly Multiplexed Profiling of Single-Cell Effector Functions Reveals Deep Functional Heterogeneity in Response to Pathogenic Ligands”, PNAS 112: E607-E615.; Lu Y, et al. (2013), “High-Throughput Secretohimic Analysis of Single Cells to Assess Functional Cellular Heterogeneity”, Anal Chem 85: 2548-2556; Han Q, et al. (2012), “Polyfunctional Responses by Human T Cells Result from Sequential Release of Cytokines”, PNAS 109: 1607-1612; Varadarajan N, et al. (2012), “Rapid, Efficient Functional Characterization and Recovery of HIV-specific Human CD8(+) T Cells Using Microengraving”, PNAS 109: 3885-3890; Yamanaka Y J, et al. (2012), “Cellular Barcodes for Efficiently Profiling Single-Cell Secretory Responses by Microengraving”, Anal Chem 84: 10531-10536; Varadarajan N, et al. (2011), “A High-Throughput Single-Cell Analysis of Human CD8(+) T Cell Functions Reveals Discordance for Cytokine Secretion and Cytolysis”, J Clin Invest 121: 4322-4331; Han Q, et al. (2010), “Multidimensional Analysis of the Frequencies and Rates of Cytokine Secretion from Single Cells by Quantitative Microengraving”, Lab Chip 10: 1391-1400], which have typical spot sizes on the order of 20-50 μm, the small size of bead based sensors (3-5 μm diameter) permits a much larger number of sensors to be placed in each microchamber. This 100-fold increase in sensor density may allow the reaction volumes to be further miniaturized and assay sensitivity to be further improved.

### Example 4. Transcriptomic Effect of Magnetic Labeling on Single Cells

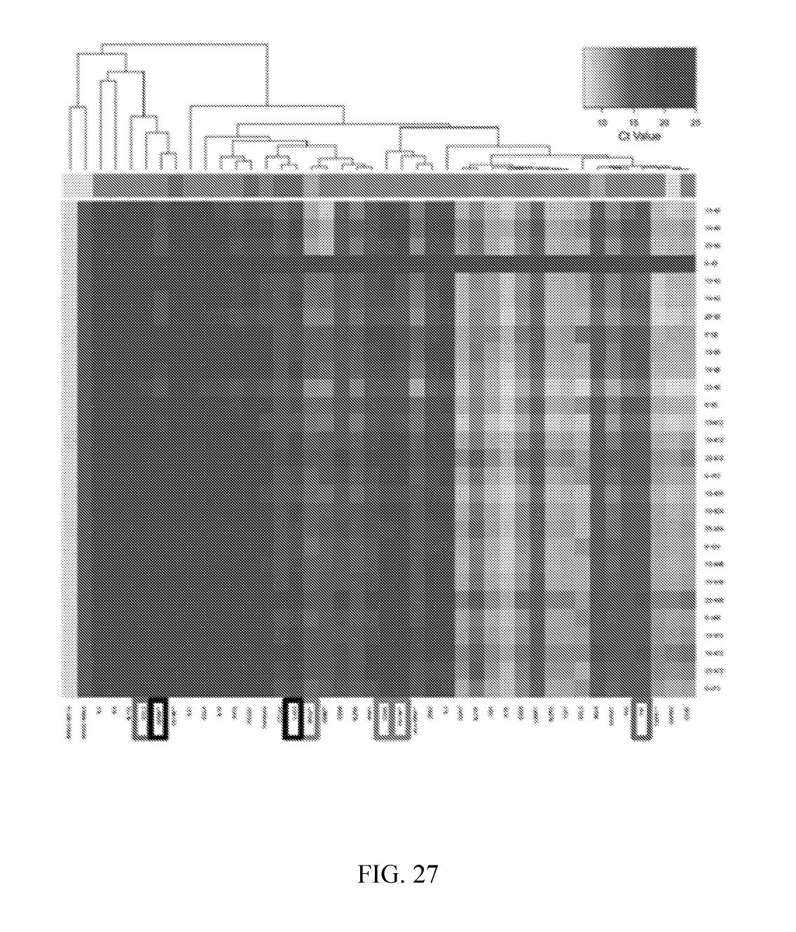

Preliminary experiments were conducted to determine the effect of magnetic labeling on single cell transcription profiles using the FLUIDIGM system with the objective of understanding the time-dependent transcriptional processes that are up-regulated when magnetic nanoparticles bind to the CD4⁺ receptors of human T cells (FIG. 27). The results indicate that magnetic labeling of CD4⁺ T cells induces significant changes in expression of only 7 genes. Importantly, all of these genes demonstrated decreases in expression over time, indicating that magnetic nanoparticles do not significantly induce T cell activation past 72 hours. These preliminary data support the approach of using specific T cell surface markers for magnetic labeling and are consistent with nanoparticle/cell interaction observations [Cheng L, et al. (2011), “In vivo Pharmacokinetics, Long-term Biodistribution and Toxicology Study of Functionalized Upconversion Nanoparticles in Mice”, Nanomedicine 6: 1327-1340; Beliakova-Bethell N, et al. (2014), “The Effect of Cell Subset Isolation Method on Gene Expression in Leukocytes”, Cytom Part A 85: 94-104]. Thus, the preliminary results suggest that the magnetic platform has the unique potential to program the arrangement of single cells and cell pairs to measure real-time functional immune responses.

### Example 5—Magnetophoretic Transistors in a 3-Dimensional Magnetic Field

Several types of magnetophoretic transistors have demonstrated the ability to switch single cells and beads between different paths in a microfluidic chamber. The semiconducting transistor junction is achieved by creating a small gap between two magnetic tracks fabricated in a thin permalloy film with an overlaid microwire pattern serving as the gate electrode. A tri-axial time-varying magnetic field superimposed on the field of the patterned permalloy film creates a translating potential energy landscape, which transports magnetic objects (i.e., magnetic beads or magnetically labeled cells) at a uniform rate along pathways defined by the magnetic track geometry. When the magnetic objects arrive at the semiconducting junction, the competing magnetic field from the microwire transforms the gap from an insulating to a conducting state, allowing the magnetic objects to cross the gap only when the gate electrode is energized. Several types of transistor geometries have been tested, which function by either presenting a local energy barrier or by repelling magnetic objects away from a given track, hereby denoted as “barrier” and “repulsion” transistors, respectively. For both types of transistors, complete switching of magnetic objects across the gap is observed with gate currents of ˜40 mA. These switching thresholds are found to have only weak dependence on particle size, magnetic field strength, and the frequency of the time-varying field.

The first integrated circuits were designed to operate with an in-plane rotating magnetic field, which had some undesirable features that impeded system performance, including the tendency to form bead and cell clumps [B. Lim, et al. (2014), “Magnetophoretic Circuits for Digital Control of Single Particles and Cells”, Nature Communications, vol. 5, p. 3846]. To overcome this problem, an alternative approach for transporting magnetic objects in a conical magnetic field (i.e., an in-plane rotating magnetic field superimposed with a static vertical field) [R. Abedini-Nassab, et al. (2016), “Magnetophoretic Conductors and Diodes in a 3D Magnetic Field,” Adv. Func. Mater., 26, 4026-4034] was recently developed. The inclusion of a vertical field bias is advantageous for inducing dipole-dipole repulsion between the magnetic objects, which reduces the tendency to form particle clumps. The presence of the vertical field, however, required a complete re-design of the magnetic track structure to achieve rectified particle transport [R. Abedini-Nassab, et al. (2016), “Magnetophoretic Conductors and Diodes in a 3D Magnetic Field,” Adv. Func. Mater., 26, 4026-4034].

In this example, a variety of transistor geometries were designed and tested for their capability of switching magnetic beads and magnetically labeled single cells in between two drop-shaped magnetic tracks separated by a small gap. Theswitching behavior of magnetically labeled cells and magnetic beads of two different sizes was investigated, along with the effect of frequency, field strength, and cone angle (i.e., the angle between the total external field and the axis perpendicular to the chip surface) of the applied field on the switching property of these transistor junctions.

Experimental Methods:

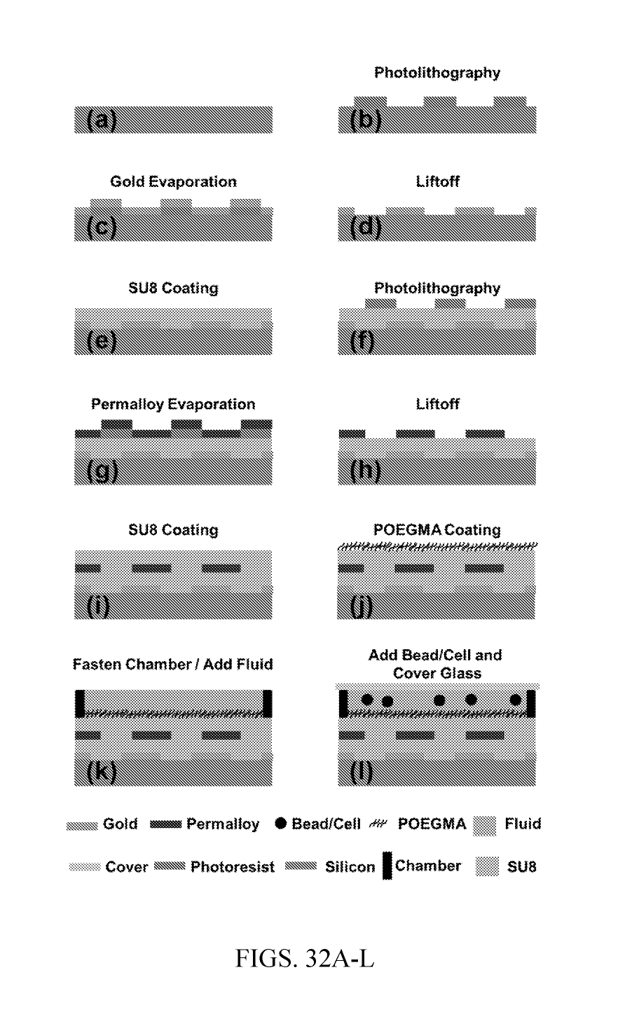

A detailed fabrication process is explained elsewhere [R. Abedini-Nassab, et al. (2016), “Magnetophoretic Conductors and Diodes in a 3D Magnetic Field”, Adv. Func. Mater., 26, 4026-4034], but in brief, aligned patterns of magnetic and metallic thin films were fabricated on silicon wafers (University Wafer, Boston, Mass.) by conventional photolithographic liftoff process (Karl Suss MA6 mask aligner) using NFR16D2 negative photoresist. The metal layers were deposited by electron beam evaporation (Kurt Lesker, PVD 75), in which the metallic pattern consisted of a 5 nm/100 nm stack of Ti/Au, while the magnetic patterns consisted of 100 nm thick Ni80Fe20 film. The remaining photoresist was stripped with 1165 photoresist remover at 65° C. In between the metallic and magnetic layers, a 300 nm thick layer of SU8 photoresist was applied to achieve electrical insulation. This ultrathin SU8 layer was created by mixing SU8 3005 with cyclopentanone at controlled ratios (Microchem, Westborough, Mass.). Another SU8 coating was applied on top of the chip in order to provide electrical insulation from the fluid and to establish a uniform surface chemistry for subsequent functionalization with a non-fouling polymer brush layer. Poly(oligo(ethylene glycol) methyl ether methacrylate) (POEGMA) was grown directly on top of the top SU8 layer by atom transfer radical polymerization. Briefly, the SU8 top layer was first conjugated to (3-aminopropyl)triethoxysilane (APTES), in which the amino groups were reacted with the epoxy groups of the SU8. A typical process for growing the 30 nm thick POEGMA brush layer described elsewhere was followed [S. L. Tao, et al. (2007), “Off-Wafer Fabrication and Surface Modification of Asymmetric 3D SU-8 Microparticles”, Nature Protocols, vol. 1, no. 6, pp. 3153-3158]. A schematic of the fabrication procedure is shown in FIGS. 32A-L.

Three types of magnetic beads were used in the transistor test experiments (Spherotech, Lake Forest, Ill., CM-50-10, FCM-8056-2 and CM-150-10, with mean diameters of 5.7 μm, 8.4 μm and 15.6 μm, respectively). The switching capability on human CD4+ T cells was also tested by magnetically labeling the cells with ˜200 nm diameter magnetic nanoparticles conjugated to anti-CD4 antibody (StemCell Technologies, Vancouver, Canada). The cell labeling process followed the vendor suggested protocols. Though it was not possible to quantitatively measure the magnetic nanoparticle coverage on the cell membrane surface, the cells moved reliably at driving frequencies below 0.3 Hz. The cell isolation purity was confirmed using flow cytometry. Experiments on magnetic beads and cells were conducted in de-ionized (DI) water and phosphate-buffered saline (PBS), respectively. The cells and/or beads were deposited onto the chip in a 10 μL drop and covered by a coverslip to create a microscopy-compatible viewing window. In some experiments, a 3D printer was used to fabricate a fluid holder, which was fastened to the chip with silicone glue.

The magnetic fields were produced by a customized apparatus fabricated in an iron plate machined into a four-pole structure, in which each of the arms were wrapped with 1000 turns of magnet wire (20 AWG). The magnetic field apparatus was powered by two programmable power supplies (Kepco BOP 20-5M, Flushing, N.Y.), which were controlled by a high-precision, 8-channel voltage analog output board (DNR-AO-308, United Electronics Industries, Boston, Mass.) and operated with a customized LABVIEW program (National Instrument, Austin, Tex.). This analog output board was also used to supply up to 50 mA currents to the gate electrodes. The magnetic fields were measured with a handheld Model 410 Gaussmeter Hall probe sensor (Lakeshore, Westerville, Ohio). In order to establish the static vertical field bias, another magnetic coil was placed underneath the stage. Electrical contact to the gate electrodes was made with an IC test clip (Ponoma Electronics, Everett, Wash.). The gate electrode currents were measured with a digital multimeter (Extech Ex430, Nashua, N.H.).

A Retiga 2000R video camera mounted on a Leica DM LM microscope was used to record movies and obtain the bead and cell trajectories in a 20× objective. The trajectories of the beads were extracted from the video data using a customized image recognition based in MATLAB (Mathworks, Natick, Mass.). Results obtained on multiple days with different chips were found to be consistent.

Results:

In prior work, the potential energy landscape of a magnetic point dipole was numerically simulated above a drop-shaped magnetic track pattern and exposed to a conical time-varying magnetic field [R. Abedini-Nassab, et al. (2016), “Magnetophoretic Conductors and Diodes in a 3D Magnetic Field”, Adv. Func. Mater., 26, 4026-4034]. For a spatially periodic magnetic track pattern having both positive and negative curvature, it has been demonstrated that rectified particle transport along the track axis can be achieved for a specific range of cone angles between 300-600. The basic transport mechanism relies on symmetry breaking during two distinct intervals of motion, corresponding to the alternating sections of positive and negative curvature. The first interval of motion involves smooth translation of the particle around the section of positive (convex) curvature, which occurs when the external field has an in-plane component that is parallel to the outward normal of the substrate curvature. The second interval of motion involves a sudden jump between two curvature inflection points, which occurs when the in-plane field component is anti-parallel to the outward normal of the substrate curvature. For each cycle of the time-varying conical field, the particle moves by one array period. Due to the linear relationship between the bead velocity and the driving frequency of the rotating field, the particle motion behaves analogously to Ohm's law for electrical circuits. In previous work, it has been shown that both bi-directional and uni-directional motion can be achieved by adjusting the symmetry of the magnetic track shape. However, no prior attempts have been made to implement transistor functionality in a conical magnetic field.

This system considers two drop-shape magnetic track patterns positioned in near proximity, wherein the ability of different micro-wire geometries (i.e., transistors) to switch magnetic particles between the two magnetic tracks was tested. The goal of this work was to identify a few effective transistor geometries, and analyze the switching thresholds as a function of experimental control parameters, including external field strength, cone angle, bead size, and frequency of the driving field. Of the many tested transistor geometries, only a few geometries that enabled high efficiency switching with the lowest possible currents are presented. These can be broadly classify in two general categories.

The first transistor category, which hereafter “barrier transistors” is used to denote the use of a small current loop to induce a local magnetic energy barrier when the particle reaches the transistor junction. Switching is observed only when the gate current within the loop produces a magnetic field that is parallel to the vertical component of the external field. The local energy minimum established by the current loop causes the particle to become momentarily trapped, after which the particle's location becomes out-of-phase with the traveling potential energy landscape of the first track. When the nearby energy minima of the opposite track arrives at the junction, the particle then resumes its path along the second track, but in the opposite direction.

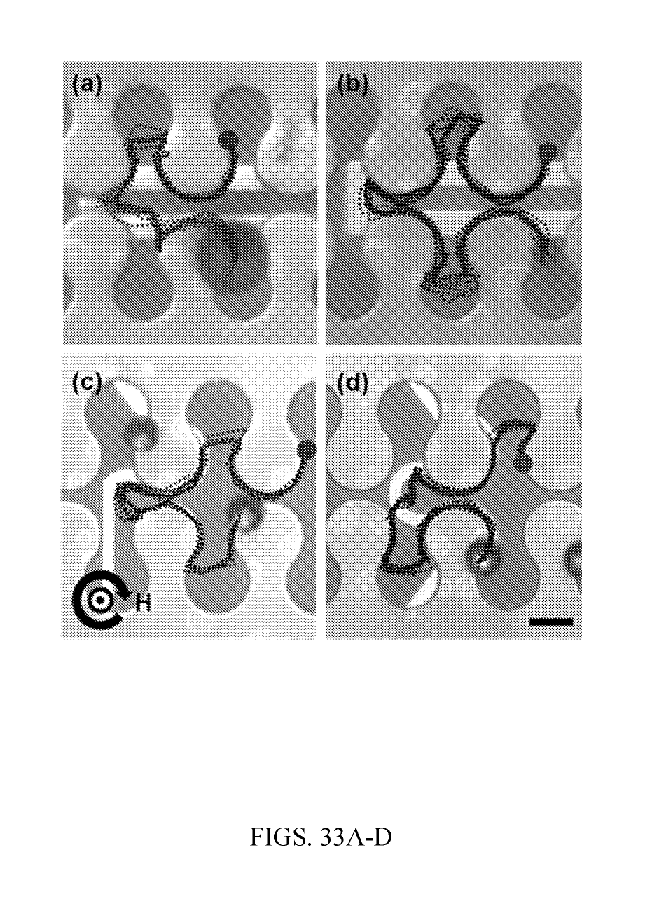

Some representative particle motions are depicted in FIGS. 33A-D, which present the overlaid trajectories (dotted lines) often magnetic beads. For these experiments, the field strength was fixed at 70 Oe, cone angle at 450, driving frequency of 0.1 Hz, and transistor gate currents of 35-45 mA. Switching was achieved by manually turning on the gate current when the particle arrived at the junction. The particle trajectories depicted in FIGS. 33A-D are consistent regardless of the size of the particle.

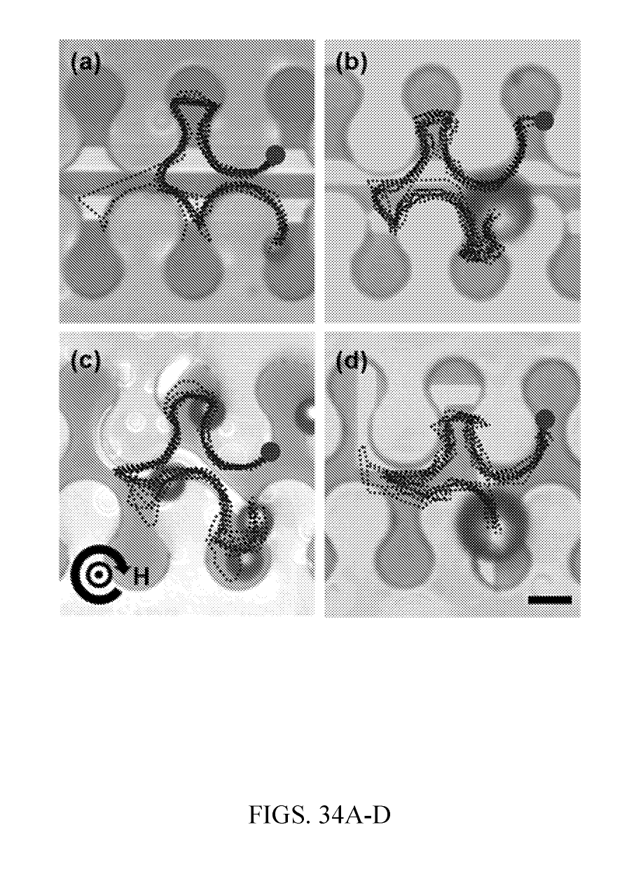

For ease of discussion, a second category of transistors, hereafter denoted as “repulsion transistors”, is also defined, which are based on straight (or slightly curved) gate currents aligned parallel to the track direction. Here, the switching mechanism is based on supplying gate currents that produce an in-plane field component, which is anti-parallel to the in-plane component of the external field. The local reduction in field strength causes the particle to be repelled away from the current magnetic track and attracted towards a nearby magnetic track, thus completing the switching process. In some cases, a two-wire geometry was employed, in which anti-parallel currents are used both to repel the bead from one side and attract the bead to the other side of the transistor junction (FIGS. 34A-B). Due to closer proximity to the first wire, the repulsion is always stronger than the attraction by the wire that on the opposite side of the junction. One-wire configurations (FIGS. 34C-D) could also achieve particle switching, but only in the repulsive direction, as the attractive force from the opposite wire was insufficient to significantly alter the local potential energy landscape.

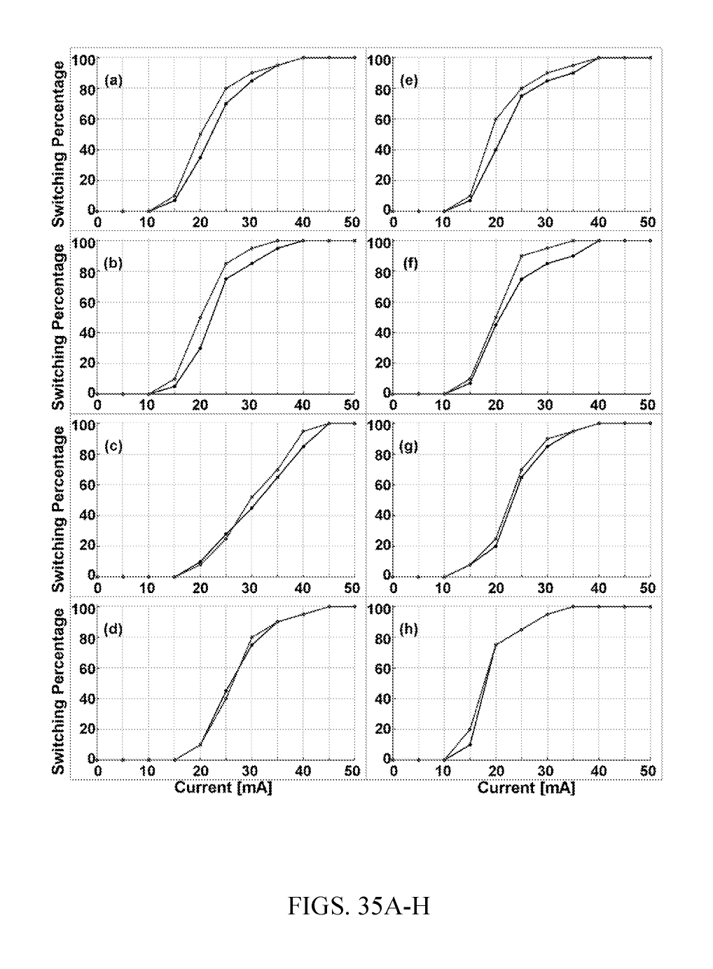

To quantify the switching thresholds of the transistors, the percentage of successful magnetic bead crossings was monitored as a function of the applied gate currents in an externally field consisting of a rotating 50 Oe in-plane component rotating at 0.1 Hz and a 50 Oe vertical component (corresponding to a 450 cone angle). For each transistor, the trajectory of at least ten magnetic beads were measured in order to obtain statistics on the switching reliability. The results for all eight transistors are illustrated in FIGS. 35A-H.

As observed in FIGS. 35A-H, the switching thresholds were relatively similar across the different class of transistors, though it appears that the transistors depicted in FIGS. 33B, 34B, and 34D required slightly lower gate currents to achieve 100% switching efficiency. Based on the lower spread of the trajectories of the transistors depicted in FIGS. 33B and 34B, these were selected for further testing of different experimental conditions.

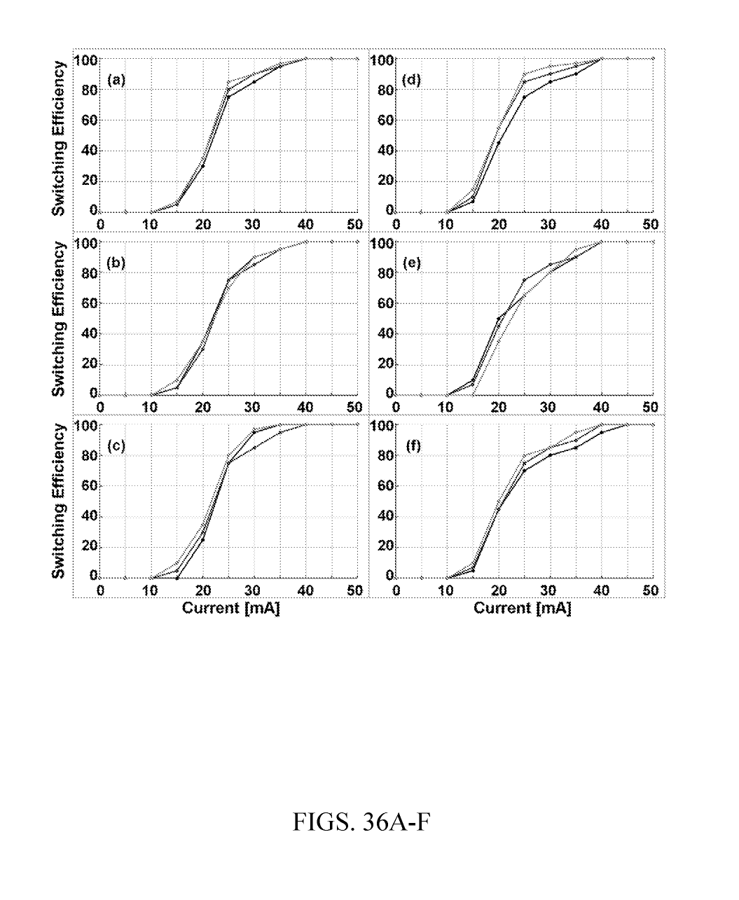

The switching efficiency for the two selected transistors are presented in FIGS. 36A-F as a function of the driving frequency (FIGS. 36A, D), field strength (FIGS. 36B, E), and field cone angle (FIGS. 36C, F). For these experiments, only the 8.4-μm diameter magnetic beads were used, and some comparative examples are presented in each of the figure panels. FIGS. 36A-C presents the results for the barrier transistor depicted in FIG. 33B, while FIGS. 36D-F shows similar experiments for the repulsion transistor of FIG. 34B. The switching thresholds only weakly depend on field strengths ranging from 50-90 Oe, cone angles ranging from 370-650, and driving frequencies ranging from 0.1-0.6 Hz.

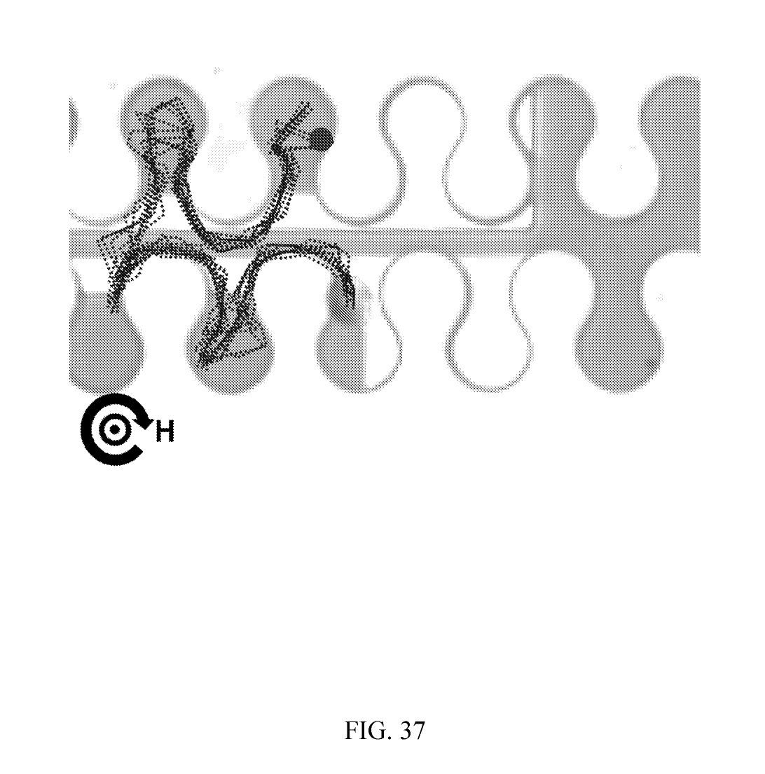

The ability to switch the trajectory of magnetically labeled CD4+ human T cells with these transistor geometries (FIG. 37) has also been demonstrated. The dotted lines present multiple overlaid cell trajectories, which demonstrate the reliability of switching.

Discussion:

Compared with prior work on magnetophoretic circuits in a 2-dimensional in-plane rotating magnetic field, there are a number of advantages for employing a 3-dimensional conical magnetic field to improve the system performance. First and foremost, the constant vertical field bias reduces the attractive force between the beads and cells, which helps to inhibit the formation of particle clusters. This approach operates more similarly to electrical circuits, in which the self-repulsion between individual electrons prevents charge accumulation inside conductors. A second important advantage of the constant vertical field is in breaking the time-symmetry of the rotating field, which reduces the degeneracy of the stable positions with respect to the substrate. This effect is used not just to improve the synchronization of particle motion relative to the global clock cycle, but it also allows two magnetic tracks close to be placed close together without concern about inadvertent switching between the different tracks.

Among the tested transistors, the symmetric geometries (e.g., those in FIGS. 33A, B, D, and 34A, B) are preferable because of their bi-directional switching properties. The barrier transistors of FIG. 33A-D are also preferable to the repulsion transistors of FIG. 34A-D since they require shorter gate currents, which have lower electrical resistance and thus reduce the operating voltages. Finally, the spread of the particle trajectories in the transistors of FIG. 33A-D appear to have tighter overlap compared to the ones shown in FIG. 34A-D, providing further motivation for the use of barrier transistors in future work.

Compared to prior work on transistors designed for 2D in-plane rotating fields, the transistors studied a 3D conical field require higher gate currents to achieve 100% switching. The increase in the required gate current results, in part, from the vertical field bias, which induces greater energy barriers between the different magnetic tracks. However, these transistors also have lower propensity for inadvertent switching of particles between different tracks, and thus provides motivation for further optimizing the geometry to reduce the switching thresholds. Finally, it has been found that the switching properties only weakly depend on the particle size, driving frequency, field strength, and the cone angle of the external field. These findings suggest that the system is robust and insensitive to the operating conditions.

The results complete the demonstration of the complete set of analogous circuit components (conductors, diodes, transistors) required to form hierarchical control architectures enabling the scalable placement of many objects inside microfluidic environments. These particle transport architectures can be designed to operate analogously to computer memory circuits, except where cells and particles are the mobile components as opposed to electrons. The ability to rapidly organize multicomponent patterns of cells and particles can make an important impact in single cell biology by providing new tools that can better characterize static and dynamic cellular signaling, and thereby improve the understanding of the relationship between the function and expression of single cells.

### Example 6—Determining Heterogeneity in the Responses and Signaling Pathways of Single Cancer Cells Exposed to Drugs

As further illustration of different embodiments of the disclosed methods, devices, and systems, a list of non-limiting prophetic examples are provided for the types of single cell interrogations that can be conducted on cancer cells, which are exposed to different amounts and/or combinations of different drugs and placed in the context of different tumor environments.

### Example 6A

Cancer drugs receiving FDA approval still face significant challenges in maintaining effectiveness against the tendency to evolve drug resistance, which emerges naturally in a large fraction of patients. Though the FDA does not explicitly test for drug resistance in clinical trials, focusing instead on upfront effectiveness and safety, the eventual onset of resistance deals a major blow to long-term therapeutic outcomes. As such, the ability to screen early in the drug development process for single and combination therapies that effectively suppress drug resistance could be transformative, enabling the clinical advancement of therapies with maximal durability. However, the existing methods for measuring drug resistance are low-throughput and require months of labor-intensive work, precluding their use during critical early stages of candidate identification. The magnetophoretic array can solve this problem by enabling the rapid assessment of the capacity of cells to become resistant to a drug, identify the signaling pathways associated with resistance, and develop combination therapies that suppress resistance.

Typical drug resistance analyses are based on exposing a population of cancer cells continuously to a drug compound, and tracking the total number of cells over time. When the drug is first applied, the cell population decreases; however, over subsequent months, the drug-resistant cells survive and become enriched [Wood, K C (2015), “Mapping the Pathways of Resistance to Targeted Therapies”, Cancer Research 75: 4247-4251; Winter P S, et al. (2014), “RAS Signaling Promotes Resistance to JAK Inhibitors by Suppressing BAD-mediated Apoptosis”, Science Signaling 7: ra122-ra122; Martz C A, et al. (2014), “Systematic Identification of Signaling Pathways with Potential to Confer Anticancer Drug Resistance”, Science Signaling 7: ra121-ra121]. Drug resistant single cell clones isolated from this pool can be studied in mechanistic detail. In total, however, it takes many months to achieve sufficient numbers of drug resistant clones to conduct follow-on genetic, biochemical, and pharmacological analyses of the various signaling pathways implicated in their resistance [Wood, K C (2015), “Mapping the Pathways of Resistance to Targeted Therapies”, Cancer Research 75: 4247-4251]. Thus, it is generally considered infeasible to use resistance to a targeted therapy as a selection criterion during early stages of drug development, especially when many drug candidates are under consideration.

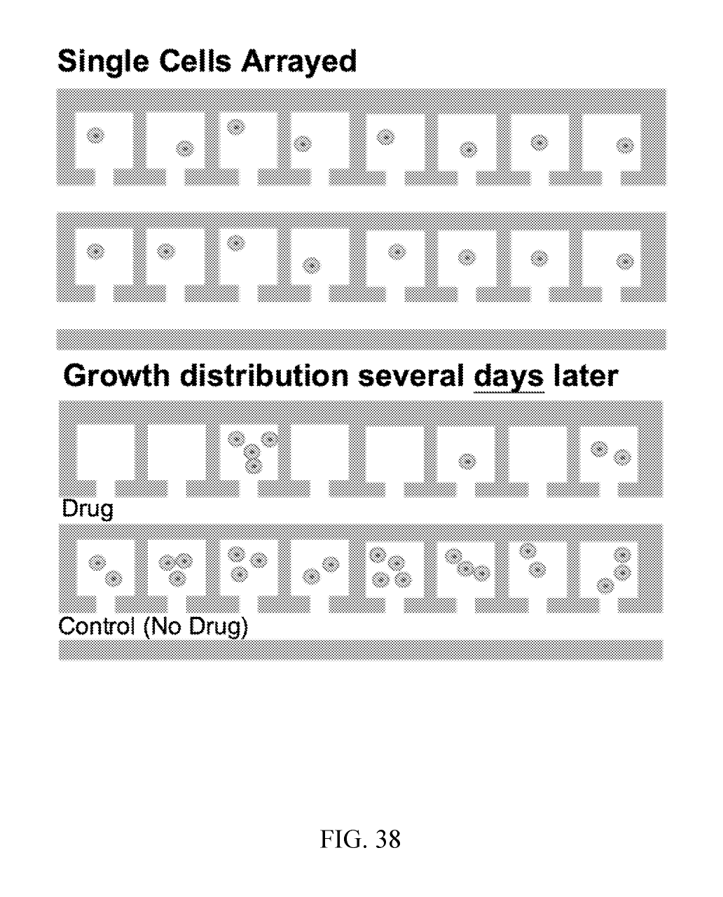

An alternative approach for studying drug resistance is based on organizing tens of thousands (possibly millions) of single cells in the microchambers of a microfluidic device (as illustrated in FIG. 38), facilitating individual measurement of clonal growth rates in the presence of drug treatments via automated microscopy. The advantage of starting each micro-culture from a single cell is the ability to identify the drug resistant clones after only a few cell divisions, thereby compressing the total assay time from months to days. As one specific, but non-limiting example, it is possible to analyze drug resistance in a model amyloid leukemia cell line through the following steps:
(i) Array MV;4-11 cells into individual microchambers, then immediately switch the media to either vehicle (DMSO, 0.1%) or quizartinib, a second-generation, ATP-competitive FLT3 kinase inhibitor, at a series of 5 escalating doses (0.1, 1, 10, 100, and 1000 nM) [Zarrinkar P P, et al. (2009), “AC220 is a Uniquely Potent and Selective Inhibitor of FLT3 for the Treatment of Acute Myeloid Leukemia (AML)”, Blood 114: 2984-2992]. For 7 days, the average and distribution of cell numbers in each microchamber will be determined each day. By normalizing these values to DMSO treatment, it is possible to construct a GI50 curve, comparing directly with the GI50 value observed in analogous bulk culture conditions.
(ii) Use immunofluorescence to identify candidate resistance pathways in the drug resistant colonies. It has been well established that resistance to FLT3 inhibitors in AML can be driven by reactivation of FLT3 (e.g., via gatekeeper resistance mutations like those described above) or through bypass activation of the downstream AKT, ERK, or STAT5 signaling pathways [Weisberg E, et al. (2010), “Drug Resistance in Mutant FLT3-positive AML”, Oncogene 29: 5120-5134; Swords R, Freeman C, Giles F (2012), “Targeting the FMS-like Tyrosine Kinase 3 in Acute Myeloid Leukemia”, Leukemia 26: 2176-2185]. To understand FLT3 inhibitor resistance in clonal populations, the frequencies with which these effector-signaling pathways are activated in resistant cells will be assessed. For example, the demonstration that quizartinib-resistant cells always exhibit FLT3 reactivation would suggest that newer generation FLT3 inhibitors that maintain potency in the presence of quizartinib-resistant gatekeeper mutations may have improved effectiveness against resistance, while the demonstration that quizartinib-resistant cells exhibit ERK pathway activation independent of FLT3 would suggest that combined FLT3 and ERK pathway inhibition may be effective in resistant cells [Smith C C, et al. (2015), “Characterizing and Overriding the Structural Mechanism of the Quizartinib-Resistant FLT3 “Gatekeeper” F691L Mutation with PLX3397”, Cancer Discovery 5: 668-679; Zhang W, et al. (2016), “The Dual MEK/FLT3 Inhibitor E6201 Exerts Cytotoxic Activity against Acute Myeloid Leukemia Cells Harboring Resistance-Conferring FLT3 Mutations”, Cancer Research 76: 1528-1537]. To perform these analyses, single cell-derived colonies of MV (4-11 cells) will be treated with quizartinib (˜10 nM) for 7 days to isolate resistant clones. Next, colonies will be fixed and permeabilized by sequential 30 minute treatments with 3.7% paraformaldehyde (containing Hoeschst nuclear stain) and 0.1% Triton X-100, respectively. Cells will then be treated with fluorophore-labeled primary antibodies against phosphorylated FLT3, AKT, ERK, or STAT5 in parallel experiments (one stain per experiment), then visualized to quantify the fraction of resistant colonies that stain positively for each pathway. Pathways that frequently stain positively in resistant cells will be co-stained in a single microchip experiment conducted as above using fluorophore-labeled antibodies with distinct emission spectra to enable the simultaneous identification of co-occurring resistance pathways. To verify these findings in traditional bulk culture, at least 25 single cell-derived resistant clones will be isolated following selection with quizartinib in bulk culture [Smith C C, et al. (2012), “Validation of ITD Mutations in FLT3 as a Therapeutic Target in Human Acute Myeloid Leukaemia”, Nature 485: 260-263], then perform analyses of the same signaling pathways using immunofluorescence and traditional western blotting.
(iii) Having identified the pathways most likely to mediate resistance to quizartinib from a panel of candidate mechanisms that include FLT3 reactivation and de novo activation of the ERK, AKT, and STAT5 effector pathways, it is then possible to determine whether high-throughput single cell clonal assays can rapidly credential combination therapies targeting these resistance pathways to suppress the emergence of resistance. Specifically, the findings of the immunofluorescence studies will be leveraged to generate testable hypotheses. For example, if these experiments reveal frequent FLT3 reactivation in resistant cells, then the combination of quizartinib with the newest generation FLT3 inhibitor PLX3347 will be tested in order to asses its ability to block multiple quizartinib gatekeeper mutations. By contrast, if the experiments reveal frequent de novo activation of the ERK pathway in resistant cells, then the combination of quizartinib and the ERK inhibitor SCH772984 will be tested, which is currently undergoing clinical evaluation in multiple cancer types. Similar hypotheses concerning the AKT and STAT5 pathways will be tested using the clinical allosteric pan-AKT inhibitor MK2206 and the FDA approved JAK inhibitor Ruxolitinib, respectively. Each hypothesis will be tested by treating cells with the relevant drug combination, then quantifying the distribution of responses relative to the same experiment in quizartinib-only treated cells. Drug combinations that suppress resistance will be identified by their narrower distributions of single cell growth responses relative to quizartinib alone.

In a manner analogous to the quizartinib-FLT3-ITD+ AML example provided above, this concept can be used to identify mechanisms of resistance within a heterogeneous population of cancer cells to virtually any anti-cancer agent, particularly those that act in a cell autonomous fashion. For example, resistance to BRAF and/or MEK inhibition, which is canonically driven by activation of the MAPK and PI3K pathways, can be investigated in BRAF mutant tumors, including those from skin (melanoma), thyroid, colon, and lung, and in KRAS/NRAS mutant tumors, including those from lung, colon, pancreas, skin (melanoma), and other tissues. Resistance to receptor tyrosine kinase (RTK)-targeted therapies, including EGFR inhibitors used in EGFR mutant lung cancers and KRAS/BRAF wild-type colorectal cancers, ALK inhibitors used in ALK mutant lung cancers and neuroblastomas, HER2 inhibitors used in HER2 mutant or amplified breast, lung, and colon cancers, MET inhibitors used in MET amplified or mutant lung and colon cancers, each of which are commonly driven by activation of compensatory RTKs or the MAPK/PI3K/STAT pathways, can be explored in a similar manner. Resistance to anti-estrogens used in ER-driven breast cancers, or anti-androgens used in AR-driven prostate cancers, which can be driven by reactivation of nuclear hormone receptor signaling or compensatory activation of the MAPK, PI3K, and other pathways, can similarly be investigated. As a final example, it is straightforward to imagine using these approaches to investigate resistance to non-specific agents like cytotoxic chemotherapies in an array of diverse cancer types.

### Example 6B

Analysis of drug sensitivity in the context of different tumor microenvironments. It is known that the cellular microenvironment, including its interaction and co-culture with other cells, such as fibroblasts, endothelial cells, macrophages and other immune cells, can have a power influence on the sensitivity of the tumor to drug treatments. Thus, the inventors envision a system in which a small community of cells may be placed together in a microchamber to model more complicated features of the tumor microbiology.

### Example 6C

Analysis of emerging cancer immunotherapies. The immune system plays an important role in regulating cancers. A new class of compounds, known as chimeric antigen receptors (CAR), has been designed to enhance the immune system's ability of to recognize and attack tumor cells. The inventors envision a use of the magnetophoretic array to credential cancer immunotherapies, through the following steps:
(i) organize sets of T cells and cancer cells in the microchambers
(ii) expose the cell sets to different drugs and combinations of drugs
(iii) monitor tumor cell proliferation, apoptosis, morphological changes, monitor markers that are activated in T cells, the signaling pathways upregulated in the tumor cells, and any other information that is obtained from immunostaining.
(iv) Monitor the engagement of T cell receptors with co-receptors on the surface of the cancer cells through MHC complexes.

While these different drug credential assay are useful in its own right, the inventors envision coupling this technology with single cell transcriptional profiling to enable the combined, rapid phenotypic and genomic analysis of rare cells [Fan H C, et al. (2015), “Combinatorial Labeling of Single Cells for Gene Expression Cytometry”, Science 34; Macosko E Z, et al. (2015), “Highly Parallel Genome-wide Expression Profiling of Individual Cells Using Nanoliter Droplets”, Cell 161: 1202-1214; Klein A M, et al. (2015), “Droplet Barcoding for Single-Cell Transcriptomics Applied to Embryonic Stem Cells”, Cell 161: 1187-1201]. It is anticipated that the transcriptional profiling capabilities can be combined with the array technology described here to form a complete, multifunctional genomic single cell analysis platform.

While various embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1.-15. (canceled)

16. A microfluidic chip comprising:
a) a microfluidic structure disposed above a solid surface; and
b) a pattern of magnetizable material comprising a continuous series of sections having either positive or negative curvature, wherein the pattern of magnetizable material is deposited on or embedded within the solid surface, and is in close proximity to, or in direct contact with, at least a portion of the microfluidic structure.

17. The microfluidic chip of claim 16, wherein the continuous series of sections alternate between having positive and negative curvature.

18. The microfluidic chip of claim 16, wherein the microfluidic structure comprises one or more of a fluid channel, a fluid chamber, a fluid compartment, a microwell, or any combination thereof.

19. The microfluidic chip of claim 16, wherein the microfluidic structure comprises a first fluid channel and a plurality of fluid compartments in fluid contact with the channel.

20. The microfluidic chip of claim 19, wherein the plurality of fluid compartments comprises at least 100 fluid compartments.

21. The microfluidic chip of claim 19, wherein the plurality of fluid compartments comprises at least 1,000 fluid compartments.

22. The microfluidic chip of claim 16, wherein the pattern of magnetizable material forms one or more structures selected from the group consisting of (i) structures that transport magnetically-susceptible objects along a path defined by the geometry of the magnetic pattern, (ii) structures that trap magnetically-susceptible objects at specific locations defined by the geometry of the magnetic pattern, and (iii) any combination thereof.

23. The microfluidic chip of claim 16, further comprising a pattern of electrically conducting material deposited on or embedded in the solid surface, and configured to form one or more junctions used to sort magnetically-susceptible objects between two pre-defined magnetic paths according to a relationship between the geometry of the magnetic pattern and the pattern of electrically conducting material.

24. The microfluidic chip of claim 16, further comprising a non-fouling layer disposed between the microfluidic domain and the pattern of magnetizable material.

25.-31. (canceled)

32. A system for controlling the position of magnetically-susceptible objects within a microfluidic chip comprising:
a) a controller adapted to dynamically adjust a time-varying magnetic field that has field components oriented in directions both parallel and perpendicular to a solid surface; and
b) a microfluidic chip comprising:
i) a microfluidic structure disposed above the solid surface;
ii) a pattern of magnetizable material, comprising a continuous series of sections having either positive or negative curvature, which is deposited on or embedded within the solid surface, and which is in close proximity to, or in direct contact with, at least a portion of the microfluidic structure.

33. The system of claim 32, wherein the microfluidic chip further comprises a pattern of electrically conducting structures deposited on or embedded within the solid surface and forming junctions used to sort magnetically-susceptible objects between (i) one or more structures of the pattern of magnetizable material that transport magnetically-susceptible objects along a path (ii) one or more structures of the pattern of magnetizable material that trap magnetically-susceptible objects at specific locations, or (iii) any combination thereof.

34. The system of claim 32, further comprising one or more magnets operatively connected to the controller and adapted to produce the time-varying magnetic field.

35. The system of claim 34, wherein the one or more magnets are electromagnets.

36. The system of claim 34, wherein the one or more magnets are movable permanent magnets.

37. A method comprising:
a) introducing a plurality of magnetically-susceptible objects into a microfluidic chip, wherein the microfluidic chip comprises:
i) a pattern of magnetizable material deposited on or embedded within a solid surface and in close proximity to or direct contact with a microfluidic channel, and
ii) a plurality of microfluidic chambers in fluid contact with the microfluidic channel; and
b) magnetically sorting the plurality of magnetically-susceptible objects into the plurality of microfluidic chambers using a time-varying magnetic field that has field components oriented in directions both parallel to and perpendicular to the solid surface.

38. The method of claim 37, further comprising correcting for multiple occupancy by identifying microfluidic chambers that contain more than one magnetically-susceptible object, and selectively removing a desired number of magnetically-susceptible objects from the identified microfluidic chambers using a time-varying magnetic field that has field components oriented in directions both parallel to and perpendicular to the solid surface.

39. The method of claim 37, wherein the plurality of magnetically-susceptible objects comprises a plurality of bioparticles.

40.-44. (canceled)

45. The method of claim 37, further comprising introducing a chemical stimulus into the plurality of microfluidic chambers.

46. (canceled)

47. The method of claim 37, further comprising applying a physical stimulus to the plurality of cells in the plurality of microfluidic chambers.

48. (canceled)

49. The method of claim 37, further comprising introducing at least a second plurality of magnetically-susceptible objects into the microfluidic chip and magnetically sorting the at least second plurality of magnetically-susceptible objects into the plurality of microfluidic chambers.

50.-80. (canceled)
